(19) United States
(12) Patent Application Publication
(10) Pub. No.: US 2021/0281842 A1
(43) Pub. Date: Sep. 9, 2021

(54) METHOD AND APPARATUS FOR PROCESSING VIDEO

(71) Applicant: LG ELECTRONICS INC., Seoul (KR)

(72) Inventors: Moonmo KOO, Seoul (KR); Mehdi SALEHIFAR, Seoul (KR); Seunghwan KIM, Seoul (KR); Jaehyun LIM, Seoul (KR)

(21) Appl. No.: 17/258,367

(22) PCT Filed: Jul. 3, 2019
(86) PCT No.: PCT/KR2019/008137

§ 371 Date: Jan. 6, 2021

Related U.S. Application Data
(60) Provisional application No. 62/695,162, filed on Jul. 8, 2018.

(51) Int. Cl. H04N 19/122; H04N 19/14; H04N 19/44; H04N 19/625; H04N 19/18

(52) U.S. Cl. CPC H04N 19/122; H04N 19/14; H04N 19/18; H04N 19/625; H04N 19/44

(57) ABSTRACT

Embodiments of the present invention provide a video signal processing method and apparatus. The video signal processing method according to an embodiment of the present invention comprises checking a length of a signal to which a transform is to be applied in the video signal, wherein the length of the signal corresponds to a width or height of a current block to which the transform is applied, determining a transform type based on the length of the signal, and applying, to the signal, the transform matrix determined based on the transform type, wherein DST-4 or DCT-4 is determined as the transform type if the length of the signal corresponds to a first length, and wherein DST-7 or DCT-8 is determined as the transform type if the length of the signal corresponds to a second length different from the first length.

### TECHNICAL FIELD

The present disclosure relates to a method and device for processing a video signal, and more particularly to a method and device for processing a video signal using a transform based on DST-4, DCT-4, DST-7, or DCT-8.

### BACKGROUND ART

A compression encoding means a series of signal processing techniques for transmitting digitized information through a communication line or techniques for storing the information in the form that is suitable for a storage medium. The media including a video, an image, an audio, and the like may be the target for the compression encoding, and particularly, the technique of performing the compression encoding targeted to the video is referred to as a video image compression.

The next generation video contents are supposed to have the characteristics of high spatial resolution, high frame rate and high dimensionality of scene representation. In order to process such contents, drastic increase of memory storage, memory access rate and processing power will be resulted.

Accordingly, a coding tool for processing more efficiently the next generation video contents needs to be designed. In particular, video codec standard after high efficiency video coding (HEVC) standard requires an efficient transform technology for transforming a video signal of a spatial domain into a frequency domain.

### DISCLOSURE

### Technical Problem

For an implementation of an efficient transform technology, there is a need for a method and apparatus for providing a low-complexity transform technology.

Accordingly, embodiments of the present disclosure provide a video signal processing method and apparatus for designing a transform matrix with low complexity.

Furthermore, embodiments of the present disclosure provide a video signal processing method and apparatus capable of reducing a computational load by selectively applying a matrix based on DCT-4 or DST-4 based on the length of a signal.

The technical objects to be achieved by the present disclosure are not limited to those that have been described hereinabove merely by way of example, and other technical objects that are not mentioned can be clearly understood from the following descriptions by those skilled in the art to which the present disclosure pertains.

### Technical Solution

A method of processing a video signal includes checking a length of a signal to which a transform is to be applied in the video signal, determining a transform type based on the length of the signal, and applying, to the signal, the transform matrix determined based on the transform type, wherein DST-4 or DCT-4 may be determined as the transform type if the length of the signal corresponds to a first length, and DST-7 or DCT-8 may be determined as the transform type if the length of the signal corresponds to a second length different from the first length.

Furthermore, in the method of processing a video signal according to the present disclosure, the first length may correspond to 8, and the second length may correspond to 4, 16, or 32.

Furthermore, in the method of processing a video signal according to the present disclosure, applying, to the signal, the transform matrix determined based on the transform type may include checking an index indicative of the transform type and determining a first transform type for horizontal components of the signal and a second transform type for vertical components of the signal to correspond to the index.

Furthermore, in the method of processing a video signal according to the present disclosure, if the length of the signal corresponds to the first length, the first transform type for the horizontal components of the signal and the second transform type for the vertical components of the signal may be determined based on a combination of the DST-4 or the DCT-4 corresponding to the index. If the length of the signal corresponds to the second length, the first transform type for the horizontal components of the signal and the second transform type for the vertical components of the signal may be determined based on a combination of the DST-7 or the DCT-8 corresponding to the index.

Furthermore, in the method of processing a video signal according to the present disclosure, the DST-4 and the DCT-4 may be determined based on DST-2 and DCT-2.

Furthermore, in the method of processing a video signal according to the present disclosure, the DST-7 may be determined based on a discrete Fourier transform (DFT).

Furthermore, in the method of processing a video signal according to the present disclosure, the first length may correspond to a length having a small complexity reduction when the DST-7 determined based on the DFT is applied.

An apparatus for processing a video signal according to an embodiment of the present disclosure may include a memory configured to store the video signal and a decoder functionally coupled to the memory and configured to process the video signal. The decoder is configured to check a length of a signal to which a transform is to be applied in the video signal and to apply, to the signal, the transform matrix determined based on the transform type. The DST-4 or DCT-4 may be determined as the transform type if the length of the signal corresponds to a first length, and DST-7 or DCT-8 may be determined as the transform type if the length of the signal corresponds to a second length different from the first length.

Furthermore, in the apparatus for processing a video signal according to the present disclosure, the first length may correspond to 8, and the second length may correspond to 4, 16, or 32.

Furthermore, in the apparatus for processing a video signal according to the present disclosure, the decoder may include checking an index indicative of the transform type and to determining a first transform type for horizontal components of the signal and a second transform type for vertical components of the signal to correspond to the index.

Furthermore, in the apparatus for processing a video signal according to the present disclosure, if the length of the signal corresponds to the first length, the first transform type for the horizontal components of the signal and the second transform type for the vertical components of the signal may be determined based on a combination of the DST-4 or the DCT-4 corresponding to the index. If the length of the signal corresponds to the second length, the first transform type for the horizontal components of the signal and the second transform type for the vertical components of the signal may be determined based on a combination of the DST-7 or the DCT-8 corresponding to the index.

Furthermore, in the apparatus for processing a video signal according to the present disclosure, the DST-4 and the DCT-4 may be determined based on DST-2 and DCT-2.

Furthermore, in the apparatus for processing a video signal according to the present disclosure, the DST-7 is determined based on a discrete Fourier transform (DFT).

Furthermore, in the apparatus for processing a video signal according to the present disclosure, the first length may correspond to a length having a small complexity reduction when the DST-7 determined based on the DFT is applied.

### Advantageous Effects

According to an embodiment of the present disclosure, a transform matrix can be designed with low complexity.

Furthermore, according to an embodiment of the present disclosure, a computational load can be reduced by selectively applying a matrix based on DCT-4 or DST-4 based on the length of a signal.

Effects that could be achieved with the present disclosure are not limited to those that have been described hereinabove merely by way of example, and other effects and advantages of the present disclosure will be more clearly understood from the following description by a person skilled in the art to which the present disclosure pertains

### DESCRIPTION OF DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates a schematic block diagram of an encoder performing encoding of a video signal as an embodiment to which the present disclosure is applied.

FIG. 2 illustrates a schematic block diagram of a decoder performing decoding of a video signal as an embodiment to which the present disclosure is applied.

FIG. 3 illustrates embodiments to which the present disclosure may be applied, wherein FIGS. 3A, 3B, 3C, and 3D are diagrams for describing block division structures based on a quadtree, a binary tree, a ternary tree, and an asymmetric tree, respectively.

FIGS. 4 and 5 are embodiments to which the present disclosure is applied, wherein FIG. 4 illustrates a schematic block diagram of transform and quantization units, and dequantization and inverse transform units within an encoder, and FIG. 5 illustrates a schematic block diagram of dequantization and inverse transform units within a decoder.

FIG. 5 is an embodiment to which the present disclosure is applied, and illustrates a schematic block diagram of an dequantization and inverse transform units 220/230 within a decoder.

FIGS. 6a and 6b illustrate examples of tables for determining a transform type for a horizontal direction and a vertical direction for each prediction mode.

FIG. 7 is an embodiment to which the present disclosure is applied, and is a flowchart illustrating an encoding process in which MTS is performed.

FIG. 8 is an embodiment to which the present disclosure is applied, and is a flowchart illustrating a decoding process in which MTS is performed.

FIG. 9 is an embodiment to which the present disclosure is applied, and is a flowchart for describing a process of encoding an MTS flag and an MTS index.

FIG. 10 is an embodiment to which the present disclosure is applied, and is a flowchart for illustrating a decoding process of applying a horizontal transform or a vertical transform to a row or column based on an MTS flag and an MTS index.

FIG. 11 is an embodiment to which the present disclosure is applied, and illustrates a flowchart in which an inverse transform is performed based on a transform-related parameter.

FIG. 12 is an embodiment to which the present disclosure is applied, and is a table illustrating that a transform set is assigned to each intra-prediction mode in an NSST.

FIG. 13 is an embodiment to which the present disclosure is applied, and illustrates a calculation flow diagram for Givens rotation.

FIG. 14 is an embodiment to which the present disclosure is applied, and illustrates one round configuration in a 4×4 NSST composed of a Givens rotation layer and permutations.

FIG. 15 is an embodiment to which the present disclosure is applied, and illustrates a flowchart in which forward DST-7 having a length 16 is designed using a DFT.

FIG. 16 is an embodiment to which the present disclosure is applied, and illustrates a flowchart in which inverse DST-7 having a length 16 is designed using a DFT.

FIGS. 17 to 19 are embodiments to which the present disclosure is applied, and illustrate flowcharts in which an xDST7 FFT_B16 function of FIGS. 15 and 16 is applied.

FIG. 20 is an embodiment to which the present disclosure is applied, and illustrates a flowchart in which forward DST-7 having a length 32 is designed using a DFT.

FIG. 21 is an embodiment to which the present disclosure is applied, and illustrates a flowchart in which inverse DST-7 having a length 32 is designed using a DFT.

FIGS. 22 to 24 are embodiments to which the present disclosure is applied, and illustrate flowcharts in which an xDST7 FFT_B32 function of FIGS. 20 and 21 is applied.

FIG. 25 is an embodiment to which the present disclosure is applied, and illustrates a flowchart in which forward DST-7 having a length 8 is designed using a DFT.

FIG. 26 is an embodiment to which the present disclosure is applied, and illustrates a flowchart in which inverse DST-7 having a length 8 is designed using a DFT.

FIGS. 27 and 28 are embodiments to which the present disclosure is applied, wherein FIG. 27 illustrates a block diagram of 16×16 DST7 to which a 33-point DFT is applied, and FIG. 28 illustrates a block diagram of 32×32 DST7 to which a 65-point DFT is applied.

FIG. 29 is an embodiment to which the present disclosure is applied, and illustrates an encoding flowchart in which forward DST-7 and forward DCT-8 are performed as DFTs.

FIG. 30 is an embodiment to which the present disclosure is applied, and illustrates a decoding flowchart in which inverse DST-7 and inverse DCT-8 are performed as DFTs.

FIG. 31 is an embodiment to which the present disclosure is applied, and illustrates diagonal elements for a pair of a transform block size and a right shift amount when DST-4 and DCT-4 are performed as forward DCT-2.

FIGS. 32 and 33 are embodiments to which the present disclosure is applied, wherein FIG. 32 illustrates sets of DCT-2 kernel coefficients which may be applied to DST-4 or DCT-4, and FIG. 33 illustrates a forward DCT-2 matrix generated from a set of a DCT-2 kernel coefficient.

FIGS. 34 and 35 are embodiments to which the present disclosure is applied, wherein FIG. 34 illustrates the execution of a code at an output step for DST-4, and FIG. 35 illustrates the execution of a code at an output step for DCT-4.

FIG. 36 is an embodiment to which the present disclosure is applied, and illustrates a configuration of a parameter set and multiplication coefficients for DST-4 and DCT-4 when DST-4 and DCT-4 are performed as forward DCT-2.

FIGS. 37 and 38 are embodiments to which the present disclosure is applied, wherein FIG. 37 illustrates the execution of a code at a pre-processing stage for DCT-4, and FIG. 38 illustrates the execution of a code at a pre-processing stage for DST-4.

FIG. 39 is an embodiment to which the present disclosure is applied, and illustrates diagonal elements for a pair of a transform block size and a right shift amount when DST-4 and DCT-4 are performed as inverse DCT-2.

FIG. 40 is an embodiment to which the present disclosure is applied, and illustrates a configuration of a parameter set and multiplication coefficients for DST-4 and DCT-4 when DST-4 and DCT-4 are performed as inverse DCT-2.

FIGS. 41 and 42 are embodiments to which the present disclosure is applied, wherein FIG. 41 illustrates MTS mapping for an intra-prediction residual, and FIG. 42 illustrates MTS mapping for an inter-prediction residual.

FIG. 43 illustrates an example of transform types according to lengths according to an embodiment of the present disclosure.

FIGS. 44a and 44b illustrate examples of tables for determining transform types for the horizontal direction and the vertical direction in the case of lengths 4, 16, and 32.

FIGS. 45a and 45b illustrate examples of tables for determining transform types for the horizontal direction and the vertical direction in the case of a length 8.

FIG. 46 illustrates an example of a flowchart for processing a video signal using a transform based on DST-4, DCT-4, DST-7, and DCT-8 according to an embodiment of the present disclosure.

FIG. 47 illustrates an example of a flowchart for determining a transform type in a process of processing a video signal using transforms based on DST-4, DCT-4, DST-7, and DCT-8 according to an embodiment of the present disclosure.

FIG. 48 illustrates an example of a video coding system as an embodiment to which the present disclosure is applied.

FIG. 49 illustrates an example of a video streaming system as an embodiment to which the present disclosure is applied

### MODE FOR INVENTION

Reference will now be made in detail to embodiments of the present disclosure, examples of which are illustrated in the accompanying drawings. A detailed description to be disclosed below together with the accompanying drawing is to describe exemplary embodiments of the present disclosure and not to describe a unique embodiment for carrying out the present disclosure. The detailed description below includes details to provide a complete understanding of the present disclosure. However, those skilled in the art know that the present disclosure can be carried out without the details.

In some cases, in order to prevent a concept of the present disclosure from being ambiguous, known structures and devices may be omitted or illustrated in a block diagram format based on core function of each structure and device.

Further, although general terms widely used currently are selected as the terms in the disclosure as much as possible, a term that is arbitrarily selected by the applicant is used in a specific case. Since the meaning of the term will be clearly described in the corresponding part of the description in such a case, it is understood that the disclosure will not be simply interpreted by the terms only used in the description of the disclosure, but the meaning of the terms should be figured out.

Specific terminologies used in the description below may be provided to help the understanding of the disclosure. Furthermore, the specific terminology may be modified into other forms within the scope of the technical concept of the disclosure. For example, a signal, data, a sample, a picture, a frame, a block, etc may be properly replaced and interpreted in each coding process.

In the present disclosure, a ‘processing unit’ refers to a unit on which encoding/decoding process such as prediction, transform and/or quantization is performed. The processing unit may also be interpreted as the meaning including a unit for a luma component and a unit for a chroma component. For example, the processing unit may correspond to a block, a coding unit (CU), a prediction unit (PU) or a transform unit (TU).

The processing unit may also be interpreted as a unit for a luma component or a unit for a chroma component. For example, the processing unit may correspond to a coding tree block (CTB), a coding block (CB), a prediction unit (PU) or a transform block (TB) for the luma component. Alternatively, the processing unit may correspond to a CTB, a CB, a PU or a TB for the chroma component. The processing unit is not limited thereto and may be interpreted as the meaning including a unit for the luma component and a unit for the chroma component.

In addition, the processing unit is not necessarily limited to a square block and may be configured in a polygonal shape having three or more vertexes.

In the present disclosure, a pixel is commonly called a sample. In addition, using a sample may mean using a pixel value or the like.

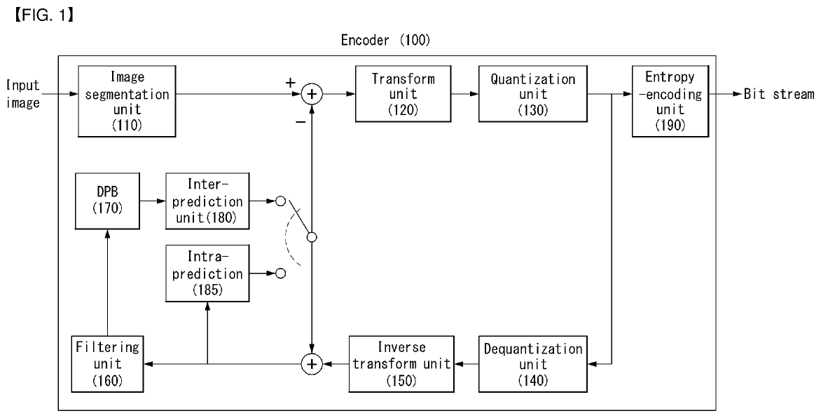

FIG. 1 is a schematic block diagram of an encoder in which encoding of a video signal is performed as an embodiment to which the present disclosure is applied.

Referring to FIG. 1, the encoder 100 may be configured to include an image segmentation 110, a transform unit 120, a quantization unit 130, a dequantization unit 140, an inverse transform unit 150, a filtering unit 160, a decoded picture buffer (DPB) 170, an inter-prediction unit 180, an intra-prediction unit 185, and an entropy encoding unit 190.

The image segmentation 110 may divide an input image (or picture or frame) input into the encoder 100 into one or more processing units. For example, the processing unit may be a Coding Tree Unit (CTU), a Coding Unit (CU), a Prediction Unit (PU), or a Transform Unit (TU).

However, the terms are only used for the convenience of description of the present disclosure and the present disclosure is not limited to the definition of the terms. In addition, in the present disclosure, for the convenience of the description, the term coding unit is used as a unit used in encoding or decoding a video signal, but the present disclosure is not limited thereto and may be appropriately interpreted according to the present disclosure.

The encoder 100 subtracts a prediction signal output from the inter-prediction unit 180 or the intra-prediction unit 185 from the input image signal to generate a residual signal and the generated residual signal is transmitted to the transform unit 120.

The transform unit 120 may generate a transform coefficient by applying a transform technique to the residual signal. A transform process may be applied to a quadtree structure square block and a block (square or rectangle) divided by a binary tree structure, a ternary tree structure, or an asymmetric tree structure.

The transform unit 120 may perform a transform based on a plurality of transforms (or transform combinations), and the transform scheme may be referred to as multiple transform selection (MTS). The MTS may also be referred to as an Adaptive Multiple Transform (AMT) or an Enhanced Multiple Transform (EMT).

The MTS (or AMT or EMT) may refer to a transform scheme performed based on a transform (or transform combinations) adaptively selected from the plurality of transforms (or transform combinations).

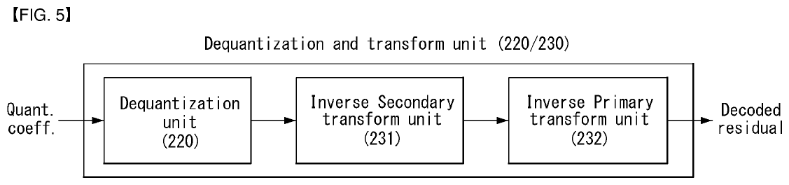

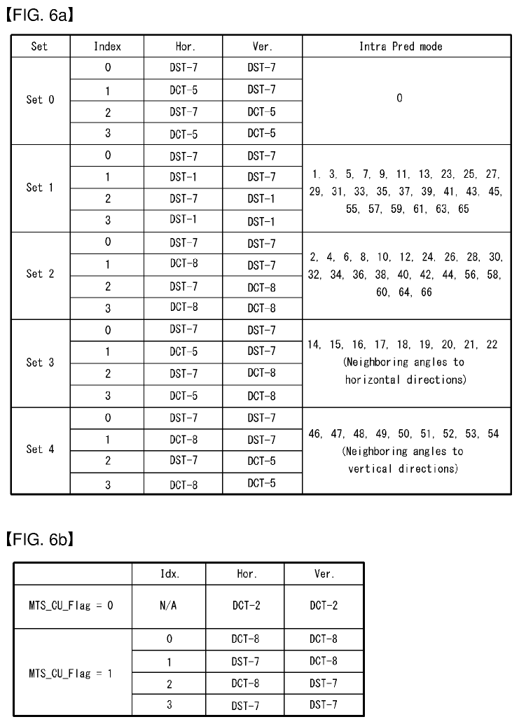

A plurality of transforms (or transform combinations) may include transforms (or transform combinations) described with reference to FIG. 6a, 6b, or 44a to 44b of the present disclosure. In the present disclosure, the transform type may be indicated as DCT-Type 2, DCT-II, DCT-2, or DCT2, for example. In the following description, the transform type may be generally indicated as DCT-2.

The transform unit 120 may perform the following embodiments.

The transform unit 120 according to an embodiment of the present disclosure can design a transform matrix with low complexity.

Furthermore, the transform unit 120 according to an embodiment of the present disclosure can reduce a computational load by selectively applying a matrix based on DCT-4 or DST-4 based on the length of a signal.

Detailed embodiments thereof are more specifically described in the present disclosure.

The transform unit 120 according to an embodiment of the present disclosure is configured to checks the length of a signal to which a transform is to be applied in a video signal, determine a transform type based on the length of the signal, and apply a transform matrix determined based on the transform type to the signal. If the length of the signal corresponds to a first length, DST-4 or DCT-4 may be determined as the transform type. If the length of the signal corresponds to a second length different from the first length, DST-7 or DCT-8 may be determined as the transform type.

Furthermore, in the transform unit 120 according to an embodiment of the present disclosure, the first length may correspond to 8, and the second length may correspond to 4, 16, or 32.

Furthermore, in the transform unit 120 according to an embodiment of the present disclosure, the decoder may include the steps of checking an index indicative of the transform type, and determining a first transform type for horizontal components of the signal and a second transform type for vertical components of the signal so that the transform type to correspond to the index.

Furthermore, in the transform unit 120 according to an embodiment of the present disclosure, if the length of the signal corresponds to the first length, the first transform type for the horizontal components of the signal and the second transform type for the vertical components of the signal may be determined based on a combination of DST-4 and DCT-4 corresponding to the index. If the length of the signal corresponds to the second length, the first transform type for the horizontal components of the signal and the second transform type for the vertical components of the signal may be determined based on a combination of DST-7 and DCT-8 corresponding to the index.

Furthermore, in the transform unit 120 according to an embodiment of the present disclosure, the DST-4 and the DCT-4 may be determined based on DST-2 and DCT-2.

Furthermore, in the transform unit 120 according to an embodiment of the present disclosure, the DST-7 may be determined based on a discrete Fourier transform (DFT).

Furthermore, in the transform unit 120 according to an embodiment of the present disclosure, the first length may correspond to a length having a small complexity reduction when DST-7 determined based on the DFT is applied.

The quantization unit 130 may quantize the transform coefficient and transmits the quantized transform coefficient to the entropy encoding unit 190 and the entropy encoding unit 190 may entropy-code a quantized signal and output the entropy-coded quantized signal as a bitstream.

Although the transform unit 120 and the quantization unit 130 are described as separate functional units, the present disclosure is not limited thereto and may be combined into one functional unit. The dequantization unit 140 and the inverse transform unit 150 may also be similarly combined into one functional unit.

A quantized signal output from the quantization unit 130 may be used for generating the prediction signal. For example, dequantization and inverse transform are applied to the quantized signal through the dequantization unit 140 and the inverse transform unit 1850 in a loop to reconstruct the residual signal. The reconstructed residual signal is added to the prediction signal output from the inter-prediction unit 180 or the intra-prediction unit 185 to generate a reconstructed signal.

Meanwhile, deterioration in which a block boundary is shown may occur due to a quantization error which occurs during such a compression process. Such a phenomenon is referred to as blocking artifacts and this is one of key elements for evaluating an image quality. A filtering process may be performed in order to reduce the deterioration. Blocking deterioration is removed and an error for the current picture is reduced through the filtering process to enhance the image quality.

The filtering unit 160 applies filtering to the reconstructed signal and outputs the applied reconstructed signal to a reproduction device or transmits the output reconstructed signal to the decoded picture buffer 170. The inter-prediction unit 170 may use the filtered signal transmitted to the decoded picture buffer 180 as the reference picture. As such, the filtered picture is used as the reference picture in the inter prediction mode to enhance the image quality and the encoding efficiency.

The decoded picture buffer 170 may store the filtered picture in order to use the filtered picture as the reference picture in the inter-prediction unit 180.

The inter-prediction unit 180 performs a temporal prediction and/or spatial prediction in order to remove temporal redundancy and/or spatial redundancy by referring to the reconstructed picture. Here, since the reference picture used for prediction is a transformed signal that is quantized and dequantized in units of the block at the time of encoding/decoding in the previous time, blocking artifacts or ringing artifacts may exist.

Accordingly, the inter-prediction unit 180 may interpolate a signal between pixels in units of a sub-pixel by applying a low-pass filter in order to solve performance degradation due to discontinuity or quantization of such a signal. Here, the sub-pixel means a virtual pixel generated by applying an interpolation filter and an integer pixel means an actual pixel which exists in the reconstructed picture. As an interpolation method, linear interpolation, bi-linear interpolation, wiener filter, and the like may be adopted.

An interpolation filter is applied to the reconstructed picture to enhance precision of prediction. For example, the inter-prediction unit 180 applies the interpolation filter to the integer pixel to generate an interpolated pixel and the prediction may be performed by using an interpolated block constituted by the interpolated pixels as the prediction block.

Meanwhile, the intra-prediction unit 185 may predict the current block by referring to samples in the vicinity of a block which is to be subjected to current encoding. The intra-prediction unit 185 may perform the following process in order to perform the intra prediction. First, a reference sample may be prepared, which is required for generating the prediction signal. In addition, the prediction signal may be generated by using the prepared reference sample. Thereafter, the prediction mode is encoded. In this case, the reference sample may be prepared through reference sample padding and/or reference sample filtering. Since the reference sample is subjected to prediction and reconstruction processes, a quantization error may exist. Accordingly, a reference sample filtering process may be performed with respect to each prediction mode used for the intra prediction in order to reduce such an error.

The prediction signal generated through the inter-prediction unit 180 or the intra-prediction unit 185 may be used for generating the reconstructed signal or used for generating the residual signal.

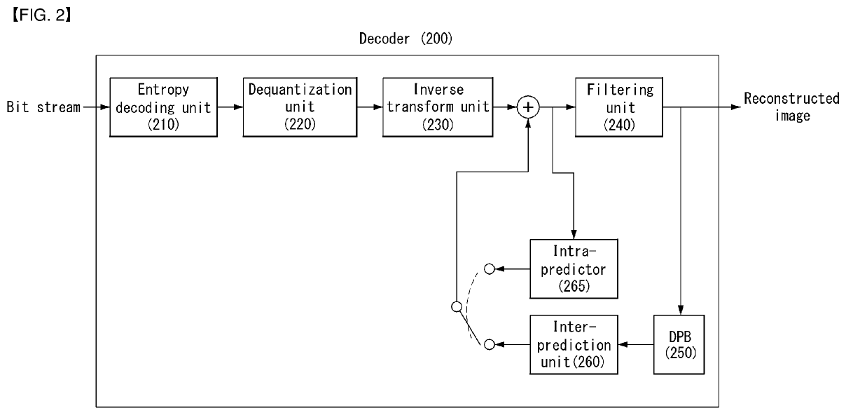

FIG. 2 is a schematic block diagram of a decoder in which decoding of a video signal is performed as an embodiment to which the present disclosure is applied.

Referring to FIG. 2, the decoder 200 may be configured to include a parsing unit (not illustrated), an entropy decoding unit 210, a dequantization unit 220, an inverse transform unit 230, a filtering unit 240, a decoded picture buffer (DPB) unit 250, an inter-prediction unit 260, and an intra-prediction unit 265.

In addition, a reconstructed video signal output through the decoder 200 may be reproduced through a reproduction device.

The decoder 200 may receive the signal output from the encoder 100 of FIG. 1 and the received signal may be entropy-decoded through the entropy decoding unit 210.

The dequantization unit 220 obtains the transform coefficient from an entropy-decoded signal by using quantization step size information.

The inverse transform unit 230 inversely transforms the transform coefficient to obtain the residual signal.

Here, the present disclosure provides a method for configuring a transform combination for each transform configuration group divided by at least one of a prediction mode, a block size or a block shape and the inverse transform unit 230 may perform inverse transform based on the transform combination configured by the present disclosure. Further, the embodiments described in the present disclosure may be applied

The inverse transform unit 230 may perform the following embodiments.

The inverse transform unit 230 according to an embodiment of the present disclosure is configured to check the length of a signal to which a transform is to be applied in a video signal, determine a transform type based on the length of the signal, and apply a transform matrix determined based on the transform type to the signal. If the length of the signal corresponds to a first length, DST-4 or DCT-4 may be determined as the transform type. If the length of the signal corresponds to a second length different from the first length, DST-7 or DCT-8 may be determined as the transform type.

Furthermore, in the inverse transform unit 230 according to an embodiment of the present disclosure, the first length may correspond to 8, and the second length may correspond to 4, 16, or 32.

Furthermore, in the inverse transform unit 230 according to an embodiment of the present disclosure, the decoder may include the steps of checking an index indicative of the transform type, and determining a first transform type for horizontal components of the signal and a second transform type for vertical components of the signal so that the transform type to correspond to the index.

Furthermore, in the inverse transform unit 230 according to an embodiment of the present disclosure, if the length of the signal corresponds to the first length, the first transform type for the horizontal components of the signal and the second transform type for the vertical components of the signal may be determined based on a combination of DST-4 and DCT-4 corresponding to the index. If the length of the signal corresponds to the second length, the first transform type for the horizontal components of the signal and the second transform type for the vertical components of the signal may be determined based on a combination of DST-7 and DCT-8 corresponding to the index.

Furthermore, in the inverse transform unit 230 according to an embodiment of the present disclosure, the DST-4 and the DCT-4 may be determined based on DST-2 and DCT-2.

Furthermore, in the inverse transform unit 230 according to an embodiment of the present disclosure, the DST-7 may be determined based on a discrete Fourier transform (DFT).

Furthermore, in the inverse transform unit 230 according to an embodiment of the present disclosure, the first length may correspond to a length having a small complexity reduction when DST-7 determined based on the DFT is applied.

Although the dequantization unit 220 and the inverse transform unit 230 are described as separate functional units, the present disclosure is not limited thereto and may be combined into one functional unit.

The obtained residual signal is added to the prediction signal output from the inter-prediction unit 260 or the intra-prediction unit 265 to generate the reconstructed signal.

The filtering unit 240 applies filtering to the reconstructed signal and outputs the applied reconstructed signal to a generation device or transmits the output reconstructed signal to the decoded picture buffer unit 250. The inter-prediction unit 250 may use the filtered signal transmitted to the decoded picture buffer unit 260 as the reference picture.

In the present disclosure, the embodiments described in the transform unit 120 and the respective functional units of the encoder 100 may be equally applied to the inverse transform unit 230 and the corresponding functional units of the decoder, respectively.

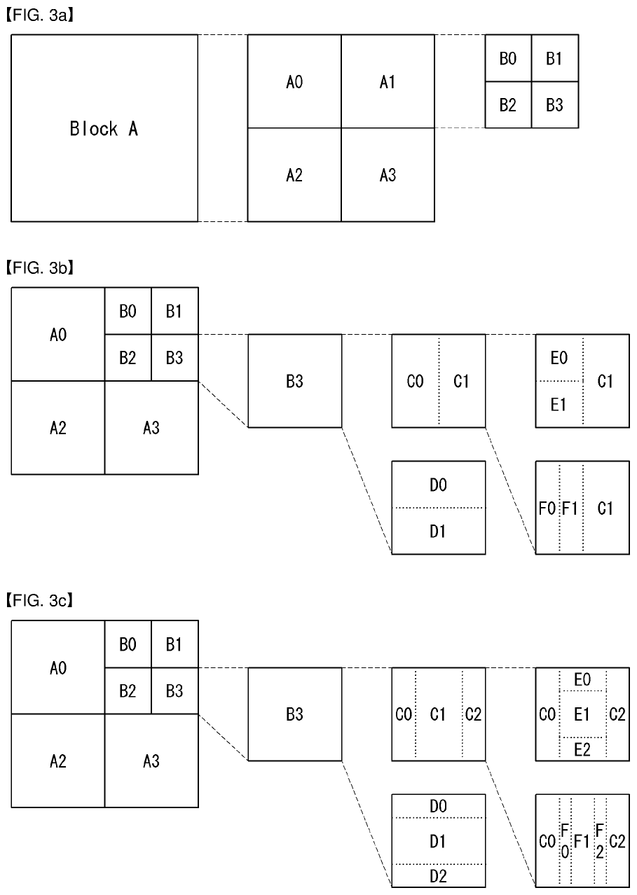

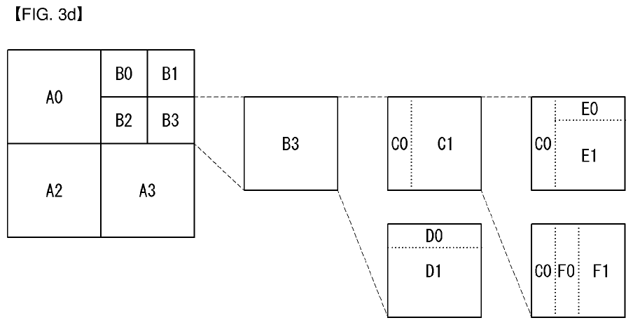

FIG. 3 illustrates embodiments to which the disclosure may be applied, FIG. 3a is a diagram for describing a block split structure based on a quadtree (hereinafter referred to as a “QT”), FIG. 3b is a diagram for describing a block split structure based on a binary tree (hereinafter referred to as a “BT”), FIG. 3c is a diagram for describing a block split structure based on a ternary tree (hereinafter referred to as a “TT”), and FIG. 3d is a diagram for describing a block split structure based on an asymmetric tree (hereinafter referred to as an “AT”).

In video coding, one block may be split based on a quadtree (QT).

Furthermore, one subblock split by the QT may be further split recursively using the QT. A leaf block that is no longer QT split may be split using at least one method of a binary tree (BT), a ternary tree (TT) or an asymmetric tree (AT). The BT may have two types of splits of a horizontal BT (2N×N, 2N×N) and a vertical BT (N×2N, N×2N). The TT may have two types of splits of a horizontal TT (2N×1/2N, 2N×N, 2N×1/2N) and a vertical TT (1/2N×2N, N×2N, 1/2N×2N). The AT may have four types of splits of a horizontal-up AT (2N×1/2N, 2N×3/2N), a horizontal-down AT (2N×3/2N, 2N×1/2N), a vertical-left AT (1/2N×2N, 3/2N×2N), and a vertical-right AT (3/2N×2N, 1/2N×2N). Each BT, TT, or AT may be further split recursively using the BT, TT, or AT.

FIG. 3a illustrates an example of a QT split. A block A may be split into four subblocks A0, A1, A2, and A3 by a QT. The subblock A1 may be split into four subblocks B0, B1, B2, and B3 by a QT.

FIG. 3b illustrates an example of a BT split. A block B3 that is no longer split by a QT may be split into vertical BTs C0 and C1 or horizontal BTs D0 and D1. As in the block C0, each subblock may be further split recursively like the form of horizontal BTs E0 and E1 or vertical BTs F0 and F1.

FIG. 3c illustrates an example of a TT split. A block B3 that is no longer split by a QT may be split into vertical TTs C0, C1, and C2 or horizontal TTs D0, D1, and D2. As in the block C1, each subblock may be further split recursively like the form of horizontal TTs E0, E1, and E2 or vertical TTs F0, F1, and F2.

FIG. 3d illustrates an example of an AT split. A block B3 that is no longer split by a QT may be split into vertical ATs C0 and C1 or horizontal ATs D0 and D1. As in the block C1, each subblock may be further split recursively like the form of horizontal ATs E0 and E1 or vertical TTs F0 and F1.

Meanwhile, BT, TT, and AT splits may be split together. For example, a subblock split by a BT may be split by a TT or AT. Furthermore, a subblock split by a TT may be split by a BT or AT. A subblock split by an AT may be split by a BT or TT. For example, after a horizontal BT split, each subblock may be split into vertical BTs or after a vertical BT split, each subblock may be split into horizontal BTs. The two types of split methods are different in a split sequence, but have the same finally split shape.

Furthermore, if a block is split, the sequence that the block is searched may be defined in various ways. In general, the search is performed from left to right or from top to bottom. To search a block may mean a sequence for determining whether to split an additional block of each split subblock or may mean a coding sequence of each subblock if a block is no longer split or may mean a search sequence when information of another neighbor block is referred in a subblock.

A transform may be performed for each processing unit (or transform unit) divided by a division structure, such as FIG. 3. In particular, a division may be performed for each row direction and each column direction, and a transform matrix may be applied. According to an embodiment of the present disclosure, a different transform type may be used based on the length of a processing unit (or transform unit) in the row direction or column direction.

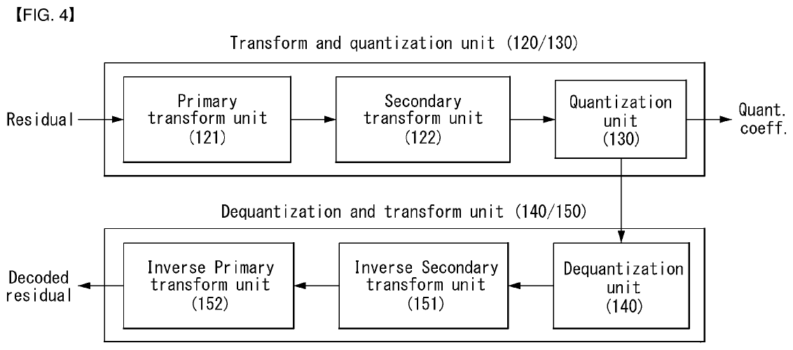

FIGS. 4 and 5 are embodiments to which the disclosure is applied. FIG. 4 illustrates a schematic block diagram of a transform and quantization unit 120/130 and a dequantization and transform unit 140/150 within the encoder, and FIG. 5 illustrates a schematic block diagram of a dequantization and transform unit 220/230 within the decoder.

Referring to FIG. 4, the transform and quantization unit 120/130 may include a primary transform unit 121, a secondary transform unit 122 and the quantization unit 130. The dequantization and transform unit 140/150 may include the dequantization unit 140, an inverse secondary transform unit 151 and an inverse primary transform unit 152.

Referring to FIG. 5, the dequantization and transform unit 220/230 may include the dequantization unit 220, an inverse secondary transform unit 231 and an inverse primary transform unit 232.

In the disclosure, when a transform is performed, the transform may be performed through a plurality of steps. For example, as in FIG. 4, two steps of a primary transform and a secondary transform may be applied or more transform steps may be used according to an algorithm. In this case, the primary transform may be referred to as a core transform.

The primary transform unit 121 may apply a primary transform on a residual signal. In this case, the primary transform may be pre-defined in a table form in the encoder and/or the decoder.

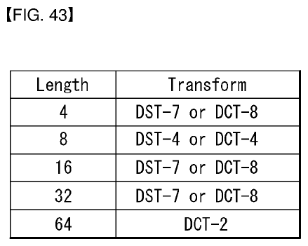

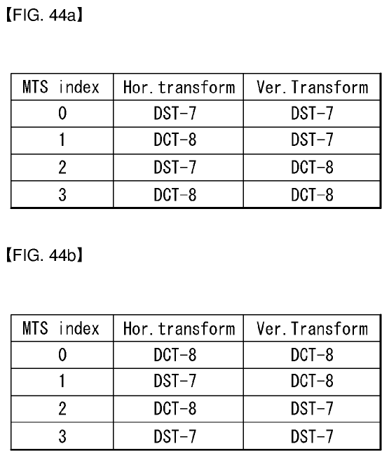

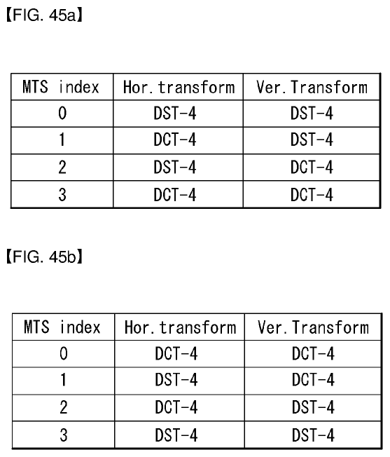

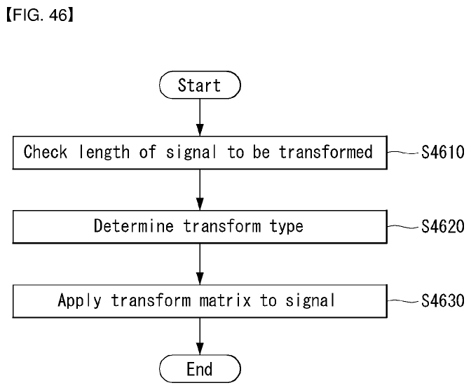

Furthermore, in the case of the primary transform, combinations of several transform types DCT-2, DST-4, DCT-4, DST-7, and DCT-8 of an MTS may be used. For example, transform types may be determined as in tables illustrated in FIGS. 6a and 6b. In particular, as in FIGS. 44a to 45b, a combination of the transform types may be determined based on the length of a transformed signal.

The secondary transform unit 122 may apply a secondary transform to a primary-transformed signal. In this case, the secondary transform may be predefined as a table in the encoder and/or the decoder.

In an embodiment, a non-separable secondary transform (hereinafter referred to as an “NSST”) may be conditionally applied to the secondary transform. For example, the NSST may be applied to only an intra-prediction block, and may have an applicable transform set for each prediction mode group.

Here, the prediction mode group may be configured based on symmetry with respect to a prediction direction. For example, since prediction mode 52 and prediction mode 16 are symmetrical based on prediction mode 34 (diagonal direction), the same transform set may be applied by forming one group. In this case, when the transform for prediction mode 52 is applied, input data is transposed and then applied because prediction mode 52 has the same transform set as prediction mode 16.

Meanwhile, since the symmetry for the direction does not exist in the case of a planar mode and a DC mode, each mode has a different transform set and the corresponding transform set may include two transforms. In respect to the remaining direction modes, each transform set may include three transforms.

In an embodiment, in the case of a primary transform, combinations of several transforms DST-4, DCT-4, DST-7, and DCT-8 of MTS may be applied. For example, transform types may be determined as in tables illustrated in FIGS. 6a and 6b. In particular, as in FIGS. 44a to 45b, a combination of the transform types may be determined based on the length of a transformed signal.

In another embodiment, DST-4 or DST-7 may be applied as the primary transform. DST-4 or DST-7 may be used for a specific length (e.g., 8).

In another embodiment, DCT-4 or DCT-8 may be applied as the primary transform. DCT-4 or DCT-8 may be used based on the length of a transformed signal.

As another embodiment, the NSST may be applied to only an 8×8 top-left region instead of the entire primarily transformed block. For example, 8×8 NSST is applied when the block size is 8×8 or more and 4×4 NSST is applied when the block size is less than 8×8. Here, blocks are divided into 4×4 blocks and then 4×4 NSST is applied to each block.

As another embodiment, 4×4 NSST may also be applied in the case of 4×N/N×4 (N>16).

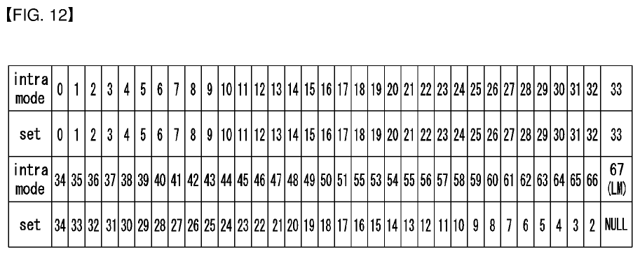

The NSST, 4×4 NSST and 8×8 NSST will be described in more detail with reference to FIG. 12 to FIG. 15 and other embodiments in the specification.

The quantization unit 130 may perform quantization on a secondarily transformed signal.

The dequantization and inverse transform units 140/150 inversely perform the aforementioned process, and redundant description will be omitted.

FIG. 5 is a schematic block diagram of a dequantization unit 220 and an inverse transform unit 230 in a decoder.

Referring to FIG. 5 above, the dequantization and inverse transform units 220 and 230 may include a dequantization unit 220, an inverse secondary transform unit 231, and an inverse primary transform unit 232.

The dequantization unit 220 obtains the transform coefficient from an entropy-decoded signal by using quantization step size information.

The inverse secondary transform unit 231 performs an inverse secondary transform for the transform coefficients. Here, the inverse secondary transform represents an inverse transform of the secondary transform described in FIG. 4 above.

The inverse primary transform unit 232 performs an inverse primary transform for the inverse secondary transformed signal (or block) and obtains the residual signal. Here, the inverse primary transform represents the inverse transform of the primary transform described in FIG. 4 above.

In an embodiment, in the case of the primary transform, combinations of several transforms (DST-4, DCT-4, DST-7, and DCT-8) of MTS may be applied. For example, transform types may be determined as in tables illustrated in FIGS. 6a and 6b. In particular, as in FIGS. 44a to 45b, a combination of the transform types may be determined based on the length of a transformed signal.

In another embodiment, DST-4 or DST-7 may be applied as the primary transform, and DST-4 or DST-7 may be used based on the length of a transformed signal.

In another embodiment, DCT-4 or DCT-8 may be applied as the primary transform, and DCT-4 or DCT-8 may be used based on the length of an inverse transformed signal.

FIGS. 6a and 6b illustrate examples of tables for determining a transform type for a horizontal direction and a vertical direction for each prediction mode. FIG. 6a illustrates an example of the table for determining transform types in the horizontal/vertical direction in an intra-prediction mode. FIG. 6b illustrates an example of the table for determining transform types for the horizontal/vertical direction in an inter-prediction mode. FIGS. 6a and 6b are examples of combination tables for determining transform types, illustrates MTS combinations applied to a joint exploration model (JEM). Another combination may also be used. For example, the table of FIG. 6b may be used for both an intra-prediction and an inter-prediction. Examples applied to the JEM are basically described with reference to FIGS. 6a and 6b.

In the JEM, the application of MTS may become on/off in a block unit (in the case of HEVC, in a CU unit) because a syntax element called EMT_CU_flag (or MTS_CU_flag) is introduced. That is, in the intra-prediction mode, when MTS_CU_flag is 0, DCT-2 or DST-7 (for a 4×4 block) in the existing high efficiency video coding (HEVC) is used. When MTS_CU_flag is 1, an MTS combination proposed in FIG. 6a is used. A possible MTS combination may be different depending on an intra-prediction mode as in FIG. 6a. For example, a total of possible four combinations are permitted because DST-7 and DCT-5 are used in the horizontal direction and DST-7 and DCT-8 are used in the vertical direction, with respect to 14, 15, 16, 17, 18, 19, 20, 21, 22 modes. Accordingly, there is a need for signaling of information on which one of the four combinations is used. One of the four combinations is selected through MTS_TU_index having two bits. FIG. 6b illustrates MTS combinations which may be applied in an inter-prediction mode. Unlike in FIG. 6a, possible combinations are determined based on only DST-7 and DCT-8. In this case, an embodiment of the present disclosure provides a method of using DST-4 or DCT-4 for a specific length in addition to DST-7 and DCT-8. According to an embodiment of the present disclosure, EMT_CU_flag may be used instead of MTS_CU_flag.

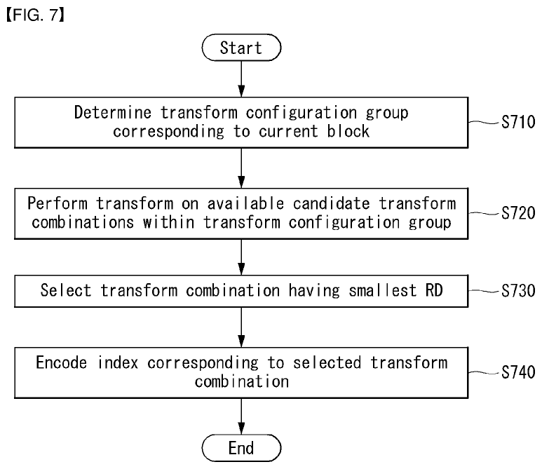

FIG. 7 is an embodiment to which the present disclosure is applied, and is a flowchart illustrating an encoding process in which MTS is performed.

In the present disclosure, basically, embodiments in which transforms are applied in the horizontal direction and the vertical direction are basically described. However, a transform combination may be configured with a non-separable transform.

Alternatively, a mixture of separable transforms and non-separable transforms may be configured. In this case, if the non-separable transform is used, transform selection for each row/column or selection for each horizontal/vertical direction becomes unnecessary. The transform combinations of FIG. 6a or 6b may be used only when the separable transform is selected.

Furthermore, methods proposed in the present disclosure may be applied regardless of a primary transform or a secondary transform. That is, there is no restriction in that the methods should be applied to any one of the primary transform and the secondary transform, and both the primary transform and the secondary transform may be applied. In this case, the primary transform may mean a transform for first transforming a residual block. The secondary transform may mean a transform for applying a transform to a block generated as a result of the primary transform.

First, the encoder 100 may determine a transform configuration group corresponding to a current block (S710). In this case, the transform configuration group may mean the transform configuration groups of FIGS. 6a and 6b or FIGS. 44a to 45b, but the present disclosure is not limited thereto. The transform configuration group may be composed of other transform combinations.

The encoder may perform a transform on available candidate transform combinations within the transform configuration group (S720).

As a result of the execution of the transform, the encoder may determine or select a transform combination having the smallest rate distortion (RD) cost (S730).

The encoder may encode a transform combination index corresponding to the selected transform combination (S940).

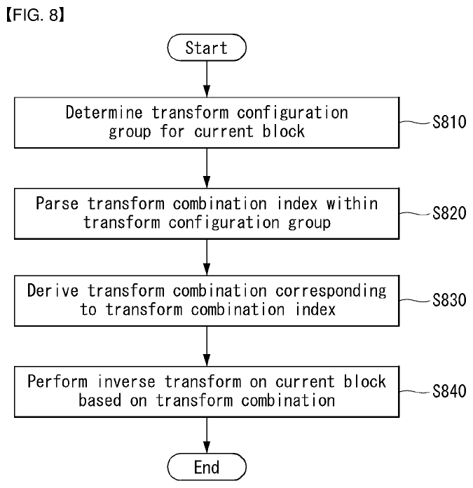

FIG. 8 is an embodiment to which the present disclosure is applied, and is a flowchart illustrating a decoding process in which MTS is performed.

First, the decoder 200 may determine a transform configuration group for a current block (S810). The decoder 200 may parse (or obtain) a transform combination index from a video signal. In this case, the transform combination index may correspond to one of a plurality of transform combinations within the transform configuration group (S820). For example, the transform configuration group may include DST-4, DCT-4, DST-7 and DCT-8. The transform combination index may be called an MTS index. In an embodiment, the transform configuration group may be configured based on at least one of a prediction mode, a block size or a block shape of the current block.

The decoder 100 may derive a transform combination corresponding to the transform combination index (S830). In this case, the transform combination is configured with a horizontal transform and a vertical transform, and may include at least one of DST-4, DCT-4, DST-7 or DCT-8. Furthermore, the transform combination may mean the transform combination described in FIG. 6a or 6b or the combinations of FIGS. 44a to 45b, but the present disclosure is not limited thereto. That is, a configuration based on another transform combination according to another embodiment of the present disclosure is also possible.

The decoder 100 may perform an inverse transform on the current block based on the derived transform combination (S840). If the transform combination is configured with a row (horizontal) transform and a column (vertical) transform, after the row (horizontal) transform is first applied, the column (vertical) transform may be applied, but the present disclosure is not limited thereto. If the transform combination is configured in an opposite way or configured with non-separable transforms, a non-separable transform may be applied.

In an embodiment, if a vertical transform or a horizontal transform is DST-7 or DCT-8, an inverse transform of DST-7 or an inverse transform of DST-8 may be applied for each column, and then applied for each row. Furthermore, in the vertical transform or the horizontal transform, a different transform may be applied for each row and/or for each column.

In an embodiment, a transform combination index may be obtained based on an MTS flag indicating whether MTS is performed. That is, the transform combination index may be obtained only when MTS is performed based on an MTS flag. Furthermore, the decoder 100 may check whether the number of non-zero coefficients is greater than a threshold value. In this case, the transform combination index may be obtained only when the number of non-zero coefficients is greater than the threshold value.

In an embodiment, the MTS flag or the MTS index may be defined in at least one level of a sequence, a picture, a slice, a block, a coding unit, a transform unit, or a prediction unit.

In an embodiment, an inverse transform may be applied only when both the width and height of a transform unit are 32 or less.

According to an embodiment of the present disclosure, DST-4, DCT-4, DST-7, or DCT-8 may be used based on the length of an inverse transformed signal. For example, DST-4 or DCT-4 may be used for a specific length (e.g., 8), and DST-7 or DCT-8 may be used for another length (e.g., 4, 16, 32).

Meanwhile, in another embodiment, the process of determining the transform configuration group and the process of parsing the transform combination index may be simultaneously performed. Alternatively, step S810 may be pre-configured in the encoder 100 and/or the decoder 200 and omitted.

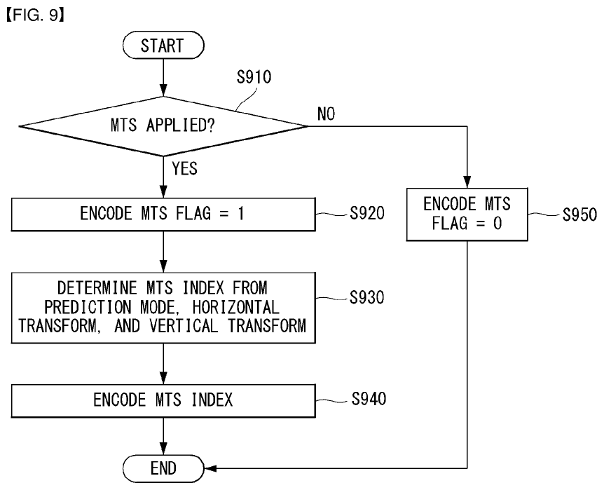

FIG. 9 is an embodiment to which the present disclosure is applied, and is a flowchart for describing a process of encoding an MTS flag and an MTS index.

The encoder 100 may determine whether MTS is applied to a current block (S910).

If the MTS is applied, the encoder 100 may encode the MTS flag=1 (S920).

Furthermore, the encoder 100 may determine an MTS index based on at least one of a prediction mode, horizontal transform, or vertical transform of the current block (S930). In this case, the MTS index means an index indicative of any one of a plurality of transform combinations for each intra-prediction mode, and the MTS index may be transmitted for each transform unit.

When the MTS index is determined, the encoder 100 may encode the MTS index determined at step S930 (S940).

Meanwhile, if the MTS is not applied, the encoder 100 may encode MTS flag=0 (S950).

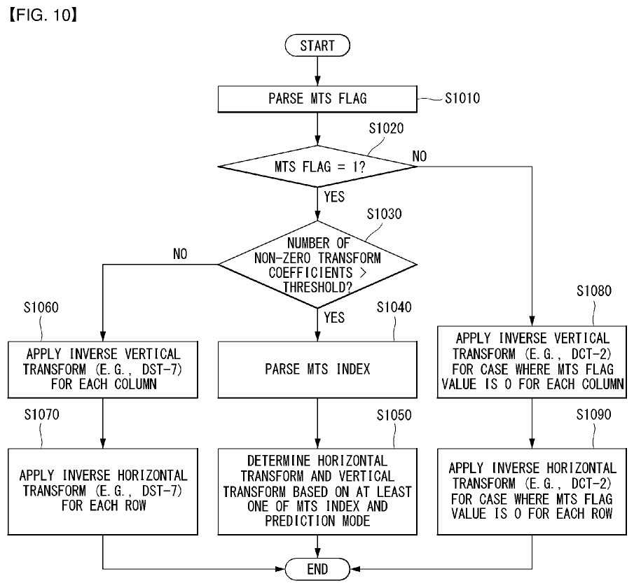

FIG. 10 is an embodiment to which the present disclosure is applied, and is a flowchart for illustrating a decoding process of applying a horizontal transform or a vertical transform to a row or column based on an MTS flag and an MTS index.

The decoder 200 may parse an MTS flag from a bit stream (S1010). In this case, the MTS flag may indicate whether MTS is applied to a current block.

The decoder 200 may check whether the MTS is applied to the current block based on the MTS flag (S1020). For example, the decoder 200 may check whether the MTS flag is 1.

When the MTS flag is 1, the decoder 200 may check whether the number of non-zero coefficients is greater than (or equal to or greater than) a threshold value (S1030). For example, the threshold value for the number of transform coefficients may be set to 2. The threshold value may be set based on a block size or the size of a transform unit.

When the number of non-zero coefficients is greater than the threshold value, the decoder 200 may parse an MTS index (S1040). In this case, the MTS index means an index indicative of any one of a plurality of transform combinations for each intra-prediction mode or each inter-prediction mode. The MTS index may be transmitted for each transform unit. Furthermore, the MTS index may mean an index indicative of any one transform combination defined in a pre-configured transform combination table. In this case, the pre-configured transform combination table may mean the tables of FIGS. 6a and 6b or FIGS. 44a to 44b, but the present disclosure is not limited thereto.

The decoder 100 may derive or determine a horizontal transform and a vertical transform based on at least one of the MTS index or a prediction mode (S1050). Furthermore, the decoder 100 may derive a transform combination corresponding to the MTS index. For example, the decoder 100 may derive or determine a horizontal transform and a vertical transform corresponding to the MTS index.

Meanwhile, when the number of non-zero coefficients is not greater than the threshold value, the decoder 200 may apply a pre-configured vertical inverse transform for each column (S1060). For example, the vertical inverse transform may be an inverse transform of DST-7. Furthermore, the vertical inverse transform may be an inverse transform of DST-8

In an embodiment of the present disclosure, with respect to a specific length, an inverse transform of DST-4 may be used as the vertical inverse transform instead of the inverse transform of DST-7. Furthermore, with respect to a specific length, the inverse transform of DCT-4 may be used as the vertical inverse transform instead of the inverse transform of DST-8.

Furthermore, the decoder may apply a pre-configured horizontal inverse transform for each row (S1070). For example, the horizontal inverse transform may be an inverse transform of DST-7. Furthermore, the horizontal inverse transform may be an inverse transform of DST-8.

In an embodiment of the present disclosure, with respect to a specific length, an inverse transform of DST-4 may be used as the horizontal inverse transform instead of the inverse transform of DST-7. Furthermore, with respect to a specific length, an inverse transform of DCT-4 may be used as the horizontal inverse transform instead of the inverse transform of DST-8.

That is, when the number of non-zero coefficients is not greater than the threshold value, a transform type pre-configured in the encoder 100 or the decoder 200 may be used. For example, not a transform type defined in a transform combination table, such as FIG. 6a or 6b, but a transform type (e.g., DCT-2) which is commonly used may be used.

Meanwhile, when the MTS flag is 0, the decoder 200 may apply a pre-configured vertical inverse transform for each column (S1080). For example, the vertical inverse transform may be an inverse transform of DCT-2.

Furthermore, the decoder 200 may apply a pre-configured horizontal inverse transform for each row (S1090). For example, the horizontal inverse transform may be an inverse transform of DCT-2. That is, when the MTS flag is 0, a transform type pre-configured in the encoder or the decoder may be used. For example, not a transform type defined in a transform combination table, such as FIG. 6a or 6b, but a transform type which is commonly used may be used.

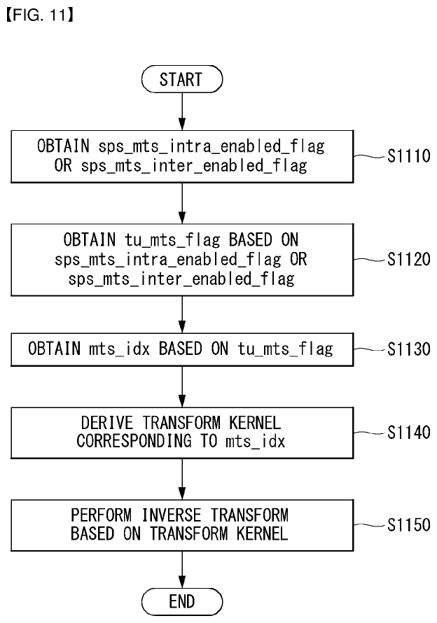

FIG. 11 is an embodiment to which the present disclosure is applied, and illustrates a flowchart in which an inverse transform is performed based on a transform-related parameter.

The decoder 200 to which the present disclosure is applied may obtain sps_mts_intra_enabled_flag or sps_mts_inter_enabled_flag (S1110). In this case, sps_mts_intra_enabled_flag indicates whether tu_mts_flag is present in a residual coding syntax a coding unit to which an intra-prediction is applied (intra-coding unit). For example, when sps_mts_intra_enabled_flag=0, tu_mts_flag is not present in the residual coding syntax of the intra-coding unit. When sps_mts_intra_enabled_flag=0, tu_mts_flag is present in the residual coding syntax of the intra-coding unit. Furthermore, sps_mts_inter_enabled_flag indicates whether tu_mts_flag is present in a residual coding syntax of a coding unit to which an inter-prediction is applied (inter-coding unit). For example, when sps_mts_inter_enabled_flag=0, tu_mts_flag is not present in the residual coding syntax of the inter-coding unit. When sps_mts_inter_enabled_flag=0, tu_mts_flag is present in the residual coding syntax of the inter-coding unit.

The decoder 200 may obtain tu_mts_flag based on sps_mts_intra_enabled_flag or sps_mts_inter_enabled_flag (S1120). For example, when sps_mts_intra_enabled_flag=1 or sps_mts_inter_enabled_flag=1, the decoder 200 may obtain tu_mts_flag. In this case, tu_mts_flag indicates whether MTS is applied to a residual sample of a luma transform unit. For example, when tu_mts_flag=0, the MTS is not applied to a residual sample of the luma transform unit. When tu_mts_flag=1, the MTS is applied to a residual sample of the luma transform unit. At least one of embodiments described in the present disclosure may be applied with respect to Tu_mts_flag=1.

The decoder 200 may obtain mts_idx based on tu_mts_flag (S1130). For example, when tu_mts_flag=1, the decoder may obtain mts_idx. In this case, mts_idx indicates whether which transform kernel is applied to luma residual samples according to the horizontal and/or vertical direction of a current transform block. For example, at least one of the embodiments of the present disclosure may be applied to mts_idx. As a detailed example, at least one of the embodiments of FIGS. 6a and 6b, 44a, or 44b may be applied.

The decoder 200 may derive a transform kernel corresponding to mts_idx (S1140). For example, the transform kernel corresponding to mts_idx may be divided and defined into a horizontal transform and a vertical transform.

For another example, different transform kernels may be applied to the horizontal transform and the vertical transform, but the present disclosure is not limited thereto. The same transform kernel may be applied to the horizontal transform and the vertical transform.

In an embodiment, mts_idx may be defined like Table 1.

TABLE 1

| mts_idx[x0][y0] | trTypeHor | trTypeVer |
|---|---|---|
| 0 | 0 | 0 |
| 1 | 1 | 1 |
| 2 | 2 | 1 |
| 3 | 1 | 2 |
| 4 | 2 | 2 |

Furthermore, the decoder 200 may perform an inverse transform based on the transform kernel derived at step S1140 (S1150).

In FIG. 11, an embodiment in which in order to determine whether to apply MTS, tu_mts_flag is obtained, mts_idx is obtained based on the obtained tu_mts_flag value, and a transform kernel is determined has been basically described, but the present disclosure is not limited thereto. For example, the decoder 200 may determine a transform kernel by directly parsing mts_idx without parsing tu_mts_flag. In this case, Table 1 may be used. That is, when the mts_idx value indicates 0, DCT-2 may be applied in the horizontal/vertical direction. When the mts_idx value indicates a value other than 0, DST-4, DCT-4, DST-7, or DCT-8 may be applied based on the mts_idx value.

In another embodiment of the present disclosure, a decoding process of performing a transform process is described.

The decoder 200 may check a transform size (nTbS). In this case, the transform size (nTbS) may be a variable indicative of a horizontal sample size of scaled transform coefficients.

The decoder 200 may check a transform kernel type (trType). In this case, the transform kernel type (trType) may be a variable indicative of the type of transform kernel, and various embodiments of the present disclosure may be applied. The transform kernel type (trType) may include a horizontal transform kernel type (trTypeHor) and a vertical transform kernel type (trTypeVer).

Referring to Table 1, the transform kernel type (trType) may indicate DCT-2 when it is 0, may indicate DST-7 when it is 1, and may indicate DCT-8 when it is 2.

Furthermore, in an embodiment of the present disclosure, the transform kernel type (trType) in Table 1 may indicate DCT-2 when it is 0, may indicate DST-4 or DST-7 when it is 1, and may indicate DCT-4 or DCT-8 when it is 2.

The decoder 200 may perform a transform matrix multiplication based on at least one of a transform size (nTbS) or a transform kernel type.

For another example, when the transform kernel type is 1 and the transform size is 4, a previously determined transform matrix 1 may be applied when a transform matrix multiplication is performed.

For another example, when the transform kernel type is 1 and the transform size is 8, a previously determined transform matrix 2 may be applied when a transform matrix multiplication is performed.

For another example, when the transform kernel type is 1 and the transform size is 16, a previously determined transform matrix 3 may be applied when a transform matrix multiplication is performed.

For another example, when the transform kernel type is 1 and the transform size is 32, a previously defined transform matrix 4 may be applied.

Likewise, when the transform kernel type is 2 and the transform size is 4, 8, 16, and 32, a previously defined transform matrices 5, 6, 7, and 8 may be applied, respectively.

In this case, each of the previously defined transform matrices 1 to 8 may correspond to any one of various types of transform matrices. For example, the transform matrices of types illustrated in FIG. 6 may be applied.

The decoder 200 may derive a transform sample based on a transform matrix multiplication.

The embodiments may be used, but the present disclosure is not limited thereto. The above embodiment and other embodiments of the present disclosure may be combined and used.

FIG. 12 is an embodiment to which the present disclosure is applied, and is a table illustrating that a transform set is assigned to each intra-prediction mode in an NSST.

The secondary transform unit 122 may apply a secondary transform to a primary transformed signal. In this case, the secondary transform may be pre-defined as a table in the encoder 100 and/or the decoder 200.

In an embodiment, an NSST may be conditionally applied to the secondary transform. For example, the NSST is applied only in the case of an intra-prediction block, and may have an applicable transform set for each prediction mode group.

In this case, the prediction mode group may be configured based on symmetry for a prediction direction. For example, a prediction mode 52 and a prediction mode 16 are symmetrical to each other with respect to a prediction mode 34 (diagonal direction), and thus may form one group, so the same transform set may be applied to the prediction mode 52 and the prediction mode 16. In this case, when a transform for the prediction mode 52 is applied, input data is transposed and applied. The reason for this is that the prediction mode 52 and the prediction mode 16 have the same transform set.

Meanwhile, the planar mode and the DC mode have respective transform sets because symmetry for a direction is not present. A corresponding transform set may be configured with two transforms. With respect to the remaining direction modes, three transforms may be configured for each transform set, but the present disclosure is not limited thereto. Each transform set may be configured with a plurality of transforms.

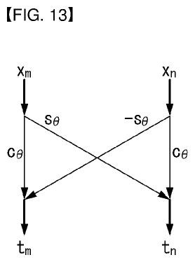

FIG. 13 is an embodiment to which the present disclosure is applied, and illustrates a calculation flow diagram for Givens rotation.

In another embodiment, the NSST is not applied to all of primary transformed blocks, but may be applied to only a top-left 8×8 region. For example, if the size of a block is 8×8 or more, an 8×8 NSST is applied. If the size of a block is less than 8×8, a 4×4 NSST is applied. In this case, the block is divided into 4×4 blocks and the 4×4 NSST is applied to each of the blocks. The NSST may be denoted as a low frequency non-separable transform (LFNST).

As another embodiment, even in the case of 4×N/N×4 (N>=16), the 4×4 NSST may be applied.

Since both the 8×8 NSST and the 4×4 NSST follow a transformation combination configuration described in the present disclosure and are the non-separable transforms, the 8×8 NSST receives 64 data and outputs 64 data and the 4×4 NSST has 16 inputs and 16 outputs.

Both the 8×8 NSST and the 4×4 NSST are configured by a hierarchical combination of Givens rotations. A matrix corresponding to one Givens rotation is shown in Equation 1 below and a matrix product is shown in Equation 2 below.

$$\begin{matrix}{R}_{θ} = [ \begin{matrix}cos θ & - s in θ \\ sin θ & cos θ\end{matrix} ] & [ Equation 1 ] \\ {t}_{m} = {x}_{m} cos θ - {x}_{n} sin θ \\ {t}_{n} = {x}_{m} sin θ + {x}_{n} cos θ & [ Equation 2 ]\end{matrix}$$

As illustrated in FIG. 13 above, since one Givens rotation rotates two data, in order to process 64 data (for the 8×8 NSST) or 16 data (for the 4×4 NSST), a total of 32 or 8 Givens rotations are required.

Therefore, a bundle of 32 or 8 is used to form a Givens rotation layer. Output data for one Givens rotation layer is transferred as input data for a next Givens rotation layer through a determined permutation.

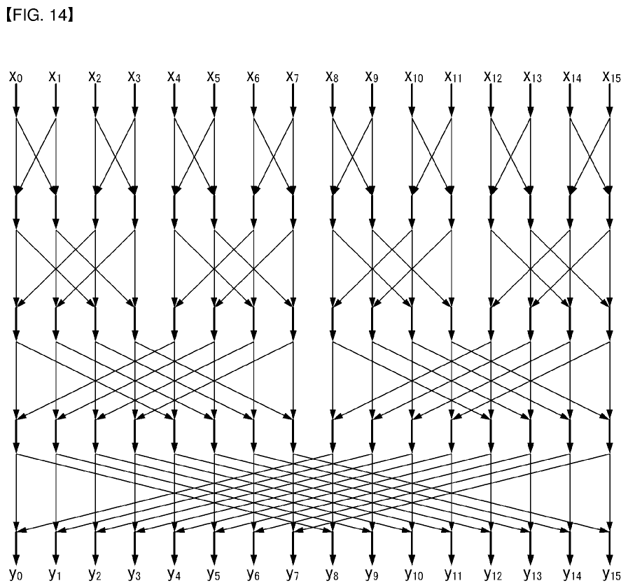

FIG. 14 illustrates one round configuration in 4×4 NSST constituted by a givens rotation layer and permutations as an embodiment to which the present disclosure is applied.

Referring to FIG. 14 above, it is illustrated that four Givens rotation layers are sequentially processed in the case of the 4×4 NSST. As illustrated in FIG. 14 above, the output data for one Givens rotation layer is transferred as the input data for the next Givens rotation layer through a determined permutation (i.e., shuffling).

As illustrated in FIG. 14 above, patterns to be permutated are regularly determined and in the case of the 4×4 NSST, four Givens rotation layers and the corresponding permutations are combined to form one round.

In the case of the 8×8 NSST, six Givens rotation layers and the corresponding permutations form one round. The 4×4 NSST goes through two rounds and the 8×8 NSST goes through four rounds. Different rounds use the same permutation pattern, but applied Givens rotation angles are different. Accordingly, angle data for all Givens rotations constituting each transform need to be stored.

As a last step, one permutation is further finally performed on the data output through the Givens rotation layers, and corresponding permutation information is stored separately for each transform. In forward NSST, the corresponding permutation is performed last and in inverse NSST, a corresponding inverse permutation is applied first on the contrary thereto.

In the case of the inverse NSST, the Givens rotation layers and the permutations applied to the forward NSST are performed in the reverse order and rotation is performed by taking a negative value even for an angle of each Givens rotation.

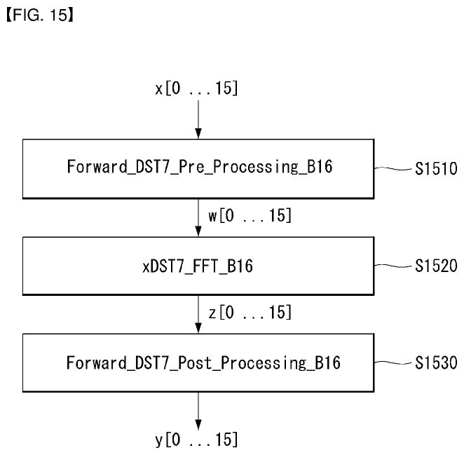

FIG. 15 is an embodiment to which the present disclosure is applied, and illustrates a flowchart in which forward DST-7 having a length 16 is designed using a DFT.

### Embodiment 1-1: Design and Implementation of DST-7 Having Length 16

The present disclosure provides detailed embodiments in which DST-7 is designed using a DFT. Embodiments of the present disclosure may be used for a DCT-8 design and may also be applied to an MTS configuration.

A signal (information) transferred between blocks illustrated in the flowchart of FIG. 15 may be a scalar value, and may have a vector form. For example, the vector may be indicated like x[0 . . . N−1], which indicates a signal (information) composed of N elements like x[0 . . . N−1]=[x[0] x[1] . . . x[N−2] x[N−1]]. A partial signal of the vector x[0 . . . N−1] may be indicated like x[i . . . j]. For example, the partial signal may be indicated like x[5 . . . 10]=[x[5] x[6] x[7] x[8] x[9] x[10]] as one partial signal of x[0 . . . 15].

FIG. 15 illustrates a flowchart in which DST-7 is implemented with respect to one row or column of a length 16. In this case, DST-7 of the length 16 is expressed as DST7_B16, forward DST-7 is expressed as Forward DST7_B16, and inverse DST-7 is expressed as Inverse DST7_B16. Furthermore, it may be indicated that input data is x[0 . . . 15] and the final output data is y[0 . . . 15].

When the input data x[0 . . . 15] is received, the encoder 100 performs pre-processing on the forward DST-7 of the length 16 (S1510).

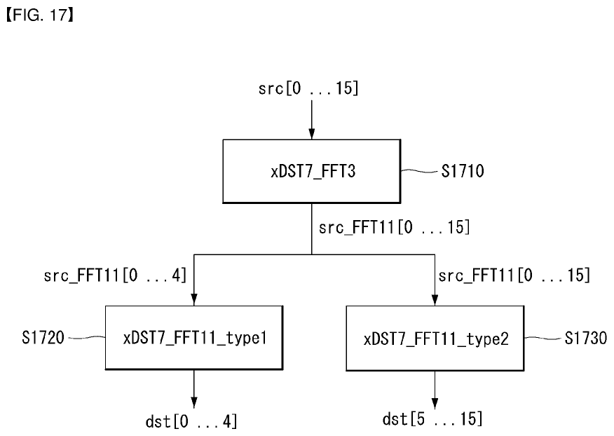

Thereafter, the encoder 100 may apply a DFT to output (w[0 . . . 15]) at step S1510 (S1520). In this case, a detailed process of applying the DFT at step S1520 is described in detail later with reference to FIGS. 17 to 19.

Thereafter, the encoder 100 may perform post-processing on output (z[0 . . . 15]) at step S1520, and may output the final output data y[0 . . . 15] (S1530).

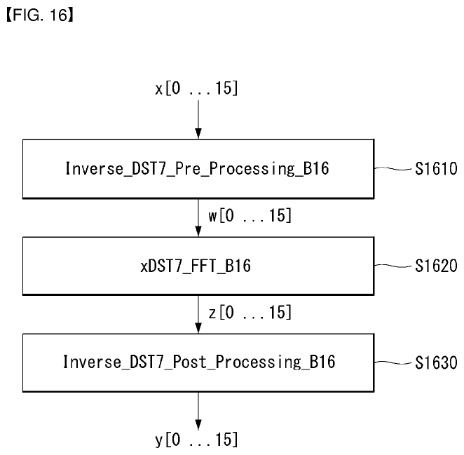

FIG. 16 is an embodiment to which the present disclosure is applied, and illustrates a flowchart in which inverse DST-7 having a length 16 is designed using a DFT. FIG. 16 illustrates a flowchart in which inverse DST-7 is implemented with respect to one row or column of the length 16. In this case, it may be indicated that input data is x[0 . . . 15] and the final output data is y[0 . . . 15].

When the input data x[0 . . . 15] is received, the decoder 200 performs pre-processing on inverse DST-7 having a length 16 (S1610).

The decoder 200 may apply a DFT to output at step S1610 (S1620). In this case, a detailed process of applying the DFT at step S1620 is described in detail later with reference to FIGS. 17 to 19.

The decoder 200 may perform post-processing on output at step S1620, and may output the final output data y[0 . . . 15] (S1630).

FIGS. 17 to 19 are embodiments to which the present disclosure is applied, and illustrate flowcharts in which an xDST7_FFT_B16 function of FIGS. 15 and 16 is applied. FIG. 17 illustrates an implementation of the xDST7_FFT_B16 block of FIGS. 15 and 16.

Referring to FIG. 17, src[0 . . . 15] is input to an xDST7_FFT3 block and src_FFT11 [0 . . . 15] is output (S1710). The output src_FFT11 [0 . . . 15] may be divided into two partial signals and transmitted.

For example, src_FFT11 [0 . . . 4] may be transmitted to an xDST7_FFT11_type1 block and src_FFT11 [5 . . . 15] may be transmitted to an xDST7_FFT11_type2 block.

The xDST7_FFT11_type1 block receives src_FFT11 [0 . . . 4] and outputs dst[0 . . . 4] (S1720).

The xDST7_FFT11_type2 block receives src_FFT11 [5 . . . 15] and outputs dst[5 . . . 15] (S1730).

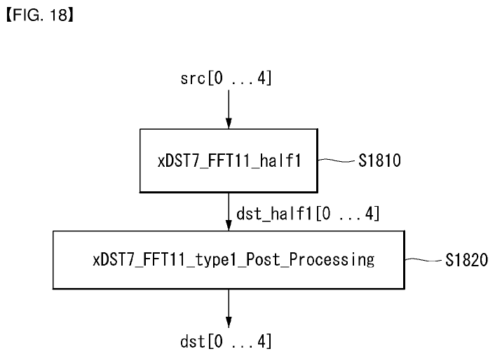

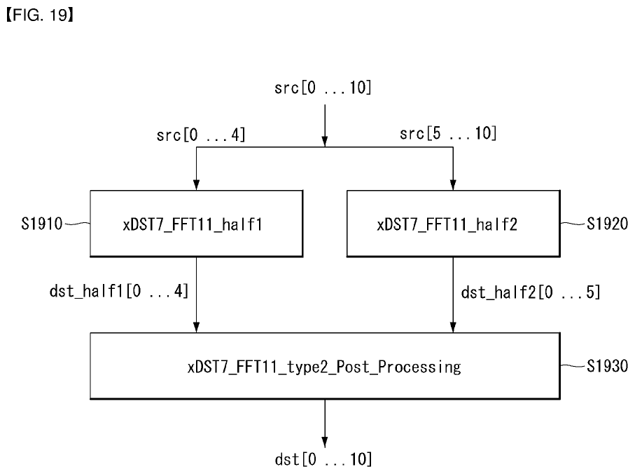

Here, implementation of the xDST7_FFT11_type1 block will be described in detail with reference to FIG. 18 and implementation of the xDST7_FFT11_type2 block will be described in detail with reference to FIG. 19.

Referring to FIG. 18, src[0 . . . 4] is input to an xDST7_FFT11_half1 block and dst_half1[0 . . . 4] is output (S1810).

The output dst_half1 [0 . . . 4] is input to an xDST7_FFT11_type1 block and dst[0 . . . 4] is output (S1820).

Referring to FIG. 19, src[0 . . . 10] is divided into two partial signals and transmitted. For example, src[0 . . . 4] may be transmitted to the xDST7_FFT11_half1 block and src[5 . . . 10] may be transmitted to an xDST7_FFT11_half2 block.

The xDST7_FFT11_half1 block receives src [0 . . . 4] and outputs dst_half1 [0 . . . 4] (S1910).

The xDST7_FFT11_half2 block receives src[5 . . . 10] and outputs dst_half2 [0 . . . 5] (S1920).

The encoder 100/the decoder 200 may perform post-processing output at step S1920 through an xDST7_FFT11_type2_Post_Processing block, and may output the final output data dst[0 . . . 10] (S1930).

In FIG. 17, src_FFT11[5 . . . 15] corresponds to src[0 . . . 10] in FIG. 19. That is, assignment is performed like src[0]=src_FFT11 [5], src[1]=src_FFT11 [6], . . . , src[10]=src_FFT11[15].

Furthermore, in the xDST7_FFT11_type2_Post_Processing block of FIG. 19, dst_half1 [0 . . . 4] and dst_half2[0 . . . 5] are sequentially input from the left. They correspond to parameters src_half1 [0 . . . 4], src_half2[0 . . . 5], respectively. This will be described in detail in a table indicating an operation of each block.

As described above, the block diagrams of FIGS. 15 and 16 may be interpreted as being connected to the block diagrams of FIGS. 17 to 19.

A detailed operation of the functions of FIGS. 15 to 19 may be described by Table 2 to Table 10. An operation described in the following table is represented as a computer programming language, such as C/C++, which may be easily understood by a person having ordinary skill in the art.

Table 2 illustrates an operation of pre-processing (Forward_DST7_Pre_Processing_B16) for forward DST-7 of the length 16.

TABLE 2

| | |
|---|---|
| Name | Forward_DST7_Pre_Processing_B16 |
| Input | src[0 ... 15] |
| Output | dst[0 ... 15] |
| Operation | dst[0] = −src[10]; dst[1] = src[8]; |
| | dst[2] = src[1]; dst[3] = −src[12]; |
| | dst[4] = −src[14]; dst[5] = src[6]; |
| | dst[6] = src[3]; dst[7] = src[5]; |
| | dst[8] = −src[15]; dst[9] = src[4]; |
| | dst[10] = src[2]; dst[11] = src[7]; |
| | dst[12] = −src[13]; dst[13] = −src[11]; |
| | dst[14] = src[0]; dst[15] = src[9]; |

Table 3 illustrates an operation of Forward_DST7_Post_Processing_B16.

TABLE 3

| | |
|---|---|
| Name | Forward_DST7_Post_Processing_B16 |
| Input | src[0 ... 15] |
| Output | dst[0 ... 15] |
| Operation | int aiReordIdx[16] = { 12, 16 + 0, 16 + 14, |
| | 10, 16 + 2, 16 + 5, 8, 16 + 4, 16 + 7, 6, 3, 16 + |
| | 9, 15, 1, 16 + 11, 13 }; |
| | for (int i = 0; i < 16; i++) { |

int index = aiReordIdx[i];
dst[i] = (int)((((index & 0x10) ? −src[index &

0xF] : src[index]) + rnd_factor) >> final_shift);
}

In Table 3, rnd_factor=1<<(final_shift−1) value may be used. Furthermore, in FIGS. 15 and 16, when a function for applying DST-7 to all the rows or columns of one block is used, if a value called a shift is transmitted through a parameter, final_shift=shift−1 value may be used.

Table 4 illustrates an operation of Inverse_DST7_Pre_Processing_B16.

TABLE 4

| | |
|---|---|
| Name | Inverse_DST7_Pre_Processing_B16 |
| Input | src[0 ... 15] |
| Output | dst[0 ... 15] |
| Operation | dst[0] = −src[5]; dst[1] = src[4]; |
| | dst[2] = src[15]; dst[3] = −src[6]; |
| | dst[4] = −src[7]; dst[5] = src[3]; |
| | dst[6] = src[14]; dst[7] = src[13]; |
| | dst[8] = −src[8]; dst[9] = src[2]; |
| | dst[10] = src[1]; dst[11] = src[12]; |
| | dst[12] = −src[9]; dst[13] = −src[10]; |
| | dst[14] = src[0]; dst[15] = src[11]; |

Table 5 illustrates an operation of an Inverse_DST7_Post_Processing_B16 function.

TABLE 5

| | |
|---|---|
| Name | Inverse_DST7_Post_Processing_B16 |
| Input | src[0 ... 15] |
| Output | dst[0 ... 15] |
| Operation | int aiReordIdx[16] = { 12, 13, 16 + 0, 16 + 11, |
| | 16 + 14, 1, 10, 15, 16 + 2, 16 + 9, 16 + 5, 3, 8, 6, |
| | 16 + 4, 16 + 7 }; |
| | for (int i = 0; i < 16; i++) { |

int index = aiReordIdx[i];
dst[i] = Clip3(outputMinimum, outputMaximum,

(int)((((index & 0x10) ? −src[index & 0xF] :
src[index]) + rnd_factor) >> final_shift));
}

In Table 5, rnd_factor=1<<(final_shift−1) value may be used. Furthermore, in FIGS. 15 and 16, when a function for applying DST-7 to all the rows or columns of one block is used, if a value called a shift is transmitted through a parameter, final_shift=shift−1 value may be used.

In Table 5, outputMinimum and outputMaximum indicate a possible minimum value and maximum value of an output value, respectively. A Clip3 function perform an operation of Clip3(A, B, C)=(C<A) ? A:(C>B) ? B:C. That is, the Clip3 function clips a C value so that it must be present in a range from A to B.

Table 6 illustrates an operation of an xDST7_FFT3 function.

TABLE 6

| | |
|---|---|
| Name | xDST7_FFT3 |
| Input | src[0 ... 15] |
| Output | dst[0 ... 15] |
| Operation | int C3 = 443; |
| | dst[10] = ((−src[0] * C3) + rnd_factor) >> shift; |
| | for (int i = 0; i < 5; i++) { |

dst[i] = (((src[3*i + 1] + src[3*i + 2] +
src[3*i + 3]) << 9) + rnd_factor) >> shift;
dst[5 + i] = ((((src[3*i + 1] << 1) − src[3*i +

2] − src[3*i + 3]) << 8) + rnd_factor) >> shift;

dst[11 + i] = (((src[3*i + 3] − src[3*i + 2]) *
C3) + rnd_factor) >> shift;

}

In Table 6, a C3 value means a round

$$( sin ( \frac{2 π}{3} ) \cdot {2}^{9} )$$

value, and indicates that a multiplication coefficient has been scaled by 29. In Table 6, since shift=10, rnd_factor=1<<(shift−1)=29 is applied, dst[i] and dst[5+i] may be calculated like Equation 3.

dst[i]=(src[3*i+1]+src[3*i+2]+src[3*i+3]+1)>>1dst[5+i]=((src[3*i+1]<<1)−src[3*i+2]−src[3*i+3]+2)>>2 [Equation 3]

Table 7 illustrates an operation of an xDST7_FFT11_half1 function.

TABLE 7

| | |
|---|---|
| Name | xDST7_FFT11_half1 |
| Input | src[0 ... 4] |
| Output | dst[0 ... 4] |
| Operation | int C11R[5] = { 193, 324, 353, 269, 100 }; |
| | dst[0] = −src[0] * C11R[0] − src[1] * C11R[1] − src[2] * |
| | C11R[2] − src[3] * C11R[3] − src[4] * C11R[4]; |
| | dst[1] = −src[0] * C11R[1] − src[1] * C11R[3] + src[2] * |
| | C11R[4] + src[3] * C11R[2] + src[4] * C11R[0]; |
| | dst[2] = −src[0] * C11R[2] + src[1] * C11R[4] + src[2] * |
| | C11R[1] − src[3] * C11R[0] − src[4] * C11R[3]; |
| | dst[3] = −src[0] * C11R[3] + src[1] * C11R[2] − src[2] * |
| | C11R[0] − src[3] * C11R[4] + src[4] * C11R[1]; |
| | dst[4] = −src[0] * C11R[4] + src[1] * C11R[0] − src[2] * |
| | C11R[3] + src[3] * C11R[1] − src[4] * C11R[2]; |

In Table 7, the array C11R indicates a value calculated through round

$$( \frac{1}{\sqrt{2 \times 16 + 1}} \cdot sin ( \frac{2 π i}{11} ) \cdot {2}^{11} ) , i = 1 , 2 , 3 , 4 , 5 .$$

Table 8 illustrates an operation of an xDST7_FFT11_half2 function.

TABLE 8

| | |
|---|---|
| Name | xDST7_FFT11_half2 |
| Input | src[0 ... 5] |
| Output | dst[0 ... 5] |
| Operation | intC11I[6] = { 357, 300, 148, −51, −233, −342 }; |
| | dst[0] = (src[0] + src[1] + src[2] + src[3] + |
| | src[4] + src[5]) * C11I[0]; |
| | dst[1] = src[0] * C11I[0] + src[1] * C11I[1] + |
| | src[2] * C11I[2] + src[3] * C11I[3] + src[4] |
| | * C11I[4] + src[5] * C11I[5]; |
| | dst[2] = src[0] * C11I[0] + src[1] * C11I[2] + |
| | src[2] * C11I[4] + src[3] * C11I[5] + src[4] |
| | * C11I[3] + src[5] * C11I[1]; |
| | dst[3] = src[0] *C11I[0] + src[1] * C11I[3] + |
| | src[2] * C11I[5] + src[3] * C11I[2] + src[4] |
| | * C11I[1] + src[5] * C11I[4]; |
| | dst[4] = src[0] * C11I[0] + src[1] * C11I[4] + |
| | src[2] * C11I[3] + src[3] * C11I[1] + src[4] |
| | * C11I[5] + src[5] * C11I[2]; |
| | dst[5] = src[0] * C11I[0] + src[1] * C11I[5] + |
| | src[2] * C11I[1] + src[3] * C11I[4] + src[4] |
| | * C11I[2] + src[5] * C11I[3]; |

In Table 8, the array C11R indicates a value calculated through round

$$( \frac{1}{\sqrt{2 \times 16 + 1}} \cdot cos ( \frac{2 π i}{11} ) \cdot {2}^{11} ) , i = 0 , 1 , 2 , 3 , 4 , 5 .$$

Table 9 illustrates an operation of an xDST7_FFT11_type_1_Post_Processing function.

TABLE 9

| | |
|---|---|
| Name | xDST7_FFT11_type1_Post_Processing |
| Input | src[0 ... 4] |
| Output | dst[0 ... 4] |
| Operation | dst[0] = src[0]; dst[1] = src[1]; dst[2] = |
| | src[2]; dst[3] = src[3]; dst[4] = src[4]; |

Table 10 illustrates an operation of an xDST7_FFT11_type2_Post_Processing function.

TABLE 10

| | |
|---|---|
| Name | xDST7_FFT11_type2_Post_Processing |
| Input | src_half1[0 ... 4], src_half2[0 ... 5] |
| Output | dst[0 ... 10] |
| Operation | dst[0] = src_half2[0]; |
| | dst[1] = src_half2[1] + src_half1[0]; |
| | dst[2] = src_half2[2] + src_half1[1]; |
| | dst[3] = src_half2[3] + src_half1[2]; |
| | dst[4] = src_half2[4] + src_half1[3]; |
| | dst[5] = src_half2[5] + src_half1[4]; |
| | dst[6] = src_half2[5] − src_half1[4]; |
| | dst[7] = src_half2[4] − src_half1[3]; |
| | dst[8] = src_half2[3] − src_half1[2]; |
| | dst[9] = src_half2[2] − src_half1[1]; |
| | dst[10] = src_half2[1] − src_half1[0]; |

If DST-7 is applied to a 16×16 two-dimensional block in a horizontal direction (or a vertical direction), the flowcharts of FIGS. 15 and 16 may be used for 16 rows (or columns).

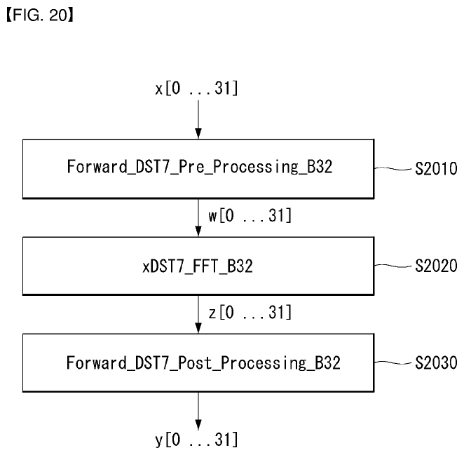

FIG. 20 is an embodiment to which the present disclosure is applied, and illustrates a flowchart in which forward DST-7 having a length 32 is designed using a DFT.

### Embodiment 1-2: Design and Implementation of DST-7 Having Length 32

The present disclosure provides detailed embodiments in which DST-7 is designed using a DFT. Embodiments of the present disclosure may be used for a DCT-8 design, and may be applied to an MTS configuration.

FIG. 20 illustrates a flowchart in which DST-7 is implemented for one row or column having a length 32. In this case, DST-7 of the length 32 is expressed as DST7_B32, forward DST-7 is expressed as Forward DST7_B32, and inverse DST-7 is expressed as Inverse DST7_B32.

Furthermore, it may be indicated that input data is x[0 . . . 31] and the final output data is y[0 . . . 31].

When the input data x[0 . . . 31] is input, the encoder 100 performs pre-processing on forward DST-7 of a length 32 (S2010).

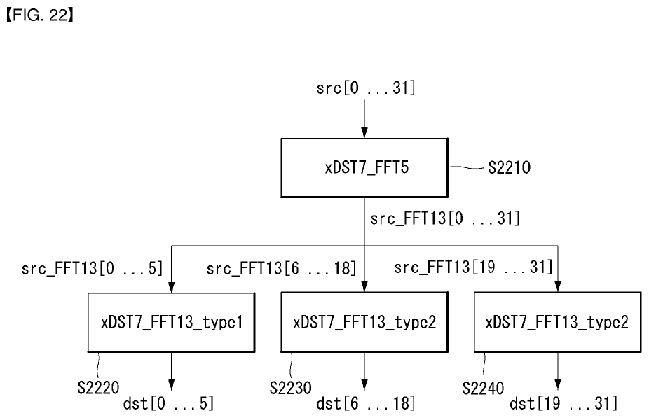

The encoder 100 may apply a DFT to output (w[0 . . . 31]) at step S2010 (S2020). In this case, step S2020 of applying the DFT is described in detail later with reference to FIGS. 22 to 24.

The encoder 100 may perform post-processing on output (z[0 . . . 31]) at step S2020, and may output the final output data y[0 . . . 31] (S2030).

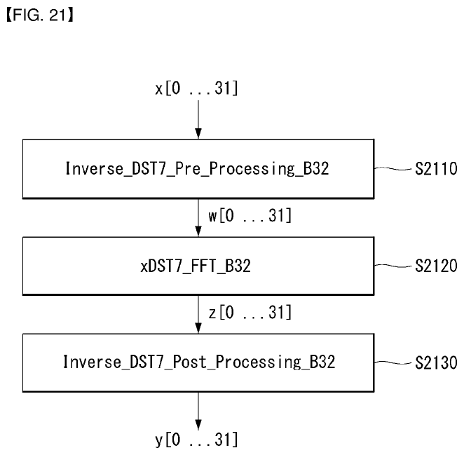

FIG. 21 is an embodiment to which the present disclosure is applied, and illustrates a flowchart in which inverse DST-7 having a length 32 is designed using a DFT.

FIG. 21 illustrates a flowchart in which inverse DST-7 is implemented for one row or column having a length 32. In this case, it may be indicated that input data is x[0 . . . 31] and the final output data is y[0 . . . 31].

When the input data x[0 . . . 31] is input, the decoder 200 performs pre-processing on inverse DST-7 having a length 32 (S2110).

The decoder 200 may apply a DFT to output (w[0 . . . 31]) at step S2110 (S2120). In this case, step S2120 of applying the DFT is described in detail later with reference to FIGS. 22 to 24.

The decoder 200 may perform post-processing on output (z[0 . . . 31]) at step S2120, and may output the final output data y[0 . . . 31] (S2130).

FIGS. 22 to 24 are embodiments to which the present disclosure is applied, and illustrate flowcharts in which an xDST7_FFT_B32 function of FIGS. 20 and 21 is applied. FIG. 22 illustrates an implementation of the xDST7_FFT_B32 block of FIGS. 20 and 21.

Referring to FIG. 22, src[0 . . . 31] is input to an xDST7_FFT5 block and src_FFT13[0 . . . 31] is output (S2210). The output src_FFT13[0 . . . 31] may be divided into three partial signals and transmitted.

For example, src_FFT13[0 . . . 5] may be transmitted to an xDST7_FFT13_type1 block, src_FFT13[6 . . . 18] may be transmitted to an xDST7_FFT13_type2 block, and src_FFT13[19 . . . 31] may be transmitted to an xDST7_FFT13_type2 block.

The xDST7_FFT13_type1 block receives src_FFT13[0 . . . 5] and outputs dst[0 . . . ] (S2220).

The xDST7_FFT13_type2 block receives src_FFT13[6 . . . 18] and outputs dst[6 . . . 18] (S2230).

The xDST7_FFT13_type2 block receives src_FFT13[19 . . . 31] and outputs dst[19 . . . 31] (S2240).

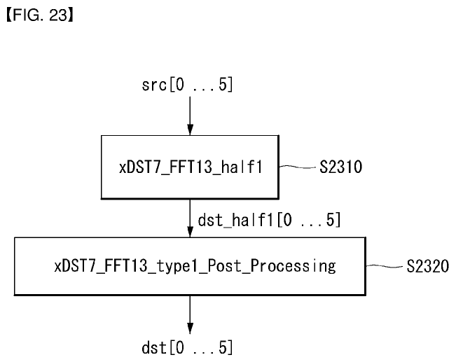

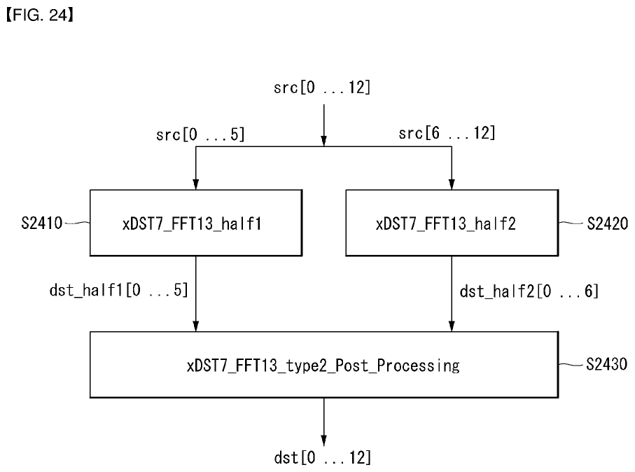

Here, an implementation of the xDST7_FFT13_type1 block will be described in detail with reference to FIG. 23 and implementation of the xDST7_FFT13_type2 block will be described in detail with reference to FIG. 24.

Referring to FIG. 23, src[0 . . . 5] is input to an xDST7_FFT13_half1 block, and dst_half1[0 . . . 5] is output (S2310).

The output dst_half1[0 . . . 5] is input to an xDST7_FFT14 type1_Post_Processing block, and dst[0 . . . 5] is output (S2320).

Referring to FIG. 24, src[0 . . . 12] may be divided into two partial signals and transmitted. For example, src[0 . . . 5] may be transmitted to the xDST7_FFT13_half1 block and src[6 . . . 12] may be transmitted to an xDST7_FFT13_half2 block. The xDST7_FFT13_half1 block receives src [0 . . . 5] and outputs dst_half1 [0 . . . 5] (S2410).

The xDST7_FFT13_half2 block receives src[6 . . . 12] and outputs dst_half2[0 . . . 6] (S2420).

The encoder 100/decoder 200 may perform post-processing output at step S2410, S2420 through the xDST7_FFT13_type2_Post_Processing block, and may output the final output data dst[0 . . . 12] (S1930).

src_FFT13[0 . . . 5] of FIG. 22 corresponds to src[0 . . . 5] of FIG. 23. That is, src[0]=src_FFT13[0], src[1]=src_FFT13[1], . . . , src[5]=src_FFT13[5].

In addition, src_FFT13[6 . . . 18] or src_FFT13[19 . . . 31] of FIG. 22 corresponds to src[0 . . . 12] of FIG. 24. For example, src[0]=src_FFT13[6], src[1]=src_FFT13[7], . . . , src[12]=src_FFT13[18].

In addition, in the xDST7_FFT13_type2_Post_Processing block of FIG. 24, dst_half1 [0 . . . 5] and dst_half2[0 . . . 6] are sequentially input from the left and respectively correspond to input parameters src_half1 [0 . . . 5] and src_half2[0 . . . 6]. This will be described in detail with reference to a table showing the operation of each block.

In this manner, the block diagrams of FIG. 20 and FIG. 21 can be interpreted in connection with the block diagrams of FIG. 22 to FIG. 24. Detailed operations of the functions of FIG. 20 to FIG. 24 can be described with reference to Table 11 to Table 18.

Table 11 illustrates an operation of a Forward_DST7_Pre_Processing_B32 function.

TABLE 11

| | |
|---|---|
| Name | Forward_DST7_Pre_Processing_B32 |
| Input | src[0 ... 31] |
| Output | dst[0 ... 31] |
| Operation | int aiFFTInReordIdx[32] = { 12, 32 + 25, |
| | 32 + 14, 1, 10, 32 + 23, 27, 29, 32 + 16, 3, 8, |
| | 32 + 21, 32 + 19, 31, 32 + 18, 5, 6, 4, 32 + 17, |
| | 30, 32 + 20, 7, 9, 2, 32 + 15, 28, 32 + 22, 32 + |
| | 24, 11, 0, 32 + 13, 26 }; |
| | for (int i = 0; i < 32; i++) { |

int index = aiFFTInReordIdx[i];
dst[i] = (index & 0x20) ? −src[index &
0x1F] : src[index];

}

Table 12 illustrates an operation of a Forward_DST7_Post_Processing_B32 function.

TABLE 12

| | |
|---|---|
| Name | Forward_DST7_Post_Processing_B32 |
| Input | src[0 ... 31] |
| Output | dst[0 ... 31] |
| Operation | int aiFFTOutReordIdx[32] = { 32 + 27, |
| | 32 + 17, 32 + 0, 15, 25, 32 + 29, 32 + 6, |
| | 32 + 2, 13, 23, 32 + 31, 32 + 8, 32 + 4, 11, |
| | 21, 32 + 20, 32 + 10, 5, 9, 19, 32 + 22, 32 + |
| | 12, 3, 7, 30, 32 + 24, 32 + 14, 1, 18, 28, 32 + |
| | 26, 32 + 16 }; |
| | for (int i = 0; i < 32; i++) { |

int index = aiFFTOutReordIdx[i];
dst[i] = (int)((((index & 0x20) ? −src[index &

0x1F] : src[index]) + rnd_factor) >> final_shift);
}

In Table 12, rd_factor=1<<(final_shift−1) value may be used. Furthermore, in FIGS. 20 and 21, when a function for applying DST-7 to all the rows or columns of one block is used, if a value called a shift has been transmitted through a parameter, final_shift=shift−1 value may be used.

Table 13 illustrates an operation of an Inverse_DST7_Pre_Processing_B32 function.

TABLE 13

| | |
|---|---|
| Name | Inverse_DST7_Pre_Processing_B32 |
| Input | src[0 ... 31] |
| Output | dst[0 ... 31] |
| Operation | int aiFFTInReordIdx[32] = { 6, 32 + 19, |
| | 32 + 7, 31, 5, 32 + 20, 18, 17, 32 + 8, 30, 4, |
| | 32 + 21, 32 + 22, 16, 32 + 9, 29, 3, 2, 32 + |
| | 23, 15, 32 + 10, 28, 27, 1, 32 + 24, 14, 32 + 11, |
| | 32 + 12, 26, 0, 32 + 25, 13 }; |
| | for (int i = 0; i < 32; i++) { |

int index = aiFFTInReordIdx[i];
dst[i] = (index & 0x20) ? −dst[index &
0x1F] : dst[index];

}

Table 14 illustrates an operation of an Inverse_DST7_Post_Processing_B32 function.

TABLE 14

| | |
|---|---|
| Name | Inverse_DST7_Post_Processing_B32 |
| Input | src[0 ... 31] |
| Output | dst[0 ... 31] |
| Operation | int aiFFTOutReordIdx[32] = { 32 + 27, 32 + |
| | 16, 32 + 17, 32 + 26, 32 + 0, 28, 15, 18, 25, 1, 32 + |
| | 29, 32 + 14, 32 + 6, 32 + 24, 32 + 2, 30, 13, 7, 23, |
| | 3, 32 + 31, 32 + 12, 32 + 8, 32 + 22, 32 + 4, 19, |
| | 11, 9, 21, 5, 32 + 20, 32+ 10 }; |
| | for (int i = 0; i < 32; i++) { |

int index = aiFFTOutReordIdx[i];
dst[i] = Clip3(outputMinimum, outputMaximum,

(int)((((index & 0x20) ? −src[index & 0x1F] :
src[index]) + rnd_factor) >> final_shift));
}

In Table 14, d_factor=1<<(final_shift−1) value may be used. Furthermore, in FIGS. 20 and 21, when a function for applying DST-7 to all the rows or columns of one block is used, if a value called a shift has been transmitted through a parameter, final_shift=shift−1 value may be used.

In Table 14, outputMinimum and outputMaximum indicate a possible minimum value and maximum value of an output value, respectively. A Clip3 function performs an operation of Clip3(A, B, C)=(C<A) ? A:(C>B) ? B:C. That is, the Clip3 function clips the C value so that it must be present in a range from A to B.

Table 15 illustrates an operation of an xDST7_FFT13_half1 function.

TABLE 15

| | |
|---|---|
| Name | xDST7_FFT13_half1 |
| Input | src[0 ... 5] |
| Output | dst[0 ... 5] |
| Operation | int C13R[6] = { 167, 296, 357, 336, 238, 86 }; |
| | dst[0] = −src[0] * C13R[0] − src[1] * |
| | C13R[1] − src[2] * C13R[2] − src[3] * C13R[3] − |
| | src[4] * C13R[4] − src[5] * C13R[5]; |
| | dst[1] = −src[0] * C13R[1] − src[1] * |
| | C13R[3] − src[2] * C13R[5] + src[3] * C13R[4] + |
| | src[4] * C13R[2] + src[5] * C13R[0]; |
| | dst[2] = −src[0] * C13R[2] − src[1] * |
| | C13R[5] + src[2] * C13R[3] + src[3] * C13R[0] − |
| | src[4] * C13R[1] − src[5] * C13R[4]; |
| | dst[3] = −src[0] * C13R[3] + src[1] * |
| | C13R[4] + src[2] * C13R[0] − src[3] * C13R[2] + |
| | src[4] * C13R[5] + src[5] * C13R[1]; |
| | dst[4] = −src[0] * C13R[4] + src[1] * |
| | C13R[2] − src[2] * C13R[1] + src[3] * C13R[5] + |
| | src[4] * C13R[0] − src[5] * C13R[3]; |
| | dst[5] = −src[0] * C13R[5] + src[1] * |
| | C13R[0] − src[2] * C13R[4] + src[3] * C13R[1] − |
| | src[4] * C13R[3] + src[5] * C13R[2]; |

In Table 15, the array C13R indicates a value calculated through round

$$( \frac{1}{\sqrt{2 \times 32 + 1}} \cdot \sqrt{2} \cdot sin ( \frac{2 π i}{13} ) \cdot {2}^{11} ) , i = 1 , 2 , 3 , 4 , 5 , 6 .$$

Table 16 illustrates an operation of an xDST7_FFT13_half2 function.

TABLE 16

| | |
|---|---|
| Name | xDST7_FFT13_half2 |
| Input | src[0 ... 6] |
| Output | dst[0 ... 6] |
| Operation | int C13I[7] = { 359, 318, 204, 43, −127, −269, −349 }; |
| | dst[0] = (src[0] + src[1] + src[2] + src[3] + |
| | src[4] + src[5] + src[6]) * C13I[0]; |
| | dst[1] = src[0] * C13I[0] + src[1] * C13I[1] + |
| | src[2] * C13I[2] + src[3] * C13I[3] + src[4] |
| | * C13I[4] + src[5] * C13I[5] + src[6] * C13I[6]; |
| | dst[2] = src[0] * C13I[0] + src[1] * C13I[2] + |
| | src[2] * C13I[4] + src[3] * C13I[6] + src[4] |
| | * C13I[5] + src[5] * C13I[3] + src[6] * C13I[1]; |
| | dst[3] = src[0] * C13I[0] + src[1] * C13I[3] + |
| | src[2] * C13I[6] + src[3] * C13I[4] + src[4] |
| | * C13I[1] + src[5] * C13I[2] + src[6] * C13I[5]; |
| | dst[4] = src[0] * C13I[0] + src[1] * C13I[4] + |
| | src[2] * C13I[5] + src[3] * C13I[1] + src[4] |
| | * C13I[3] + src[5] * C13I[6] + src[6] * C13I[2]; |
| | dst[5] = src[0] * C13I[0] + src[1] * C13I[5] + |
| | src[2] * C13I[3] + src[3] * C13I[2] + src[4] |
| | * C13I[6] + src[5] * C13I[1] + src[6] * C13I[4]; |
| | dst[6] = src[0] * C13I[0] + src[1] * C13I[6] + |
| | src[2] * C13I[1] + src[3] * C13I[5] + src[4] |
| | * C13I[2] + src[5] * C13I[4] + src[6] * C13I[3]; |

In Table 16, the array C13I indicates a value calculated through round

$$( \frac{1}{\sqrt{2 \times 32 + 1}} \cdot \sqrt{2} \cdot sin ( \frac{2 π i}{13} ) \cdot {2}^{11} ) , i = 0 , 1 , 2 , 3 , 4 , 5 , 6.$$

Table 17 illustrates an operation of an xDST7_FFT13_type1_Post_Processing function.

TABLE 17

| | |
|---|---|
| Name | xDST7_FFT13_type1_Post_Processing |
| Input | src[0 ... 5] |
| Output | dst[0 ... 5] |
| Operation | dst[0] = src[0]; dst[1] = src[1]; dst[2] = src[2]; |
| | dst[3] = src[3]; dst[4] = src[4]; dst[5] = src[5]; |

Table 18 illustrates an operation of an xDST7_FFT13_type2_Post_Processing function.

TABLE 18

| | |
|---|---|
| Name | xDST7_FFT13_type2_Post_Processing |
| Input | src_half1[0 ... 5], src_half2[0 ... 6] |
| Output | dst[0 ... 12] |
| Operation | dst[0] = src_half2[0]; |
| | for (int i = 0; i < 6; i++) { |

dst[1 + i] = src_half1[i] + src_half2[1 + i];

}
for (int i = 0; i < 6; i++) {

dst[7 + i] = −src_half1[5 − i] + src_half2[6 − i];

}

If DST-7 is applied to a 32×32 two-dimensional block in the horizontal direction (or vertical direction), the flowchart of FIGS. 20 and 21 may be used for 32 rows (or columns).

FIG. 25 is an embodiment to which the present disclosure is applied, and illustrates a flowchart in which forward DST-7 having a length 8 is designed using a DFT. In this case, the length 8 indicates the width or height of a transform block to which a transform is applied.

### Embodiment 1-3: Design and Implementation of DST-7 Having Length 8

The present disclosure provides detailed embodiments in which DST-7 is designed using a DFT. Embodiments of the present disclosure may also be used for a DCT-8 design, and may also be applied to an MTS configuration.

FIG. 25 illustrates a flowchart in which DST-7 is implemented for one row or column of the length 8. In this case, DST-7 of the length 8 is expressed as DST7_B8, forward DST-7 is expressed as Forward DST7_B8, and inverse DST-7 is expressed as Inverse DST7_B8.

Furthermore, it may be indicated that input data is x[0 . . . 7] and the final output data is y[0 . . . 7].

When the input data x[0 . . . 7] is input, the encoder 100 performs pre-processing on forward DST-7 of the length 8 (S2510).

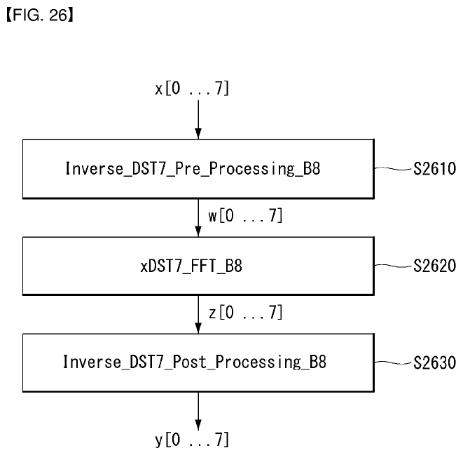

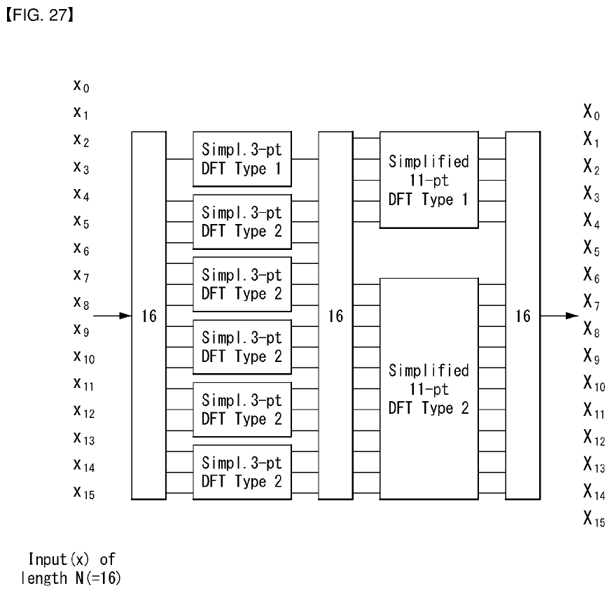

The encoder 100 may apply a DFT to output (w[0 . . . 7]) at step S2510 (S2520). In this case, a detailed process of applying the DFT at step S2520 is described in detail later with reference to FIGS. 27 and 28.

The encoder 100 may perform post-processing on output (z[0 . . . 7]) at step S2520, and may output the final output data y[0 . . . 7] (S2530).

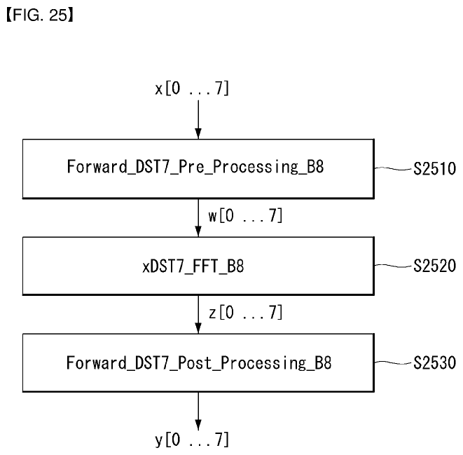

FIG. 26 is an embodiment to which the present disclosure is applied, and illustrates a flowchart in which inverse DST-7 having a length 8 is designed using a DFT. FIG. 26 illustrates a flowchart in which inverse DST-7 is implemented for one row or column of the length 8. In this case, it may be indicated input data is x[0 . . . 7] and the final output data is y[0 . . . 7].

When the input data x[0 . . . 7] is input, the decoder 200 performs pre-processing on inverse DST-7 having a length 8 (S2610).

The decoder 200 may apply a DFT to output (w[0 . . . 7]) at step S2610 (S2620). In this case, step S2620 of applying the DFT is described in detail later with reference to FIGS. 27 and 28.

The decoder 200 may perform post-processing on output (z[0 . . . 7]) at step S2620, and may output the final output data y[0 . . . 7] (S2630).

A detailed operation of the functions of FIGS. 25 and 26 may be described by Table 19 to Table 23.

Table 19 illustrates an operation of a Forward_DST7_Pre_Processing_B8 function.

TABLE 19

| | |
|---|---|
| Name | Forward_DST7_Pre_Processing_B8 |
| Input | src[0 ... 7] |
| Output | dst[0 ... 7] |
| Operation | dst[0] = src[1]; dst[1] = src[3]; |
| | dst[2] = src[5]; dst[3] = src[7]; |
| | dst[4] = src[6]; dst[5] = src[4]; |
| | dst[6] = src[2]; dst[7] = src[0]; |

Table 20 illustrates an operation of a Forward_DST7_Post_Processing_B8 function.

TABLE 20

| | |
|---|---|
| Name | Forward_DST7_Post_Processing_B8 |
| Input | src[0 ... 7] |
| Output | dst[0 ... 7] |
| Operation | for (int i = 0; i < 8; i++) { |

dst[i] = (int)((src[i] + rnd_factor) >> shift);

}

In Table 20, rnd_factor=1<<(shift−1) value may be used. In this case, a shift value is a value transmitted through a parameter when a function for applying DST-7 to all the rows or columns of one block is used.

Table 21 illustrates an operation of an Inverse_DST7_Pre_Processing_B8 function.

TABLE 21

| | |
|---|---|
| Name | Inverse_DST7_Pre_Processing_B8 |
| Input | src[0 ... 7] |
| Output | dst[0 ... 7] |
| Operation | dst[0] = dst[7]; dst[1] = dst[6]; dst[2] = dst[5]; |
| | dst[3] = dst[4]; |
| | dst[4] = dst[3]; dst[5] = dst[2]; dst[6] = dst[1]; |
| | dst[7] = dst[0]; |

Table 22 illustrates an operation of an Inverse_DST7_Post_Processing_B8 function.

TABLE 22

| | |
|---|---|
| Name | Inverse_DST7_Post_ProcessingB8 |
| Input | src[0 ... 7] |
| Output | dst[0 ... 7] |
| Operation | int aiReordIdx[8] = { 0, 7, 1, 6, 2, 5, 3, 4 }; |
| | for (int i = 0; i < 8; i++) { |

dst[i] = Clip3(outputMinimum, outputMaximum,

(int)((src[aiReordIdx[i]]) + rnd_factor) >> shift);
}

In Table 22, rnd_factor=1<<(shift−1) value may be used. In this case, a shift value is a value transmitted through a parameter when a function for applying DST-7 to all the rows or columns of one block is used.

In Table 5, outputMinimum and outputMaximum indicate a possible minimum value and maximum value of an output value, respectively. A Clip3 function performs an operation of Clip3(A, B, C)=(C<A) ? A:(C>B) ?B:C. That is, Clip3 function clips the C value so that it must be present in a range from A to B.

Table 23 indicates an operation of an xDST7_FFT_B8 function.

TABLE 23

| | |
|---|---|
| Name | xDST7_FFT_B8 |
| Input | src[0 ... 7] |
| Output | dst[0 ... 7] |
| Operation | int C8[8] = { 127, 237, 314, 350, 338, 280, 185, 65 }; |
| | dst[0] = src[0] * C8[0] + src[1] * C8[1] + |
| | src[2] * C8[2] + src[3] * C8[3] + src[4] * C8[4] + |
| | src[5] * C8[5] + src[6] * C8[6] + src[7] * C8[7]; |
| | dst[1] = src[0] * C8[2] + src[1] * C8[5] − |
| | src[2] * C8[7] − src[3] * C8[4] − src[4] * C8[1] + |
| | src[5] * C8[0] + src[6] * C8[3] + src[7] * C8[6]; |
| | dst[2] = src[0] * C8[4] − src[1] * C8[6] − |
| | src[2] * C8[1] + src[3] * C8[2] + src[4] * C8[7] − |
| | src[5] * C8[3] + src[6] * C8[0] + src[7] * C8[5]; |
| | dst[3] = src[0] * C8[6] − src[1] * C8[2] + |
| | src[2] * C8[3] − src[3] * C8[5] + src[4] * C8[0] + |
| | src[5] * C8[7] − src[6] * C8[1] + src[7] * C8[4]; |
| | dst[4] = −src[0] * C8[7] + src[1] * C8[0] − |
| | src[2] * C8[6] + src[3] * C8[1] − src[4] * C8[5] + |
| | src[5] * C8[2] − src[6] * C8[4] + src[7] * C8[3]; |
| | dst[5] = −src[0] * C8[5] + src[1] * C8[4] − |
| | src[2] * C8[0] − src[3] * C8[6] + src[4] * C8[3] − |
| | src[5] * C8[1] − src[6] * C8[7] + src[7] * C8[2]; |
| | dst[6] = −src[0] * C8[3] − src[1] * C8[7] + |
| | src[2] * C8[4] + src[3] * C8[0] − src[4] * C8[2] − |
| | src[5] * C8[6] + src[6] * C8[5] + src[7] * C8[1]; |
| | dst[7] = −src[0] * C8[1] − src[1] * C8[3] − |
| | src[2] * C8[5] − src[3] * C8[7] + src[4] * C8[6] + |
| | src[5] * C8[4] + src[6] * C8[2] + src[7] * C8[0]; |

In Table 23, the array C8 indicates a value calculated through round

$$( \frac{1}{\sqrt{2 \times 8 + 1}} . \sqrt{2} \cdot sin ( \frac{2 π i}{17} ) \cdot {2}^{10} ) , i = 1 , 2 , 3 , 4 , 5 , 6 , 7 , 8 .$$

If DST-7 is applied to an 8×8 two-dimensional block in the horizontal direction (or vertical direction), the flowchart of FIGS. 25 and 26 may be used for 8 rows (or columns).

### Embodiment 1-4: Method of Partially Applying the DST-7 Implementations Proposed in the Embodiments 1-1 to 1-3

The DST-7 implementation proposed in the embodiment 1-1 and the embodiment 1-2 may be applied to DST-7 for the length 16 and DST-7 for the length 32. The DST-7 implementation proposed in the embodiment 1-3 may be applied to DST-7 for the length 8, but the present disclosure is not limited thereto, and may be differently applied. For example, if the DST-7 implementation proposed in the embodiment 1-3 is not applied, A DST-7 implementation of a common matrix multiplication form may be applied.

### Embodiment 1-5: Implementation of DST-7 Using DFT

A matrix form of N×N DST-7 may be represented as in Equation 7.

$${[ {S}_{N}^{VII} ]}_{n , k} = \frac{2}{\sqrt{2 N + 1}} sin ( \frac{π ( 2 k + 1 ) ( n + 1 )}{2 N + 1} ) , \\ n , k = 0 , 1 , … , N - 1 \qquad [ Equation 4 ]$$

In this case, if n is a row index from 0 to N−1 and k is a column index from 0 to N−1, a matrix of Equation 4 is matched with an inverse DST-7 matrix by which transform coefficients are multiplied in order to restore original inputs.

Accordingly, the transpose matrix of Equation 4 is a forward DST-7 matrix. Furthermore, forward DST-7 and inverse DST-7 matrices are orthogonal to each other, and a default vector of each of them has norm 1.

Based on Equation 4, a relation between DST-7 and DFT may be represented as in Equation 5.

$${( {S}_{N}^{VII} )}^{T} = R𝔍 [ {F}_{2 N + 1} ] QP , {where [ R ]}_{n , k} = \{ \begin{matrix}- 1 , & if k = 2 n + 1 , n = 0 , 1 , … , N - 1 \\ 0 , & otherwise\end{matrix} , \\ Q = ( \begin{matrix}{0}^{T} \\ {I}_{N} \\ - {J}_{N}\end{matrix} ) , {and [ P ]}_{n , k} = \{ \begin{matrix}1 , & if k + 1 = 2 ( n + 1 ) , & n = 0 , 1 , … , N / 2 - 1 \\ 1 , & if k + 1 = 2 ( N - n ) - 1 , & n = N / 2 , … , N - 1 \\ 0 , & otherwise & \end{matrix} \qquad [ Equation 5 ]$$

In Equation 5, R is an N×(2N+1) matrix (the number of rows×columns), Q is an (2N+1)×N matrix, and P is an N×N matrix I_{N} indicates an N×N identity matrix, and J_{N} indicates

$${[ {J}_{N} ]}_{ij , i , j = 0 , … , N - 1} = \{ \begin{matrix}1 , J = N - 1 - i \\ 0 , otherwise\end{matrix} .$$

In Equation 5, ·[F_{2N+1}] means that after a DFT of the length (2N+1) is performed, only the imaginary part of the DFT results is taken. Equation 5 is held only when N is an even number. More specifically, ·[F_{2N+1}] means that when x input to forward DST-7 is an N×1 vector, if z=QPx is calculated, a (2N+1)×1 vector(z) is output, and after a DFT of a 2N+1 length is performed using the vector(z) as input, only the imaginary part is taken.

As in Equation 5, with respect to the matrices P, Q, and R, the rearranging of N inputs and the assigning of a sign (+/−) are performed so that a major calculation part becomes a 2N+1 length DFT in the forward DST-7.

The present embodiment uses DST-7 of a 2n×2n (N=2n) size. Accordingly, 9-point DFT, 17-point DFT, 33-point DFT, and 65-point DFTs may be applied when N=4, 8, 16, and 32, respectively.

In the embodiment, the case of N=8, 16, or 32 is basically described. The designs of corresponding DFTs are introduced in the form of an equivalent multi-dimensional DFT. There is provided a method of integrating the DFTs in order to obtain low complexity DST-7.

Inverse N×N DST-7 matched with forward DST-6 may be represented as a 2N+1 length DFT as in Equation 6:

$${S}_{N}^{VII} = R𝔍 [ {F}_{2 N + 1} ] QP , {where [ R ]}_{n , k} = \{ \begin{matrix}1 , & if k = n + 1 , & n = 1 , 3 , … , N - 1 \\ - 1 , & if k = n + 1 , & n = 0 , 2 , … , N - 2 \\ 0 , & otherwise & \end{matrix} , \\ Q = ( \begin{matrix}{0}^{T} \\ {J}_{N} \\ - {I}_{N}\end{matrix} ) , {and [ P ]}_{n , k} = \{ \begin{matrix}1 , & if k = n , & n = 0 , 1 , … , N - 1 \\ 0 , & otherwise & \end{matrix} \qquad [ Equation 6 ]$$

In this case, R indicates an Nx (2N+1) matrix (the number of rows×columns), Q indicates a (2N+1)×N matrix, and I_{N} indicates an N×N identity matrix. The definition of J_{N} is the same as that in Equation 5.

·[F_{2N1}] means that when x input to forward DST-7 is an N×1 vector, if z=Qx is calculated, a (2N+1)×1 vector(z) is output, and only the imaginary part is taken after a DFT of a 2N+1 length is performed using the vector(z) as input. That is, the meaning of ·[F_{2N+1}] in Equation 6 is the same as the definition in Equation 5 except that z=QPx is calculated.

In Equation 6, N is an even number. Furthermore, the same DFT of a 2N+1 length as that in forward DST-7 may be used in inverse DST-7.

A trigonometric transform having a length of an even number may be applied to a codec system to which the present disclosure is applied. For example, DFTs of lengths 17, 33, 65, and 129 are necessary for DST-7 of lengths 8, 16, 32, and 64 from Equation 5. 33-point DFT and 65-point DFT to which DST-7 for the lengths 8 and 16 will be applied may be represented as one-dimensional DFTs as in Equation 7 and Equation 8, respectively. Equation 9 indicates a DFT equation for a common length N.

$$\begin{matrix}X ( k ) = \frac{1}{\sqrt{2 \cdot 16 + 1}} {\sum }_{n = 0}^{32} x ( n ) {W}_{N}^{nk} , {W}_{N} = {e}^{- j ( 2 π / 33 )} & [ Equation 7 ] \\ X ( k ) = \frac{1}{\sqrt{2 \cdot 32 + 1}} {\sum }_{n = 0}^{64} x ( n ) {W}_{N}^{n k} , {W}_{N} = {e}^{- j ( 2 π / 65 )} & [ Equation 8 ] \\ X ( k ) = \frac{1}{\sqrt{N}} {\sum }_{n = 0}^{N - 1} x ( n ) {W}_{N}^{nk} , {W}_{N} = {e}^{- j ( 2 π / M )} & [ Equation 9 ]\end{matrix}$$

For an N×N DST-7 implementation, a process to which the DFT of the length 2N+1 is applied has been described, but in contents including Equation 7 and Equation 8, a length N may be used instead of the length 2N+1, for convenience of an expression. Accordingly, if a DFT is applied through Equation 5 and Equation 6, a proper transform in the expression is necessary.

Furthermore, a one-dimensional 33-point DFT and a one-dimensional 65-point DFT are also represented as equivalent two-dimensional DFTs, respectively, through a simple input/output data transform, and corresponding equations are the same as Equation 10 and Equation 11.

$$\begin{matrix}\hat{X} ( {k}_{1} , {k}_{2} ) = \frac{1}{\sqrt{2 \cdot 16 + 1}} {\sum }_{{n}_{2} = 0}^{10} {\sum }_{{n}_{1} = 0}^{2} \hat{x} ( {n}_{1} , {n}_{2} ) {W}_{3}^{{n}_{1} {k}_{1}} {W}_{11}^{{n}_{2} {k}_{2}} = {\sum }_{{n}_{2} = 0}^{10} \hat{y} ( {k}_{1} , {n}_{2} ) {W}_{11}^{{n}_{2} {k}_{2}} & [ Equation 10 ] \\ \hat{X} ( {k}_{1} , {k}_{2} ) = \frac{1}{\sqrt{2 \cdot 32 + 1}} {\sum }_{{n}_{2} = 0}^{12} {\sum }_{{n}_{1} = 0}^{4} \hat{x} ( {n}_{1} , {n}_{2} ) {W}_{5}^{{n}_{1} {k}_{1}} {W}_{13}^{{n}_{2} {k}_{2}} = {\sum }_{{n}_{2} = 0}^{12} \hat{y} ( {k}_{1} , {n}_{2} ) {W}_{13}^{{n}_{2} {k}_{2}} & [ Equation 11 ]\end{matrix}$$

In this case, n indicates an index for input data, and k indicates an index for a transform coefficient.

Hereinafter, a residue of a number is indicated like [symbol] x [symbol] _{N}=x mod N. Furthermore, four index variables n1, n2, k1, and k2 are introduced. A relation between 33-point DFT and 65-point DFTs may be indicated like Equation 12 and Equation 13.

n= [symbol] 22n₁+12n₂ [symbol] ₃₃

k= [symbol] 11k₁+3k₂ [symbol] ₃₃ [Equation 12]

n= [symbol] 26n₁+40n₂ [symbol] ₆₅

k= [symbol] 13k₁+5k₂ [symbol] ₆₅ [Equation 13]

In this case, n indicates an index for input data, and k indicates an index for a transform coefficient. Equation 12 indicates an index mapped to the 33-point DFT, and Equation 13 indicates an index mapped to the 65-point DFT.

Input/output data mapping between a one-dimensional DFT and a two-dimensional DFT by Equation 12 and Equation 13 is given like Equation 14 and Equation 15. From Equations 12 and 13, the present embodiment may define new input/output variables like Equation 14 and Equation 15 based on two index arguments \hat{x}(n₁,n₂) and \hat{X}(k₁,k₂).

\hat{x}(n₁,n₂)=x [symbol] 22n₁+12n₂ [symbol] ₃₃)

\hat{X}(k₁,k₂)=X [symbol] 11k₁+3k₂ [symbol] ₃₃) [Equation 14]

\hat{x}(n₁,n₂)=x [symbol] 26n₁+40n₂ [symbol] ₆₅)

\hat{X}(k₁,k₂)=X [symbol] 13k₁+5k₂ [symbol] ₆₅) [Equation 14]

In this case, [symbol] x [symbol] _{N}=x mod N.

### Embodiment 1-6: Method of Indexing Two-Dimensional DFT Constituting DST-7

A two-dimensional DFT is made possible by Equation 12 and Equation 14, but the present disclosure is not limited thereto. That is, if Equation 16 is satisfied, two-dimensional DFTs, such as Equation 10 and Equation 11, may be formed.

N=N₁N₂

n= [symbol] K₁n₁+K₂n₂ [symbol] _{N}

k= [symbol] K₃k₁+K₄k₂ [symbol] _{N}

[symbol]

K₁K₃ [symbol] _{N}=N₂

[symbol]

K₂K₄ [symbol] _{N}=N₁

[symbol]

K₂K₄ [symbol] _{N}= [symbol] K₂K₄ [symbol] _{N}=0 [Equation 16]

In this case, N₁ and N₂ indicate mutually prime factors. Furthermore, [symbol] x [symbol] _{N}=x mod N.

A 33-point one-dimensional DFT corresponds to (N1, N2)=(3, 11), and a 65-point one-dimensional DFT corresponds to (N1, N2)=(5, 13). In both cases, since both N1 and N2 are mutually prime factors, Equation 19 may be applied. If K1, K2, K3, and K4 satisfy Equation 17, the [symbol] K₁K₄ [symbol] _{N}= [symbol] K₂K₃ [symbol] _{N}=0 condition in Equation 16 is satisfied.

K₁=αN₂,K₂=βN₁,K₃=γN₂,K₄=δN₁ [Equation 17]

Furthermore, in order for other conditions of Equation 16 to be satisfied, a relation equation in Equation 18 needs to be satisfied.

[symbol]

αγN₂ [symbol] _{N}_{₁}=1, [symbol] βδN₁ [symbol] _{N}_{₂}=1 [Equation 18]

Accordingly, all a, P, y, and b satisfying Equation 18 can derive K1, K2, K3, and K4 satisfying Equation 16 from Equation 17. Accordingly, an equivalent two-dimensional DFT can be configured. Embodiments of possible α, β, γ, and δ are as follows.

1) (α, β, γ, δ)=(2,4,1,1)

This is a case where it corresponds to Equation 12 and (N1, N2)=(3, 11).

2) (α, β, γ, δ)=(2,8,1,1)

This is a case where it corresponds to Equation 13 and (N1, N2)=(5, 13).

3) (α, β, γ, δ)=(1,1,2,4)

This is a case where (N1, N2)=(3, 11).

4) (α, β, γ, δ)=(1,1,2,8)

This is a case where it corresponds to (N1, N2)=(5, 13).

If a corresponding two-dimensional DFT is configured by K1, K2, K3, and K4 derived from, β, γ, and δ satisfying Equation 18, in a process of calculating the two-dimensional DFT, symmetry between input/output data and an intermediate result value, such as that in the equations, may occur.

Accordingly, although the two-dimensional DFT is a two-dimensional DFT having an index (i.e., having different α, β, γ, δ values) different from that in the embodiments, complexity necessary to perform DST-7 can be significantly reduced by applying the method and structure proposed in the embodiments.

In summary, a DFT for a length N (N=N₁N₂, N₁ and N₂ are relatively primes) may be calculated as a two-dimensional DFT, such as Equation 19, by an index transform (i.e., a transform between a one-dimensional index and a two-dimensional index) satisfying Equations 16 to 18.

$$\hat{X} ( {k}_{1} , {k}_{2} ) = \frac{1}{\sqrt{N}} {\sum }_{{n}_{2} = 0}^{{N}_{2} - 1} {\sum }_{{n}_{1} = 0}^{{N}_{1} - 1} \hat{x} ( {n}_{1} , {n}_{2} ) {W}_{{N}_{1}}^{{n}_{1} {k}_{1}} {W}_{{N}_{2}}^{{n}_{2} {k}_{2}} = {\sum }_{{n}_{2} = 0}^{{N}_{2} - 1} \hat{y} ( {k}_{1} , {n}_{2} ) {W}_{{N}_{2}}^{{n}_{2} {k}_{2}} \qquad [ Equation 19 ]$$

If the two-dimensional DFT form, such as Equation 19, is used, an operation is possible by decomposing the two-dimensional DFT into DFTs of a short length. A computational load can be significantly reduced compared to an equivalent one-dimensional DFT.

### Embodiment 1-7: Optimization for Low Complexity DST-7 Design

According to Equation 10 and Equation 11, with respect to given n2, the present disclosure performs a 3-point DFT of \hat{x}(0, n₂), \hat{x}(1, n₂), \hat{x}(2, n₂) and a 5-point DFT of \hat{x}(0, n₂), \hat{x}(1, n₂), \hat{x}(2, n₂), \hat{x}(3, n₂), \hat{x}(4, n₂).

With respect to {circumflex over (()}k₁, n₂) generated after the internal DFT loop of Equation 10 and Equation 11 is performed, the present disclosure may define a real part and imaginary part of ŷ(k₁, n₂) like Equation 20.

ŷ(k₁,n₁)=ŷ_{R}(k₁,n₂)+j·ŷ_{I}(k¹,n₂ [Equation 20]

In this case, ŷ_{R} indicates a real part, and ŷ_{I} indicates an imaginary part.

Similarly, the input \hat{x}(n₁, n₂) and the output \hat{X}(k₁, k₂) may be decomposed into a real part and an imaginary part, respectively.

\hat{x}(n₁,n₂)=\hat{x}_{R}(n₁,n₂)+j·\hat{x}₁(n₁,n₂)

\hat{X}(n₁,n₂)=\hat{X}_{R}(n₁,n₂)+j·\hat{X}₁(n₁,n₂) [Equation 21]

In this case, the input \hat{x}(n₁, n₂) may be pixels or residual data to which a designed transform is expected to be applied. Accordingly, it may be assumed that all \hat{x}_{I}(n₁, n₂) actually has a 0 value.

Under such an assumption, in the present disclosure, relations between first-transformed data ŷ(k₁, n₂) output by input symmetries imposed to a first step DFT (i.e., a 3-point DFT in the case of a 33-point DFT, and a 5-point DFT in the case of a 65-point DFT may be checked. Such symmetries are provided by the P and Q matrices of Equation 5 or Equation 6, and are described in Equation 22 and Equation 23.

[Equation 22]

x(0,n₂)=0,x(2,n₂)=−x(1,n₂) Case 1)

x(0,n₂)=−x(0,n₂′),x(1,n₂)=−x(2,n₂′),x(2,n₂)=−x(1,n₂′) for some n₂′ Case 2)

[Equation 23]

x(0,n₂)=0,x(3,n₂)=−x(2,n₂),x(4,n₂)=−x(1,n2) Case 1)

x(0,n2)=−x(0,n₂′),x(1,n2)=−x(4,n₂′),x(2,n₂)=−x(3,n₂′),

x(3,n₂)=−x(2,n₂′),x(4,n₂)=−x(1,n₂′) for some n₂′ Case 2)

Furthermore, in ŷ(k₁, n₂), first step output relations are the same as Equation 24 and Equation 25.

ŷ_{R}(2,n₂)=ŷ_{R}(1,n₂)

ŷ_{I}(0,n₂)=0,ŷ_{I}(2,n₂)=−ŷ_{I}(1,n₂) [Equation 24]

ŷ_{R}(3,n₂)=ŷ_{R}(2,n₂)=ŷ_{R}(4,n₂)=ŷ_{R}(1,n₂)

ŷ_{I}(0,n₂)=0,ŷ_{I}(3,n₂)=−ŷ_{I}(2,n₂),ŷ_{I}(4,n₂)=−ŷ_{I}(1,n₂) [Equation 25]

Equation 22 and Equation 24 indicate relations in the 3-point FFT belonging to the 33-point DFT. Equation 23 and Equation 25 indicate relations in the 5-point FFT belonging to the 65-point DFT.

For example, in Equation 22 and Equation 23, Case 1 occurs when n2=0, and Case 2 occurs when n₂=11−n₂′, n₂′=1,2, . . . ,10 (n₂=13−n₂′, n₂′=1,2, . . . , 12). With respect to Case 1 inputs, the real parts of all outputs from the 3-point FFT (5-point FFT) become 0. In the present disclosure, it is necessary to maintain one (two) imaginary part outputs because the remaining one output (two outputs) can be recovered according to Equation 24 and Equation 25.

In Equation 22 and Equation 23, due to the input patterns of Case 2, the present disclosure has a relation between ŷ(k₁, n₂) and ŷ(k₁, n₂′) like Equation 26.

ŷ_{R}(k₁,n₂)=−ŷ_{R}(k₁,n₂′)

ŷ_{I}(k₁,n₂)=−ŷ_{I}(k₁,n₂′) [Equation 26]

In Equation 26, a relation between the indices n₂=11−n₂′, n₂′=1,2, . . . ,10 (n₂=13−n₂′, n₂′=1,2, . . . , 12) of a 11-point FFT (13-point FFT) are identically applied.

Accordingly, the present disclosure performs a 3-point FFT (5-point FFT) only when n2 is within a range of [0, 5] ([0, 6]) due to Equation 26, and thus can reduce an associated computational load.

Furthermore, in each 3-point FFT (5-point FFT) calculation in the range of [1, 5]([1, 6]), other parts of outputs can be recovered according to Equation 18. Only some outputs, that is, two (three) real part outputs and one (two) imaginary part outputs, are calculated.

Due to symmetry present in the first step outputs (Equation 29), outputs calculated from an external loop (the second step FFT) in Equation 10 and Equation 11 are symmetrically arranged. This can reduce a computational load. The input pattern of the external loop (the second step FFT) is the same as Equations 27 to 30.

1) Real part

ŷ_{R}(k₁,0)=0,ŷ_{R}(k₁,6)=−ŷ_{R}(k₁,5),ŷ_{R}(k₁,7)=−ŷ_{R}(k₁,4),

ŷ_{R}(k₁,8)=−ŷ_{R}(k₁,3),ŷ_{R}(k₁,9)=−ŷ_{R}(k₁,2),ŷ_{R}(k₁,10)=−ŷ_{R}(k₁,1) [Equation 27]

1) Real Part

ŷ_{R}(k₁,0)=0,ŷ_{R}(k₁,7)=−ŷ_{R}(k₁,6),ŷ_{R}(k₁,8)=−ŷ_{R}(k₁,5),ŷ_{R}(k₁,9)=−ŷ_{R}(k₁,4),

ŷ_{R}(k₁,10)=−ŷ_{R}(k₁,3),ŷ_{R}(k₁,11)=−ŷ_{R}(k₁,2),ŷ_{R}(k₁,12)=−ŷ_{R}(k₁,1) [Equation 28]

2) Imaginary Part

ŷ_{I}(k₁,6)=ŷ_{I}(k₁,5)=ŷ_{I}(k₁,7)=ŷ_{I}(k₁,4),

ŷ_{I}(k₁,8)=ŷ_{I}(k₁,3),ŷ_{I}(k₁,9)=ŷ_{I}(k₁,2),ŷ_{I}(k₁,10)=−ŷ_{I}(k₁,1) [Equation 29]

2) Imaginary Part

ŷ_{I}(k₁,7)=ŷ_{I}(k₁,6),ŷ_{I}(k₁,8)=ŷ_{I}(k₁,5),ŷ_{I}(k₁,9)=ŷ_{I}(k₁,4),

ŷ_{I}(k₁,10)=ŷ_{I}(k₁,3),ŷ_{I}(k₁,11)=ŷ_{I}(k₁,2),ŷ_{I}(k₁,12)=−ŷ_{I}(k₁,1) [Equation 30]

Equation 27 and Equation 29 indicate input symmetries encountered in an 11-point FF belonging to a 33-point FFT.

Equation 28 and Equation 30 indicate input symmetries encountered in a 13-point FFT belonging to a 65-point FFT. As the external loop is repeated, other symmetry is also encountered among the input sets of the 11-point FFT (13-point FFT). This enables the output of an iteration to be recovered from one of previous iterations.

In the present disclosure, if the vector of ŷ(k₁, n₂) is represented as Ŷ(k₁)=[ŷ(k₁, 0) ŷ(k₁,1) . . . ŷ(k₁, N₂−1)]^{T}=Ŷ_{R}(k₁)+j·Ŷᵢ(k₁), input symmetries present in an iteration process may be represented like Equation 31:

[Equation 31]

Ŷ_{I}(k₁)=0 Case 1:

Ŷ_{R}(k₁)=Ŷ_{R}(k₁′),Ŷ_{I}(k₁)=−Ŷ_{I}(k₁′) Case 2:

In a two-dimensional DFT, such as a 33-point FFT (65-point FFT), k1 has a range of [0, 2] ([0, 4]).

In Equation 31, Case 1 occurs only when k1=0. In Equation 31, Case 2 occurs only when k₁=3−k₁′, k₁′=1,2 (k₁=5−k₁′, k₁′=1,2,3,4).

Since the output of a skipped iteration can be derived from one of previous iterations thereof based on the symmetries of Equation 31, the number of valid iterations of the 11-point FFT (15-point FFT) in the 33-point FFT (65-point FFT) can be reduced from 3(5) to 2(3).

Furthermore, according to Equation 5 and Equation 6, the present disclosure takes only imaginary parts among the outputs from the 33-point FFT (65-point FFT). Accordingly, the output pattern of each case in Equation 31 may be indicated like Equation 32 to 35.

[Equation 32]

\hat{X}_{I}(k₁,0)=0,\hat{X}_{I}(kᵢ,11−k₂)=−\hat{X}_{I}(k₁,k₂),k₂=1,2, . . . ,10 Case 1:

[Equation 33]

\hat{X}_{I}(k₁,0)=0,\hat{X}_{I}(k₁,13−k₂)=−\hat{X}_{I}(k₁,k₂),k₂=1,2, . . . ,12 Case 1:

[Equation 34]

\hat{X}_{I}(k₁,0)=−\hat{X}_{I}(3−k₁,0),\hat{X}_{I}(k₁,k₂)=−\hat{X}_{I}(3−k₁,11−k₂),k₁=1,2,k₂=1,2, . . . ,10 Case 2:

[Equation 35]

\hat{X}_{I}(k₁,0)=\hat{X}_{I}(5−k₁,0),\hat{X}_{I}(k₁,k₂)=−\hat{X}_{I}(5−k₁,13−k₂),k₁=1,2,3,4,k₂=1,2, . . . ,12 Case 2:

Equation 32 and Equation 34 indicate output symmetries in a 11-point FFT belonging to a 33-point FFT. Equation 33 and Equation 35 indicate output symmetries in a 13-point FFT belonging to a 65-point FFT.

Due to symmetries, such as Equation 32 to 35, subsequent iterations of an external loop are unnecessary in a two-dimensional DFT. In Equation 5, k indices that are finally output based on a relation between forward DST-7 and a DFT are k=2m+1. In this case, the range of m is [0, 15] ([0, 31]) with respect to 16×16 DST7 (32×32 DST7).

FIGS. 27 and 28 are embodiments to which the present disclosure is applied, wherein FIG. 27 illustrates a block diagram of 16×16 DST7 to which a 33-point DFT is applied, and FIG. 28 illustrates a block diagram of 32×32 DST7 to which a 65-point DFT is applied.

### Embodiment 1-8: Constructing Replacing Winograd FFT Block with Simplified DFT Block

The embodiment proposes a construction using a common DFT instead of the Winograd FFT.

Equations for a common one-dimensional DFT are given as in Equation 4 and Equation 5 with respect to a 33-point DFT and a 65-point DFT, respectively. Furthermore, equations for a common two-dimensional DFT corresponding to a 33-point one-dimensional DFT and a 65-point one-dimensional DFT are given like Equation 10 and Equation 11.

In FIGS. 27 and 28, a first step DFT is a 3-point DFT or a 5-point DFT. A common DFT equation for the first step DFT is as follows.

$$\hat{y} ( {k}_{1} , {n}_{2} ) = {\hat{y}}_{R} ( {k}_{1} , {n}_{2} ) + j \cdot {\hat{y}}_{I} ( {k}_{1} , {n}_{2} ) = {\sum }_{{n}_{1} = 0}^{{N}_{1} - 1} \hat{x} ( {n}_{1} , {n}_{2} ) {W}_{{N}_{1}}^{{n}_{1} k} \\ {\hat{y}}_{R} ( {k}_{1} , {n}_{2} ) = {\sum }_{{n}_{1} = 0}^{{N}_{1} - 1} \hat{x} ( {n}_{1} , {n}_{2} ) cos ( \frac{2 π {k}_{1} {n}_{1}}{{N}_{1}} ) \\ {\hat{y}}_{I} ( {k}_{1} , {n}_{2} ) = - {\sum }_{{n}_{1} = 0}^{{N}_{1} - 1} \hat{x} ( {n}_{1} , {n}_{2} ) sin ( \frac{2 π {k}_{1} {n}_{1}}{{N}_{1}} ) \qquad [ Equation 36 ]$$

In Equation 36, a 3-point DFT is obtained when N1=3, and a 5-point DFT is obtained when N1=5. A corresponding DFT has only to be calculated with respect to a range in which n2 is 0˜(N2−1)/2 in Equation 31 due to the symmetry proposed in Equation 18. That is, N2=11 when N1=3, and N2=13 when N1=5.

Cases 1 in Equation 25 and Equation 26 correspond to a simplified 3-point DFT Type 1 of FIG. 27 and a simplified 5-point DFT Type 1 of FIG. 28, respectively, and correspond to a case where n2=0.

The simplified 3-point DFT Type 1 is given like Equation 37.

$${\hat{y}}_{R} ( {k}_{1} , 0 ) = 0 , {\hat{y}}_{I} ( {k}_{1} , 0 ) = - 2 \hat{x} ( 1 , 0 ) sin ( \frac{2 π {k}_{1}}{3} ) \qquad [ Equation 37 ]$$

In Equation 37, only one multiplication is necessary because calculation is necessary for a case where k1=1. An equation for a simplified 5-point DFT Type 1 is Equation 38 using the same method.

$${\hat{y}}_{R} ( {k}_{1} , 0 ) = 0 , {\hat{y}}_{I} ( {k}_{1} , 0 ) = - 2 \hat{x} ( 1 , 0 ) sin ( \frac{2 π {k}_{1}}{5} ) - 2 \hat{x} ( 2 , 0 ) sin ( \frac{2 π {k}_{1} \cdot 2}{5} ) \qquad [ Equation 38 ]$$

In Equation 38, only two multiplications are necessary because calculation is necessary for only a case where k1=1, 2. Furthermore, a multiplication 2 output from Equations 37 and 38 is not counted as a multiplication because it can be processed by a left shift operation.

In Equations 22 and 23, Cases 2 correspond to the simplified 3-point DFT Type 2 of FIG. 27 and the simplified 5-point DFT Type 2 of FIG. 28, and correspond to cases where n2=1˜5, n2=1˜6, respectively.

The simplified 3-point DFT Type 2 may be implemented through Equation 36. In this case, if the symmetries of Equation 24 are used, ŷ_{R}(k₁,n₂) has only to be calculated with respect to a case where k1=0, 1, and ŷ_{I} (k₁, n₂) has only to be calculated with respect to a case where k1=1.

Likewise, the simplified 5-point DFT Type 2 may be implemented through Equation 36. Likewise, if the symmetries of Equation 25 are used, ŷ_{R}(k₁, n₂) has only to be calculated with respect to a case where k1=0, 1, 2, and ŷ_{I} (k₁, n₂) has only to be calculated with respect to a case where k1=1, 2.

In FIGS. 27 and 28, the second step DFT is a 11-point DFT or a 13-point DFT. A common DFT equation for the second step DFT is the same as Equation 39.

$$\hat{X} ( {k}_{1} , {k}_{2} ) = {\hat{X}}_{R} ( {k}_{1} , {k}_{2} ) + j \cdot {\hat{X}}_{I} ( {k}_{1} , {k}_{2} ) = {\sum }_{{n}_{2} = 0}^{{N}_{2} - 1} \hat{y} ( {k}_{1} , {n}_{2} ) {W}_{{N}_{2}}^{{n}_{2} {k}_{2}} \\ {\hat{X}}_{I} ( {k}_{1} , {k}_{2} ) = {\sum }_{{n}_{2} = 0}^{{N}_{2} - 1} [ {\hat{y}}_{I} ( {k}_{1} , {n}_{2} ) cos ( \frac{2 π {k}_{2} {n}_{2}}{{N}_{2}} ) - {\hat{y}}_{R} ( {k}_{1} , {n}_{2} ) sin ( \frac{2 π {k}_{2} {n}_{2}}{{N}_{2}} ) ] \qquad [ Equation 39 ]$$

In Equation 39, a 11-point DFT is obtained when N2=11, and a 13-point DFT is obtained when N2=13. Due to the symmetry proposed in Equations 33 to 35, a corresponding DFT has only to be calculated with respect to a range where k1 is 0 (N1−1)/2 in Equation 39. N1=3 when N2=11, and N1=5 when N2=13.

Case 1 of Equation 31 and Equation 32 correspond to the simplified 11-point DFT Type 1 of FIG. 27. Furthermore, Case 1 of Equation 31 and Equation 33 correspond to the simplified 13-point DFT Type 1 of FIG. 28.

If the symmetry proposed in Equations 27 to 30 is used, the simplified 11-point DFT Type 1 and the simplified 13-point DFT Type 1 are calculated like Equation 40. That is, this corresponds to a case where k1=0.

$${\hat{X}}_{I} ( 0 , {k}_{2} ) = {\sum }_{{n}_{2} = 1}^{\frac{{N}_{2} - 1}{2}} [ - 2 {\hat{y}}_{R} ( 0 , {n}_{2} ) ] sin ( \frac{2 π {k}_{2} {n}_{2}}{{N}_{2}} ) = - 2 {\sum }_{{n}_{2} = 1}^{\frac{{N}_{2} - 1}{2}} {\hat{y}}_{R} ( 0 , {n}_{2} ) sin ( \frac{2 π {k}_{2} {n}_{2}}{{N}_{2}} ) \qquad [ Equation 40 ]$$

According to Equation 40, the simplified 11-point DFT Type 1 requires five multiplications, and the simplified 13-point DFT Type 1 requires six multiplications.

Likewise, if the symmetry proposed in Equations 27 to 30 is used, a simplified 11-point DFT Type 2 and a simplified 13-point DFT Type 2 can be obtained like Equation 41. In this case, the simplified 11-point DFT Type 2 is performed when k1=1, and the simplified 13-point DFT Type 2 is performed when k1=1, 2.

$${\hat{X}}_{I} ( {k}_{1} , {k}_{2} ) = 2 [ {\sum }_{{n}_{2} = 1}^{\frac{{N}_{2} - 1}{2}} {\hat{y}}_{I} ( {k}_{1} , {n}_{2} ) cos ( \frac{2 π {k}_{2} {n}_{2}}{{N}_{2}} ) ] + {\hat{y}}_{I} ( {k}_{1} , 0 ) - 2 [ {\sum }_{{n}_{2} = 1}^{\frac{{N}_{2} - 1}{2}} {\hat{y}}_{R} ( {k}_{1} , {n}_{2} ) sin ( \frac{2 π {k}_{2} {n}_{2}}{{N}_{2}} ) ] \qquad [ Equation 41 ]$$

According to Equation 41, the simplified 11-point DFT Type 2 requires ten multiplications, and the simplified 13-point DFT Type 2 requires twelve multiplications.

In the multiplications appearing in Equations 37 to 41, cosine values and sine values are multiplied as DFT kernel coefficients. Since possible N1 and N2 values are 3, 5, 11, and 13, coefficient values such as Equation 42 appear in corresponding multiplications. This is excluded because a corresponding cosine or sine value is 0 or 1 in the case where i=0.

$$\begin{matrix}cos ( \frac{2 π i}{3} ) , sin ( \frac{2 π i}{3} ) , & i = 1 , 2 \\ cos ( \frac{2 π i}{5} ) , sin ( \frac{2 π i}{5} ) , & i = 1 , 2 , 3 , 4 \\ cos ( \frac{2 π i}{11} ) , sin ( \frac{2 π i}{11} ) , & i = 1 , 2 , 3 , 4 , 5 \\ cos ( \frac{2 π i}{13} ) , sin ( \frac{2 π i}{13} ) , & i = 1 , 2 , 3 , 4 , 5 , 6\end{matrix} \qquad [ Equation 42 ]$$

In Equations 40 and 41, since an n2 index is increased up to (N2−1)/2, an i value is limited up to (N2−1)/2 in the last two cases in Equation 42.

All the number of coefficients appearing in Equation 42 become 2×(2+4+5+6)=34. 2×(2+5)=14 coefficients are necessary for a 33-point DFT, and 2×(4+6)=20 coefficients are necessary for a 65-point DFT. Each of the coefficients may be approximated in an integer form through scaling and rounding. Input data of DST-7 is residual data in an integer form. Accordingly, all of associated calculations may be performed as an integer operation. Of course, since intermediate result values are also scaled values, it is necessary to properly apply down scaling in each calculation step or output step.

Furthermore, forms in which reference is made to a cosine value and a sine value include

$$cos ( \frac{2 π {k}_{1} {n}_{1}}{{N}_{1}} ) , sin ( \frac{2 π {k}_{1} {n}_{1}}{{N}_{1}} ) , cos ( \frac{2 π {k}_{2} {n}_{2}}{{N}_{2}} ) , sin ( \frac{2 π {k}_{2} {n}_{2}}{{N}_{2}} ) .$$

Accordingly, a reference order of coefficient values may be difference based on k1 and k2 values.

Accordingly, a sequence table having the k1 and k2 values as addresses may be generated, and a reference sequence according to n1 and n2 may be obtained in a table loop-up form. For example, if N2=11, k2=3,

$${[ {〈 {k}_{2} {n}_{2} 〉}_{{N}_{2}} ]}_{{n}_{2} = 1 , 2 , … , 5} = [ 3 , 6 , 9 , 1 , 4 ]$$

may become a corresponding table entry. A corresponding table entry may be configured with respect to all possible k2 values.

FIGS. 27 and 28, squares having a long form indicated as 16 and 32 perform permutation and a sign transform on data. Through the symmetry of the index transform proposed in Equations 12 and 13 and the input data proposed in Equations 22 and 23, the simplified 3-point DFT Type 1, the simplified 3-point DFT Type 2, the simplified 5-point DFT Type 1, and the simplified 5-point DFT Type 2 blocks in FIG. 27 and FIG. 28 may receive corresponding data. Due to the symmetry of Equations 22 and 23, some data is input after a sign is transformed.

### Embodiment 1-9: DST-7 Implementation Through Several Scaling Methods

The simplified 3-point DFT Type 2 of FIG. 27 and the simplified 5-point DFT Type 2 of FIG. 28 are calculated through Equation 36. More specifically, in Equation 36, this corresponds to a case where n2≠0. In

$$cos ( \frac{2 π {k}_{1} {n}_{1}}{{N}_{1}} ) and sin ( \frac{2 π {k}_{1} {n}_{1}}{{N}_{1}} ) ,$$

many cases where an absolute value is the same occur according to a change in the n1 value. Accordingly, as in Equation 36, although the n1 value is increased from 0 to N1−1, multiplications corresponding to N1 times are not necessary. In Equation 36, when n200 (i.e., the simplified 3-point DFT Type 2 of FIG. 27 and the simplified 5-point DFT Type 2 of FIG. 28), it is assumed that an A/B value is scaled like Equation 43.

$$\frac{A}{B} {\hat{y}}_{R} ( {k}_{1} , {n}_{2} ) = \frac{A}{B} {\sum }_{{n}_{1} = 0}^{{N}_{1} - 1} \hat{x} ( {n}_{1} , {n}_{2} ) cos ( \frac{2 π {k}_{1} {n}_{1}}{{N}_{1}} ) = \frac{1}{B} {\sum }_{{n}_{1} = 0}^{{N}_{1} - 1} \hat{x} ( {n}_{1} , {n}_{2} ) [ A cos ( \frac{2 π {k}_{1} {n}_{1}}{{N}_{1}} ) ] \\ \frac{A}{B} {\hat{y}}_{I} ( {k}_{1} , {n}_{2} ) = - \frac{A}{B} {\sum }_{{n}_{1} = 0}^{{N}_{1} - 1} \hat{x} ( {n}_{1} , {n}_{2} ) sin ( \frac{2 π {k}_{1} {n}_{1}}{{N}_{1}} ) = \frac{1}{B} [ - {\sum }_{{n}_{1} = 0}^{{N}_{1} - 1} \hat{x} ( {n}_{1} , {n}_{2} ) [ A sin ( \frac{2 π {k}_{1} {n}_{1}}{{N}_{1}} ) ] ] \qquad [ Equation 43 ]$$

As in Equation 43, a

$$cos ( \frac{2 π {k}_{1} {n}_{1}}{{N}_{1}} )$$

value or

$$sin ( \frac{2 π {k}_{1} {n}_{1}}{{N}_{1}} )$$

value is a floating-point number whose absolute value is equal to or smaller than 1. If an A value is properly multiplied, an integer value or a floating-point number having sufficient accuracy can be obtained. In Equation 43, 1/B that is finally multiplied may be calculated as only a shift operation based on a value, and more detailed contents thereof are described in embodiment 1-10.

In Equations 37 and 38, if A/2B is multiplied instead of A/B, Equations 44 and 45 are obtained.

$$\begin{matrix}\frac{A}{2 B} {\hat{y}}_{R} ( {k}_{1} , 0 ) = 0 , \frac{A}{2 B} {\hat{y}}_{I} ( {k}_{1} , 0 ) = \frac{1}{B} [ - \hat{x} ( 1 , 0 ) [ A sin ( \frac{2 π {k}_{1}}{3} ) ] ] & [ Equation 44 ] \\ \frac{A}{2 B} {\hat{y}}_{R} ( {k}_{1} , 0 ) = 0 , \frac{A}{2 B} {\hat{y}}_{1} ( {k}_{1} , 0 ) = \frac{1}{B} [ - \hat{x} ( 1 , 0 ) [ Asin ( \frac{2 π {k}_{1}}{5} ) ] - \hat{x} ( 2 , 0 ) [ Asin ( \frac{2 π {k}_{1}}{5} ) ] ] & [ Equation 45 ]\end{matrix}$$

Even in Equations 44 and 45, an integer value or a floating-point number having sufficient accuracy can be obtained by multiplying

$$cos ( \frac{2 π {k}_{1} {n}_{1}}{{N}_{1}} ) or sin ( \frac{2 π {k}_{1} {n}_{1}}{{N}_{1}} )$$

by an A value. 1/B that is finally multiplied can be calculated using only a shift operation based on a B value, and more detailed contents thereof are described in embodiment 1-10.

The simplified 11-point DFT Type 1 and the simplified 13-point DFT Type 1 perform the operation (corresponding to a case where k1=0) described in Equation 40. Equation 46 may be obtained by multiplying a C/2D value as a scaling value.

$$\frac{C}{2 D} {\hat{X}}_{I} ( 0 , {k}_{2} ) = \frac{1}{D} {\sum }_{{n}_{2} = 1}^{\frac{{N}_{2} - 1}{2}} [ - {\hat{y}}_{R} ( 0 , {n}_{2} ) ] [ C sin ( \frac{2 π {k}_{2} {n}_{2}}{{N}_{2}} ) ] \\ \frac{A}{B} \frac{C}{2 D} {\hat{X}}_{I} ( 0 , {k}_{2} ) = \frac{1}{D} {\sum }_{{n}_{2} = 1}^{\frac{{N}_{2} - 1}{2}} [ - \frac{A}{B} {\hat{y}}_{R} ( 0 , {n}_{2} ) ] [ C sin ( \frac{2 π {k}_{2} {n}_{2}}{{N}_{2}} ) ] \qquad [ Equation 46 ]$$

As in Equation 46, an integer or a fixed point operation may be applied because

$$sin ( \frac{2 π {k}_{2} {n}_{2}}{{N}_{2}} )$$

can be multiplied by a C value. If A/B, that is, the scaling value multiplied in Equation 43 is considered, as in Equation 43, a total scaling value multiplied into \hat{X}_{I}(0, k₂), that is, one of the final result data, becomes

$$\frac{A}{B} \frac{C}{2 D} .$$

Furthermore, the

$$\frac{A}{B} {\hat{y}}_{R}$$

(0,n₂) value calculated from Equation 43 may be directly applied as input as in Equation 46.

The simplified 11-point DFT Type 2 and the simplified 13-point DFT Type 2 is calculated through Equation 41 (the simplified 11-point DFT Type 2 is performed when k1=1, and the simplified 13-point DFT Type 2 is performed when k1=1, 2). As in Equation 46, Equation 47 is obtained by multiplying C/2D as a scaling value.

$$\frac{C}{2 D} {\hat{X}}_{I} ( {k}_{1} , {k}_{2} ) = [ \frac{1}{D} {\sum }_{{n}_{2} = 1}^{\frac{{N}_{2} - 1}{2}} {\hat{y}}_{I} ( {k}_{1} , {k}_{2} ) [ C cos ( \frac{2 π {k}_{2} {n}_{2}}{{N}_{2}} ) ] ] + \frac{C}{2 D} {\hat{y}}_{I} ( {k}_{1} , 0 ) + [ \frac{1}{D} {\sum }_{{n}_{2} = 1}^{\frac{{N}_{2} - 1}{2}} [ - {\hat{y}}_{R} ( {k}_{1} , {n}_{2} ) ] [ C sin ( \frac{2 π {k}_{2} {n}_{2}}{{N}_{2}} ) ] ] \\ \frac{A}{B} \frac{C}{2 D} {\hat{X}}_{I} ( {k}_{1} , {k}_{2} ) = [ \frac{1}{D} {\sum }_{{n}_{2} = 0}^{\frac{{N}_{2} - 1}{2}} {\hat{y}}_{I} ( {k}_{1} , {n}_{2} ) [ C cos ( \frac{2 π {k}_{2} {n}_{2}}{{N}_{2}} ) ] ] + [ \frac{1}{D} {\sum }_{{n}_{2} = 1}^{\frac{{N}_{2} - 1}{2}} [ - \frac{A}{B} {\hat{y}}_{R} ( {k}_{1} , {n}_{2} ) ] [ C sin ( \frac{2 π {k}_{2} {n}_{2}}{{N}_{2}} ) ] ] \\ where {\tilde{y}}_{I} ( {k}_{1} , {n}_{2} ) = \{ \begin{matrix}\frac{A}{2 B} {\hat{y}}_{I} ( {k}_{1} , 0 ) , & if {n}_{2} = 0 \\ \frac{A}{B} {\hat{y}}_{I} ( {k}_{1} , {n}_{2} ) , & otherwise\end{matrix} \qquad [ Equation 47 ]$$

Even in Equation 47, as in Equation 46, it may be seen that

$$sin ( \frac{2 π {k}_{2} {n}_{2}}{{N}_{2}} ) and cos ( \frac{2 π {k}_{2} {n}_{2}}{{N}_{2}} )$$

is multiplied by a C value. Accordingly, an integer or a floating point operation may be used to multiply a cosine value and a sine value. As in Equation 46, if both the A/B value multiplied in Equation 43 and A/2B multiplied in Equation 44 and Equation 45 are considered, the second equation in Equation 47 is obtained. If \tilde{y}_{I}(k₁, n₂) is defined as in Equation 47, a value obtained through Equations 43 to 45 may be used as input data for Equation 47.

A k2 value possible in Equation 47 is 0 to 10 in the case of the simplified 11-point DFTType 2 and is 0 to 12 in the case of the simplified 13-point DFTType 2. Due to symmetry fundamentally present in a cosine value and a sine value, a relation equation, such as Equation 48, is established.

$$f ( {k}_{1} , {k}_{2} ) = \frac{1}{D} {\sum }_{{n}_{2} = 0}^{\frac{{N}_{2} - 1}{2}} {\tilde{y}}_{I} ( {k}_{1} , {n}_{2} ) [ C cos ( \frac{2 π {k}_{2} {n}_{2}}{{N}_{2}} ) ] \\ g ( {k}_{1} , {k}_{2} ) = \frac{1}{D} {\sum }_{{n}_{2} = 1}^{\frac{{N}_{2} - 1}{2}} [ - \frac{A}{B} {\hat{y}}_{R} ( {k}_{1} , {n}_{2} ) ] [ C sin ( \frac{2 π {k}_{2} {n}_{2}}{{N}_{2}} ) ] \\ \frac{A}{B} \frac{C}{2 D} {\hat{X}}_{I} ( {k}_{1} , {k}_{2} ) = f ( {k}_{1} , {k}_{2} ) + g ( {k}_{1} , {k}_{2} ) = g ( {k}_{1} , {k}_{2} ) \\ h ( {k}_{1} , {k}_{2} ) = \{ \begin{matrix}f ( {k}_{1} , {k}_{2} ) , & {k}_{2} = 0 \\ f ( {k}_{1} , {k}_{2} ) + g ( {k}_{1} , {k}_{2} ) , & 1 \leq {k}_{2} \leq \frac{{N}_{2} - 1}{2} \\ f ( {k}_{1} , {N}_{2} - {k}_{2} ) - g ( {k}_{1} , {N}_{2} - {k}_{2} ) , & \frac{{N}_{2} + l}{2} \leq {k}_{2} \leq {N}_{2} - 1\end{matrix} \qquad [ Equation 48 ]$$

In Equation 48, an N2 value for the simplified 11-point DFT Type 2 is 11, and an N2 value for the simplified 13-point DFT Type 2 is 13. The definition of all the identifiers appearing in Equation 48 is the same as that in Equation 47.

Accordingly, as in Equation 48, with respect to f(k₁, k₂), only the range of 0≤

$${k}_{2} \leq \frac{{N}_{2} - 1}{2}$$

has only to be calculated. With respect to g(k₁, k₂), only the range of 1≤

$${k}_{2} \leq \frac{{N}_{2} - 1}{2}$$

has only to be calculated. According to the same principle, even in Equation 46, only the range of

$$1 \leq {k}_{2} \leq \frac{{N}_{2} - 1}{2}$$

has only to be calculated due to symmetry for k2.

### Embodiment 1-10: Implement DST7 Using Only an Integer or the Floating Point Operation by Adjusting a Scaling Value

All the scaling values appearing in the embodiment 1-9 have an A/B form.

$$cos ( \frac{2 π kn}{N} ) or sin ( \frac{2 π kn}{N} )$$

is first multiplied by A to enable an integer operation, and 1/B is later multiplied. Furthermore, as in Equation 42, the number of cosine values and sine values appearing in all the equations is limited. Corresponding cosine values and sine values are previously multiplied by an A value and stored in an array or a ROM, and may be used in a table loop-up method. Equation 43 may be represented like Equation 49.

$$\frac{A}{B} {\hat{y}}_{R} ( {k}_{1} , {n}_{2} ) = \frac{1}{B} {\sum }_{{n}_{1} = 0}^{{N}_{1} - 1} \hat{x} ( {n}_{1} , {n}_{2} ) [ A cos ( \frac{2 π {k}_{1} {n}_{1}}{{N}_{1}} ) ] \\ \frac{A}{B} {\hat{y}}_{I} ( {k}_{1} , {n}_{2} ) = \frac{1}{B} [ - {\sum }_{{n}_{1} = 0}^{{N}_{1} - 1} \hat{x} ( {n}_{1} , {n}_{2} ) [ Asin ( \frac{2 π {k}_{1} n}{{N}_{1}} ) ] \qquad [ Equation 49 ]$$

In this case, a cosine value or a sine value can be modified into a scaled integer value and accuracy of the value can also be sufficiently maintained by multiplying

$$acos ( \frac{2 π kn}{N} )$$

### or A

$$sin ( \frac{2 π kn}{N} )$$

by a sufficiently great A value and rounding off the results. In general, a value of an exponentiation form of 2 (2ⁿ) may be used as the A value. For example, A

$$cos ( \frac{2 π kn}{N} ) or Asin ( \frac{2 π kn}{N} )$$

may be approximated using a method, such as Equation 50.

$${2}^{n} cos ( \frac{2 π kn}{N} ) \approx round ( {2}^{n} cos ( \frac{2 π kn}{N} ) ) \qquad [ Equation 50 ]$$

In Equation 50, round indicates a rounding operator. Any rounding of any method for making an integer is possible, but a common rounding method for rounding off based on 0.5 may be used.

In Equation 49, to multiply 1/B (i.e., by division using B) may be implemented as a right shift operation if B is an exponentiation form of 2. Assuming that B=2m, as in Equation 51, a multiplication for 1/B may be approximated. In this case, as in Equation 51, rounding may be considered, but the present disclosure is not limited thereto.

$$\frac{x}{{2}^{m}} \approx \\ \{ \begin{matrix}x ⪢ m , & when rounding is not considered \\ ( x + ( 1 ⪡ ( m - 1 ) ) ⪢ m , & when rounding is considered\end{matrix} \qquad [ Equation 51 ]$$

Meanwhile, as in Equation 50, the multiplied A value does not need to be essentially an exponentiation form of 2. In particular, if a scaling factor of a 1/\sqrt{N} form has to be additionally multiplied, the scaling factor may be incorporated into the A value.

For example, in Equations 46 to 48, a value multiplied as a numerator is A and C.

$$\frac{1}{\sqrt{N}}$$

may be multiplied in one of A or C. If

$$\frac{1}{\sqrt{N}} = αβ ,$$

α may be multiplied on the A side, and β may be multiplied on the C side. A may be additionally multiplied by a value, such as

$${2}^{\frac{1}{2}} ,$$

for another example, not an exponentiation form. In a codec system to which the present disclosure is applied, in order to identically maintain the range of a kernel coefficient value for transforms having all sizes,

$${2}^{\frac{1}{2}}$$

is additionally multiplied.

In a similar manner, Equations 37, 38, 40, and 41 may be properly approximated using only the simple operations of Equation 52 to 55, respectively.

$$\begin{matrix} \frac{A}{2 B} {\hat{y}}_{R} ( {k}_{1} , 0 ) = 0 , \\ \frac{A}{2 B} {\hat{y}}_{I} ( {k}_{1} , 0 ) = \frac{1}{B} [ - \hat{x} ( 1 , 0 ) [ A sin ( \frac{2 π {k}_{1}}{3} ) ] ] & [ Equation 52 ] \\ \frac{A}{2 B} {\hat{y}}_{R} ( {k}_{1} , 0 ) = 0 , \\ \frac{A}{2 B} {\hat{y}}_{I} ( {k}_{1} , 0 ) = \frac{1}{B} [ - \hat{x} ( 1 , 0 ) [ A sin ( \frac{2 π {k}_{1}}{5} ) ] - \hat{x} ( 2 , 0 ) [ A sin ( \frac{2 π {k}_{1}}{5} ) ] ] & [ Equation 53 ] \\ \frac{A}{B} \frac{C}{2 D} {\hat{X}}_{I} ( 0 , {k}_{2} ) = \frac{1}{D} {\sum }_{{n}_{2} = 1}^{\frac{{N}_{2} - 1}{2}} [ - \frac{A}{B} {\hat{y}}_{R} ( 0 , {n}_{2} ) ] [ C sin ( \frac{2 π {k}_{2} {n}_{2}}{{N}_{2}} ) ] & [ Equation 54 ] \\ f ( {k}_{1} , {k}_{2} ) = \frac{1}{D} {\sum }_{{n}_{2} = 0}^{\frac{{N}_{2} - 1}{2}} {\tilde{y}}_{I} ( {k}_{1} , {n}_{2} ) [ C cos ( \frac{2 π {k}_{2} {n}_{2}}{{N}_{2}} ) ] , \\ g ( {k}_{1} , {k}_{2} ) = \frac{1}{D} {\sum }_{{n}_{2} = 1}^{\frac{{N}_{2} - 1}{2}} [ - \frac{A}{B} {\hat{y}}_{R} ( {k}_{1} , {n}_{2} ) ] [ C sin ( \frac{2 π {k}_{\underline{2}} {n}_{2}}{{N}_{2}} ) ] \\ \frac{A}{B} \frac{C}{2 D} {\hat{X}}_{I} ( {k}_{1} , {k}_{2} ) = \{ \begin{matrix}f ( {k}_{1} , {k}_{2} ) , & {k}_{2} = 0 \\ f ( {k}_{1} , {k}_{2} ) + g ( {k}_{1} , {k}_{2} ) , & 1 \leq {k}_{2} \leq \frac{{N}_{2} - 1}{2} \\ f ( {k}_{1} , {N}_{2} - {k}_{2} ) - g ( {k}_{1} , {N}_{2} - {k}_{2} ) , & \frac{{N}_{2} + 1}{2} \leq {k}_{2} \leq {N}_{2} - 1\end{matrix} , \\ where \\ {\tilde{y}}_{I} ( {k}_{1} , {n}_{2} ) = \{ \begin{matrix}\frac{A}{2 B} {\hat{y}}_{I} ( {k}_{1} , 0 ) , & if {n}_{2} = 0 \\ \frac{A}{B} {\hat{y}}_{I} ( {k}_{1} , {n}_{2} ) , & otherwise\end{matrix} & [ Equation 55 ]\end{matrix}$$

In this case, f(k₁, k₂) and g(k₁, k₂) may be calculated only in a partial range

$$( [ 0 , \frac{{N}_{2} - 1}{2} ] , [ 1 , \frac{{N}_{2} - 1}{2} ] ,$$

respectively) due to symmetry. Accordingly, complexity can be substantially reduced.

Furthermore, an approximation method for the multiplication of A and an approximation method for the multiplication of 1/B may also be applied to Equations 44 to 48.

In DST-7 of the length 8, 16, or 32, an example of approximation implementation for a scaling vector multiplication is illustrated in Table 24. A, B, C, and D appearing in Table 24 are the same as A, B, C, and D appearing in Equations 43 to 48. A shift is a value introduced into the DST-7 function as a factor, and may be a value determined according to a method of executing quantization (or dequantization) performed after a transform (or prior to an inverse transform).

TABLE 24

| Config. | | Original | Approximation |
|---|---|---|---|
| 8 × 8 DST7 | 17-pt DFT | $A sin ( \frac{2 π k}{17} ) , k = 1 , 2 , … , 8$ | $round \{ \frac{1}{\sqrt{17}} \cdot {2}^{\frac{1}{2}} \cdot sin ( \frac{2 π k}{17} ) \cdot {2}^{10} \} , k = 1 , 2 , … , 8$ |
| | | 1/B = 2^{-shift} | (x + (1 < < (shift − 1)) > > shift |
| 16 × 16 DST7 | 3-pt DFT | $A sin ( \frac{2 π k}{3} ) , k = 1$ | $round \{ sin ( \frac{2 π k}{3} ) \cdot {2}^{9} \} , k = 1$ |
| | | 1/B = 2⁻¹⁰ | (x + (1 < < 9) > > 10 |
| | 11-pt DFT | $C sin ( \frac{2 π k}{11} ) , k = 1 , 2 , … , 5$ | $round \{ \frac{1}{\sqrt{33}} \cdot sin ( \frac{2 π k}{11} ) \cdot {2}^{11} \} , k = 1 , 2 , … , 5$ |
| | | $C cos ( \frac{2 π k}{11} ) , k = 0 , 1 , … , 5$ | $round \{ \frac{1}{\sqrt{33}} \cdot cos ( \frac{2 π k}{11} ) \cdot {2}^{11} \} , k = 0 , 1 , … , 5$ |
| | | 1/D = 2^{-(shift-1)} | (x + (1 < < (shift − 2)) > > (shift − 1) |
| 32 × 32 DST7 | 5-pt DFT | $A sin ( \frac{2 π k}{5} ) , k = 1 , 2$ | $round \{ sin ( \frac{2 π k}{5} ) \cdot {2}^{9} \} , k = 1 , 2$ |
| | | $A cos ( \frac{2 π k}{5} ) , k = 1 , 2$ | $round \{ cos ( \frac{2 π k}{5} ) \cdot {2}^{9} \} , k = 1 , 2$ |
| | | 1/B = 2⁻¹⁰ | (x + (1 < < 9) > > 10 |
| | 13-pt DFT | $C sin ( \frac{2 π k}{13} ) , k = 1 , 2 , … , 6$ | $round \{ \frac{1}{\sqrt{65}} \cdot {2}^{\frac{1}{2}} \cdot sin ( \frac{2 π k}{13} ) \cdot {2}^{11} \} , k = 1 , 2 , … , 6$ |
| | | $C cos ( \frac{2 π k}{13} ) , k = 0 , 1 , … , 6$ | $round \{ \frac{1}{\sqrt{65}} \cdot {2}^{\frac{1}{2}} \cdot cos ( \frac{2 π k}{13} ) \cdot {2}^{11} \} , k = 0 , 1 , … , 6$ |
| | | 1/D = 2^{-(shift-1)} | (x + (1 < < (shift − 2)) > > (shift − 1) |

Table 25 is an example in which a scaling value different from that of Table 24 is applied. That is, a scaling value obtained by multiplying the scaling of Table 24 by 1/4 is used.

TABLE 25

| Config. | | Original | Approximation |
|---|---|---|---|
| 8 × 8 DST7 | 17-pt DFT | $A sin ( \frac{2 π k}{17} ) , k = 1 , 2 , … , 8$ | $round \{ \frac{1}{\sqrt{17}} \cdot {2}^{\frac{1}{2}} \cdot sin ( \frac{2 π k}{17} ) \cdot {2}^{8} \} , k = 1 , 2 , … , 8$ |
| | | 1/B = 2^{-shift} | (x + (1 < < (shift − 1)) > > shift |
| 16 × 16 DST7 | 3-pt DFT | $A sin ( \frac{2 π k}{3} ) , k = 1$ | $round \{ sin ( \frac{2 π k}{3} ) \cdot {2}^{7} \} , k = 1$ |
| | | 1/B = 2⁻¹⁰ | (x + (1 < < 7)) > > 8 |
| | 11-pt DFT | $C sin ( \frac{2 π k}{11} ) , k = 1 , 2 , … , 5$ | $round \{ \frac{1}{\sqrt{33}} \cdot sin ( \frac{2 π k}{11} ) \cdot {2}^{9} \} , k = 1 , 2 , … , 5$ |
| | | $C cos ( \frac{2 π k}{11} ) , k = 0 , 1 , … , 5$ | $round \{ \frac{1}{\sqrt{33}} \cdot cos ( \frac{2 π k}{11} ) \cdot {2}^{9} \} , k = 0 , 1 , … , 5$ |
| | | 1/D = 2^{-(shift-1)} | (x + (1 < < (shift − 2)) > > (shift − 1) |
| 32 × 32 DST7 | 5-pt DFT | $A sin ( \frac{2 π k}{5} ) , k = 1 , 2$ | $round \{ sin ( \frac{2 π k}{5} ) \cdot {2}^{7} \} , k = 1 , 2$ |
| | | $A cos ( \frac{2 πk}{5} ) , k = 1 , 2$ | $round \{ cos ( \frac{2 π k}{5} ) \cdot {2}^{7} \} , k = 1 , 2$ |
| | | 1/B = 2⁻¹⁰ | (x + (1 < < 7)) > > 8 |
| | 13-pt DFT | $C sin ( \frac{2 π k}{13} ) , k = 1 , 2 , … , 6$ | $round \{ \frac{1}{\sqrt{65}} \cdot {2}^{\frac{1}{2}} \cdot sin ( \frac{2 π k}{13} ) \cdot {2}^{9} \} , k = 1 , 2 , … , 6$ |
| | | $C cos ( \frac{2 π k}{13} ) , k = 0 , 1 , … , 6$ | $round \{ \frac{1}{\sqrt{65}} \cdot {2}^{\frac{1}{2}} \cdot cos ( \frac{2 π k}{13} ) \cdot {2}^{9} \} , k = 0 , 1 , … , 6$ |
| | | 1/D = 2^{-(shift-1)} | (x + (1 < < (shift − 2)) > > (shift − 1) |

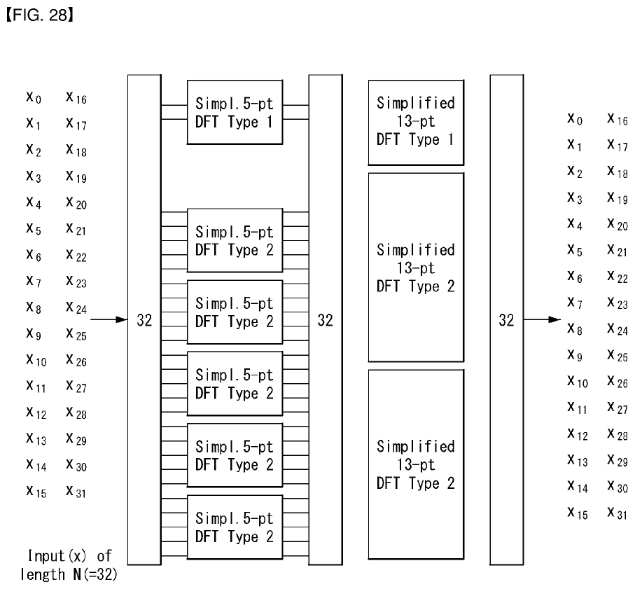

FIG. 29 is an embodiment to which the present disclosure is applied, and illustrates an encoding flowchart in which forward DST-7 and forward DGT-8 are performed as DFTs.

The encoder may determine (or select) a horizontal transform and/or a vertical transform based on at least one of a prediction mode, a block shape and/or a block size of a current block (S2910). In this case, a candidate for the horizontal transform and/or the vertical transform may include at least one of the embodiments of FIG. 6.

The encoder 100 may determine an optimal horizontal transform and/or an optimal vertical transform through rate distortion (RD) optimization. The optimal horizontal transform and/or the optimal vertical transform may correspond to one of a plurality of transform combinations. The plurality of transform combinations may be defined by a transform index.

The encoder 100 may encode a transform index corresponding to the optimal horizontal transform and/or the optimal vertical transform (S2920). In this case, other embodiments described in the present disclosure may be applied to the transform index. For example, other embodiments may include at least one of the embodiments of FIGS. 6a, 6b, 44a to 45b.

For another example, a horizontal transform index for the optimal horizontal transform and a vertical transform index for the optimal vertical transform may be independently signaled.

The encoder 100 may perform a forward transform on the current block in the horizontal direction using the optimal horizontal transform (S2930). In this case, the current block may mean a transform block, and the optimal horizontal transform may be forward DCT-4 or DCT-8.

Furthermore, the encoder 100 may perform a forward transform on the current block in the vertical direction using the optimal vertical transform (S2940). In this case, the optimal vertical transform may be forward DST-4 or DST-7, and forward DST-7 may be designed as a DFT.

In the embodiment, after a horizontal transform is performed, a vertical transform is performed, but the present disclosure is not limited thereto. That is, after a vertical transform is performed, a horizontal transform may be performed.

In an embodiment, a combination of a horizontal transform and a vertical transform may include at least one of the embodiments of FIG. 6a, 6b, or 44a to 45b.

Meanwhile, the encoder 100 may generate a transform coefficient block by performing quantization on the current block (S2950).

The encoder 100 may generate a bit stream by performing entropy encoding on the transform coefficient block.

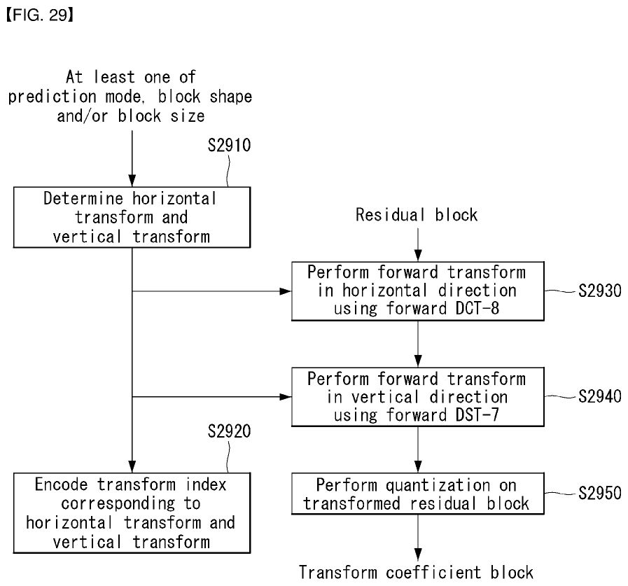

FIG. 30 is an embodiment to which the present disclosure is applied, and illustrates a decoding flowchart in which inverse DST-7 and inverse DCT-8 are performed as DFTs.

The decoder 200 may obtain a transform index from a bit stream (S3010). In this case, other embodiments described in the present disclosure may be applied to the transform index. For example, other embodiments may include at least one of the embodiments of FIG. 6a, 6b, or 44a to 45b.

The decoder 200 may derive a horizontal transform and a vertical transform corresponding to the transform index (S3020). In this case, a candidate for the horizontal transform and/or the vertical transform may include at least one of the embodiments of FIG. 6a, 6b, or 44a to 45b.

In this case, steps S3010 and S3020 are embodiments, and the present disclosure is not limited thereto. For example, the decoder 200 may derive the horizontal transform and the vertical transform based on at least one of a prediction mode, a block shape and/or a block size of a current block. For another example, the transform index may include a horizontal transform index corresponding to the horizontal transform and a vertical transform index corresponding to the vertical transform.

Meanwhile, the decoder 200 may obtain a transform coefficient block by entropy-decoding the bit stream, and may perform dequantization on the transform coefficient block (S3030).

The decoder 200 may perform an inverse transform on the inverse quantized transform coefficient block in a vertical direction using the vertical transform (S3040). In this case, the vertical transform may correspond to DST-7. That is, the decoder 200 may apply inverse DST-7 to the inverse quantized transform coefficient block.

Embodiments of the present disclosure provide a method of designing forward DST-7 and/or inverse DST-7 as a discrete Fourier transform (DFT).

The decoder 200 may implement DST-7 through a one-dimensional DFT or a two-dimensional DFT.

Furthermore, the decoder 200 may implement DST-7 using only an integer operation by applying various scaling methods.

Furthermore, the decoder 200 may design DST-7 of a length 8, 16, 32 through a method of implementing DST-7 using a DFT and a method of implementing DST-7 using only an integer operation.

In an embodiment, the decoder 200 may derive a transform combination corresponding to a transform index, and may perform an inverse transform on the current block in the vertical or horizontal direction using DST-7 or DCT-8. In this case, the transform combination is composed of a horizontal transform and a vertical transform. The horizontal transform and the vertical transform may correspond to any one of DST-7 or DCT-8.

In an embodiment, when a 33-point DFT is applied to DST-7, a method may include the steps of one row or one column of DST-7 into two partial vector signals, and the step of applying 11-point DFT type 1 or 11-point DFT type 2 to the two partial vector signals.

In an embodiment, when one row or one column of DST-7 is represented as src[0 . . . 15], the two partial vector signals may be divided into src[0 . . . 4] and src[5 . . . 15].

In an embodiment, when a 65-point discrete Fourier transform (DFT) is applied to DST-7, a method may include the step of one row or one column of DST-7 into three partial vector signals and the step of applying 13-point DFT type 1 or 13-point DFT type 2 to the three partial vector signals.

In an embodiment, when one row or one column of DST-7 is represented as src[0 . . . 31], the three partial vector signals may be divided into src[0 . . . 5], src[6 . . . 18] and src[19 . . . 31].

In an embodiment, among the three partial vector signals, 13-point DFT type 1 may be applied to the src[0 . . . 5], and 13-point DFT type 2 may be applied to the src[6 . . . 18] and the src[19 . . . 31].

In an embodiment, one-dimensional 33-point DFT necessary for 16×16 DST-7 and one-dimensional 65-point DFT necessary for 32×32 DST-7 may be decomposed into equivalent two-dimensional DFTs having a shorter DFT. As described above, redundant calculation can be removed and low complexity DST-7 can be designed by executing DST-7 by a DFT.

Furthermore, the decoder 200 may perform an inverse transform in a horizontal direction using the horizontal transform (S3050). In this case, the horizontal transform may correspond to DCT-8. That is, the decoder may apply inverse DCT-8 to an inverse quantized transform coefficient block.

In the embodiment, after a vertical transform is applied, a horizontal transform is applied, but the present disclosure is not limited thereto. That is, after a horizontal transform is applied, a vertical transform may be applied.

In an embodiment, a combination of the horizontal transform and the vertical transform may include at least one of the embodiments of FIG. 6a, 6b, or 44a to 45b.

The decoder 200 generates a residual block through step S3050, and generates a reconstructed block by adding the residual block and the prediction block.

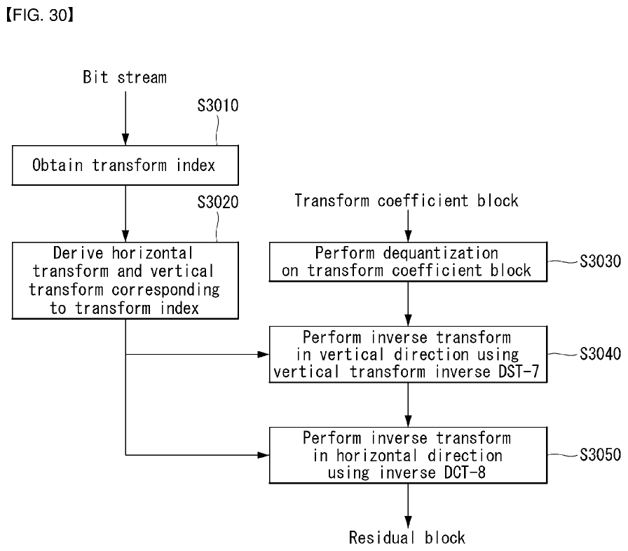

FIG. 31 is an embodiment to which the present disclosure is applied, and illustrates diagonal elements for a pair of a transform block size N and a right shift amount S1 when DST-4 and DCT-4 are performed as forward DCT-2.

The present disclosure proposes a method of using a memory for DST-4 and DCT-4 among transform types for video compression and reducing operation complexity.

In an embodiment, there is provided a method of performing DST-4 and DCT-4 as forward DCT-2.

In an embodiment, there is provided a method of performing DST-4 and DCT-4 as inverse DCT-2.

In an embodiment, there is provided a method of applying DST-4 and DC-T4 to a transform configuration group to which MTS is applied.

### Embodiment 2-1: DST-4 and DCT-4 Design Using DCT-2

Equations for deriving matrices of DST-4 and DCT-4 are as follows.

$$\begin{matrix}{[ {S}_{N}^{IV} ]}_{n , k} = \sqrt{\frac{2}{N}} sin [ ( n + \frac{1}{2} ) ( k + \frac{1}{2} ) \frac{π}{N} ] , \\ k , n = 0 , 1 , … , N - 1 & [ Equation 56 ] \\ {[ {C}_{N}^{IV} ]}_{n , k} = \sqrt{\frac{2}{N}} cos [ ( n + \frac{1}{2} ) ( k + \frac{1}{2} ) \frac{π}{N} ] , \\ k , n = 0 , 1 , … , N - 1 & [ Equation 57 ]\end{matrix}$$

In this case, n (0, . . . N−1) indicates a row index, and k (0, . . . N−1) indicates a column index. In this case, Equation 56 and Equation 57 generate inverse transform matrices of DST-4 and DCT-4, respectively. Furthermore, these transposes indicate forward transform matrices.

When the DST-4(DCT-4) inverse transform matrix is indicated as (S_{N}^{IV}) ((C_{N}^{IV})), a relation between Equations 58 and 59 can be seen.

$$\begin{matrix} {( {S}_{N}^{IV} )}^{T} = ( {S}_{N}^{IV} ) , {( {C}_{N}^{IV} )}^{T} = ( {C}_{N}^{IV} ) & [ Equation 58 ] \\ ( {S}_{N}^{IV} ) = {J}_{N} ( {C}_{N}^{IV} ) {D}_{N} = {( {S}_{N}^{IV} )}^{T} = {{D}_{N} ( {C}_{N}^{IV} )}^{T} {J}_{N} = {D}_{N} ( {C}_{N}^{IV} ) {J}_{N} \\ ( {C}_{N}^{IV} ) = {J}_{N} ( {S}_{N}^{IV} ) {D}_{N} = {( {C}_{N}^{IV} )}^{T} = {{D}_{N} ( {S}_{N}^{IV} )}^{T} {J}_{N} = {D}_{N} ( {S}_{N}^{IV} ) {J}_{N} \\ {where \\ [ {J}_{N} ]}_{i , j} = \{ \begin{matrix}1 , & j = N - 1 - i \\ 0 , & otherwise\end{matrix} , i , j = 0 , 1 , … , N - 1 \\ {and \\ [ {D}_{N} ]}_{i , j} = diag ( {( - 1 )}^{i} ) = \{ \begin{matrix}{( - 1 )}^{i} , & i = j \\ 0 , & i \neq j\end{matrix} , i , j = 0 , 1 , … , N - 1 & [ Equation 59 ]\end{matrix}$$

According to Equations 58 and 59, the present disclosure may derive the DST-4 (DCT-4) inverse transform matrix (S_{N}^{IV}) ((C_{N}^{IV})) from the DCT-4 (DST-4) inverse transform matrix (S_{N}^{IV}) ((C_{N}^{IV})) by changing an input order or an output order and changing a sign through a pre-processing stage or a post-processing stage.

Accordingly, if DST-4 or DCT-4 is performed through the present disclosure, the other can be easily derived from one without additional calculation.

In an embodiment of the present disclosure, DCT-4 may be represented as follows using DCT-2.

$${( {C}_{N}^{IV} )}^{T} = ( {C}_{N}^{IV} ) = {{A}_{N} ( {C}_{N}^{II} )}^{T} {M}_{N} , {where \\ [ {A}_{N} ]}_{n , k} = \{ \begin{matrix}{( - 1 )}^{n} \cdot \frac{1}{\sqrt{2}} , & k = 0 , & n = 0 , 1 , … , N - 1 \\ {( - 1 )}^{n + k} , & n \leq k , & n , k = 1 , 2 , … , N - 1 \\ 0 , & otherwise & \end{matrix} , \\ {and \\ [ {M}_{N} ]}_{n , k} = \{ \begin{matrix}2 cos \frac{π ( 2 n + 1 )}{4 N} , & if n = k \\ 0 , & otherwise\end{matrix} n , k = 0 , 1 , … , N - 1 \qquad [ Equation 60 ]$$

In this case, M_{N} indicates a post-processing matrix, and A_{N} indicates a pre-processing matrix.

In Equation 60, (C_{N}^{IV}) indicates inverse DCT-2. An example of M_{N}, A_{N}

$$may be$$

$${A}_{4} = [ \begin{matrix}1 / \sqrt{2} & 0 & 0 & 0 \\ - 1 / \sqrt{2} & 1 & 0 & 0 \\ 1 / \sqrt{2} & - 1 & 1 & 0 \\ - 1 / \sqrt{2} & 1 & - 1 & 1\end{matrix} ] , \\ {M}_{4} = [ \begin{matrix}2 cos \frac{π}{16} & 0 & 0 & 0 \\ 0 & 2 cos \frac{3 π}{16} & 0 & 0 \\ 0 & 0 & 2 cos \frac{5 π}{16} & 0 \\ 0 & 0 & 0 & 2 cos \frac{7 π}{16}\end{matrix} ] .$$

In the present embodiment, it may be seen that DCT-4 can be designed based on a post-processing matrix M_{N}, a pre-processing matrix A_{N}, and DCT-2 from Equation 60. In this case, in the case of the post-processing matrix MN and the pre-processing matrix A_{N}, only a small amount of multiplication is added. Furthermore, DCT-2 can reduce the number of coefficients to be stored, and has been well known as a transform for a fast implementation based on symmetry between coefficients within a DCT-2 matrix.

Accordingly, by adding some multiplication factors, a fast implementation of DCT-4 can be realized with low complexity. The same is true of DST-4.

Inverse matrices of the post-processing matrix M_{N} and the pre-processing matrix A_{N} may be represented as in Equation 61.

$${[ {M}_{N}^{- 1} ]}_{n , k} = \{ \begin{matrix}1 / 2 cos \frac{π ( 2 n + 1 )}{4 N} , & if n = k \\ 0 , & otherwise\end{matrix} n , k = 0 , 1 , … , N - {1 \\ [ {A}_{N}^{1} ]}_{n , k} = \\ \{ \begin{matrix}\sqrt{2} , & n = k = 0 \\ 1 , & n = k or k + 1 , n = 1 , 2 , … , N - 1 , k = 0 , 1 , … , N - 1 \\ 0 , & otherwise\end{matrix} \qquad [ Equation 61 ]$$

In this case, an example of A_{N}⁻¹, M_{N}⁻¹ may be

$${A}_{4}^{- 1} = [ \begin{matrix}\sqrt{2} & 0 & 0 & 0 \\ 1 & 1 & 0 & 0 \\ 0 & 1 & 1 & 0 \\ 0 & 0 & 1 & 1\end{matrix} ] , \\ {M}_{4}^{- 1} = [ \begin{matrix}1 / 2 cos \frac{π}{16} & 0 & 0 & 0 \\ 0 & 1 / 2 cos \frac{3 π}{16} & 0 & 0 \\ 0 & 0 & 1 / 2 cos \frac{5 π}{16} & 0 \\ 0 & 0 & 0 & 1 / 2 cos \frac{7 π}{16}\end{matrix} ] .$$

The present disclosure can derive another relation equation between DCT-4 and DCT-2, such as Equation 62, by using A_{N}⁻¹ and M_{N}⁻¹ of Equation 61.

(C_{N}^{IV})^{T}=(C_{N}^{IV})=M_{N}⁻¹(C_{N}^{II})A_{N}⁻¹ [Equation 62]

In this case, the A_{N}⁻¹, M_{N}⁻¹ enable a fast implementation of DCT-4 with low complexity because it has multiplications simpler than (C_{N}^{II}). Furthermore, A_{N}⁻¹ causes a smaller number of additions or subtractions than A_{N}, but coefficients within M_{N}⁻¹ have a wider range than those within M_{N}. Accordingly, the present disclosure can design a transform type based on Equations 61 and 62 by considering a tradeoff between complexity and performance.

The present embodiment can implement DST-4 with low complexity by reusing the fast implementation of DCT-2 from Equations 59, 60, and 62. This is represented through Equations 63 and 64.

$$\begin{matrix} {( {S}_{N}^{IV} )}^{T} = ( {S}_{N}^{IV} ) = ( {D}_{N} {A}_{N} ) \cdot {( {C}_{N}^{II} )}^{T} \cdot ( {M}_{N} {J}_{N} ) , \\ {where [ {D}_{N} {A}_{N} ]}_{n , k} = \{ \begin{matrix}\frac{1}{\sqrt{2}} , & k = 0 , & n = 0 , 1 , … , N - 1 \\ {( - 1 )}^{k} , & n \leq k , & n , k = 1 , 2 , … , N - 1 \\ 0 , & otherwise & \end{matrix} \\ {and [ {M}_{N} {J}_{N} ]}_{n , k} = \{ \begin{matrix}2 cos \frac{π ( 2 ( N - 1 - n ) + 1 )}{4 N} , & if n = N - 1 - k \\ 0 , & otherwise\end{matrix} \\ n , k = 0 , 1 , … , N - 1 & [ Equation 63 ] \\ {( {S}_{N}^{IV} )}^{T} = ( {S}_{N}^{IV} ) = ( {D}_{N} {M}_{N}^{- 1} ) \cdot ( {C}_{N}^{II} ) \cdot ( {A}_{N}^{- 1} {J}_{N} ) , \\ {where [ {D}_{N} {M}_{N}^{- 1} ]}_{n , k} = \begin{matrix}{( - 1 )}^{n} / 2 cos \frac{π ( 2 n + 1 )}{4 N} , & if n = k \\ 0 , & otherwise\end{matrix} \\ n , k = 0 , 1 , … , N - 1 {and \\ [ {A}_{N}^{- 1} {J}_{N} ]}_{n , k} = \{ \begin{matrix}\sqrt{2} , & n = 0 , k = N - 1 \\ 1 , & k = N - n or N - 1 - n , n = 1 , 2 , … , N - 1 \\ 0 , & otherwise\end{matrix} & [ Equation 64 ]\end{matrix}$$

### Embodiment 2-2: Implementation of DST4 and DCT4 Using Forward DCT-2

If Equation 63 is used for an implementation of DST-4, first, the input vector of a length N needs to be scaled by (M_{N}J_{N}). Likewise, if Equation 60 is used for an implementation of DCT-4, first, the input vector of a length N needs to be scaled by (M_{N}).

Diagonal elements within M_{N} are floating-point numbers, and need to be properly scaled in order to be used in a fixed-point or integer multiplication. If integerized (M_{N}J_{N}) and M_{N} are represented as (M_{N}J_{N})′ and M_{N}, (M_{N}J_{N})′ and M_{N}′ may be calculated according to Equation 68.

$${[ {M}_{N}^{′} ]}_{n , k} = \begin{matrix}round \{ [ 2 cos \frac{π ( 2 n + 1 )}{4 N} ] ⪡ {S}_{1} \} , & if n = k \\ 0 , & otherwise\end{matrix} \\ n , k = 0 , 1 , … , N - {1 \\ [ {( {M}_{N} {J}_{N} )}^{′} ]}_{n , k} = \\ \{ \begin{matrix}round \{ [ 2 cos \frac{π ( 2 ( N - 1 - n ) + 1 )}{4 N} ] ⪡ {S}_{1} \} , & if n = N - 1 - k \\ 0 , & otherwise\end{matrix} \\ n , k = 0 , 1 , \text{...} , N - 1 \qquad [ Equation 65 ]$$

FIG. 31 illustrates examples of M_{N}′ based on N and S1. In this case, diag(·) means that an argument matrix is transformed as an association vector that constitutes diagonal elements within the argument matrix.

diag((M_{N}J_{N})′) of the same (N, S1) may be easily derived from FIG. 31 by changing the element order of each vector. For example, [251,213,142,50] may be changed into [50,142,213,251].

In an embodiment of the present disclosure, S1 may be differently configured with respect to each N. For example, S1 may be set to 7 with respect to a 4×4 transform, and S1 may be set to 8 with respect to an 8×8 transform.

In Equation 65, S₁ indicates a left shift amount for scaling by 2^{S}^{₁}, and a “round” operator performs proper rounding.

M_{N}′ and (M_{N}J_{N})′ are diagonal matrices. An i-th element (denoted by xi) of an input vector x is multiplied by [M_{N}′]_{i,i} and [(M_{N}J_{N})′]_{i,i}. The multiplication results and diagonal matrices of the input vector x may be indicated like Equation 66.

$$\hat{x} = \{ \begin{matrix}{[ {{x}_{0} [ {M}_{N}^{′} ]}_{0 , 0} {x}_{1} \cdot {[ {M}_{N}^{′} ]}_{1 , 1} … {x}_{N - 1} \cdot {[ {M}_{N}^{′} ]}_{N - 1 , N - 1} ]}^{T} for DCT 4 \\ {[ {x}_{0} \cdot {[ {( {M}_{N} {J}_{N} )}^{′} ]}_{0 , 0} {x}_{1} \cdot {[ {( {M}_{N} {J}_{N} )}^{′} ]}_{1 , 1} … {x}_{N 1} \cdot {[ {( {M}_{N} {J}_{N} )}^{′} ]}_{N - 1 , N - 1} ]}^{T} = \\ {[ {x}_{0} \cdot {[ {M}_{N}^{′} ]}_{N 1 , N 1} {x}_{1} \cdot {[ {M}_{N}^{′} ]}_{N 2 , N 2} … {x}_{N - 1} \cdot {[ {M}_{N}^{′} ]}_{0 , 0} ]}^{T} for DST 4\end{matrix} \qquad [ Equation 66 ]$$

In Equation 66, \hat{x} indicates multiplication results. In this case, \hat{x} needs to be subsequently scaled down. The down scaling of \hat{x} may be performed before DCT-2 is applied, may be performed after DCT-2 is applied, or may be performed after A_{N} ((D_{N}A_{N})) is multiplied by DCT-4 (DST-4). If the down scaling of \hat{x} is performed before DCT-2 is applied, the down-scaled one x may be determined based on Equation 67.

$${\tilde{x}}_{i} = \{ \begin{matrix}( {\hat{x}}_{i} + ( 1 ⪡ ( {S}_{2} - 1 ) ) ) ⪢ {S}_{2} , & ( 1 ) & \\ \hat{x} ⪢ {S}_{2} , & ( 2 ) & i = 0 , 1 , … , N - 1 \\ Other functions & & \end{matrix} \qquad [ Equation 67 ]$$

In Equation 67, S2 may be the same value as the S1, but the present disclosure is not limited thereto. The S2 may have a value different from the S1.

In Equation 67, any type of the scaling and the rounding is possible. In an embodiment, (1) and (2) of Equation 67 may be used. That is, as represented in Equation 67, (1), (2) or other functions may be applied to find out zi.

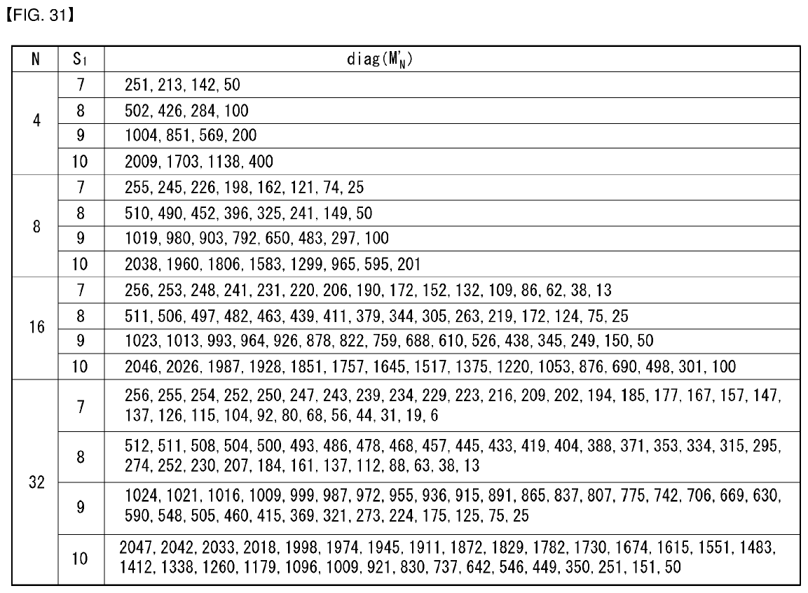

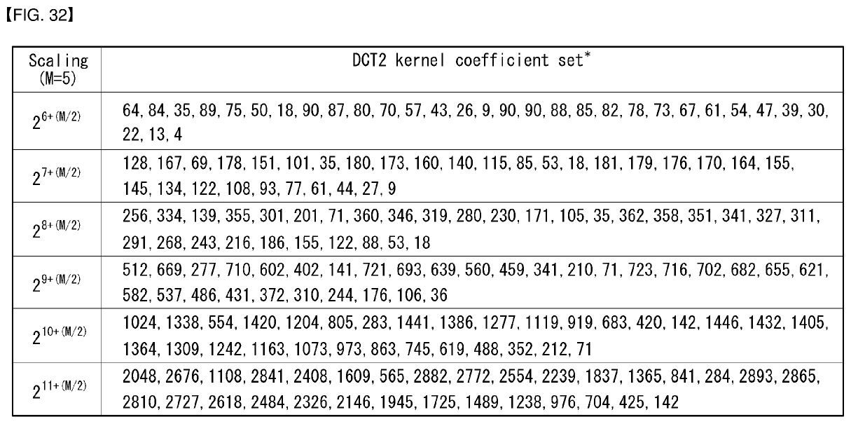

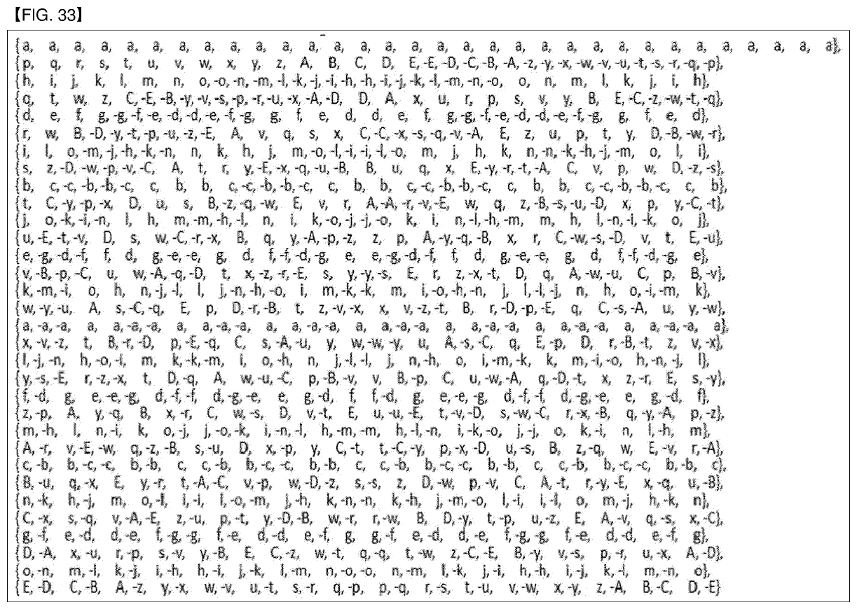

FIGS. 32 and 33 are embodiments to which the present disclosure is applied, wherein FIG. 32 illustrates sets of DCT-2 kernel coefficients which may be applied to DST-4 or DCT-4, and FIG. 33 illustrates a forward DCT-2 matrix generated from a set of a DCT-2 kernel coefficient.

An embodiment of the present disclosure may use the same DCT-2 kernel coefficient as HEVC. 31 other coefficients of DCT2 facilitated by symmetries among all DCT2 kernel coefficients of all sizes up to 32×32 need to be maintained.

If the existing DCT-2 implementation is reused, additional coefficients of DCT-2 used in DST-4 or DCT-4 do not need to be stored.

If a specific DCT-2 kernel not the existing DCT-2 is used, the present disclosure may add only one set of DCT-2 kernel coefficients, that is, 31 coefficients using the same kind of symmetry. That is, if up to 2n×2n DCT-2 is supported, the present disclosure requires only other (2n−1) coefficients.

Such an additional set may have accuracy higher or lower than the existing set. If a dynamic range of z does not exceed a range supported by the existing DCT-2 design, the present disclosure may reuse the same routine as DCT-2 without extending the bit length of internal variables, and may reuse legacy design of DCT-2.

Although DST-4/DCT-4 requires more calculation accuracy than DCT-2, an updated routine capable of accumulating higher accuracy can also sufficiently perform the existing DCT-2. For example, more accurate sets of DCT-2 coefficients are listed in FIG. 32 based on scaling factors.

In FIG. 32, each coefficient may be further adjusted in order to improve orthogonality between basis vectors, may make a norm of each basis vector close to 1, and can reduce a Frobenius norm error from a floating-point accurate DCT-2 kernel.

If a coefficient set is given as (a,b,c,d,e,f,g,h,i,j,k,l,m,n,o,p,q,r,s,t,u,v,w,x,y,z,A,B,C,D,E), forward DCT-2 generated from the coefficient set may be configured like FIG. 33.

In FIG. 33, each DCT-2 coefficient set (each row of FIG. 33) is described in a (a,b,c,d,e,f,g,h,i,j,k,l,m,n,o,p,q,r,s,t,u,v,w,x,y,z,A,B,C,D,E) form. This incorporates that only 31 possibly different coefficients are necessary for all DCT-2 transforms having a size not greater than 32×32.

Output of the DCT-2 transform needs to be post-processed for a matrix A_{N} (or DNAN) of DCT-4 (or DST-4). Before an input vector is provided to the matrix A_{N} (or DNAN) of the DCT-4 (or DST-4), a DCT-2 output vector may be rounded as a value for accuracy adjustment in order to store the value as variables having a limited bit length as the input vector. If a DCT-2 output vector prior to scaling and rounding is y, a rounded one ŷ may be determined from Equation 68. As in Equation 67, other forms of scaling and rounding may also be applied to Equation 68.

ŷᵢ=(yᵢ+(1<<(S₃−1)))>>S3,i=0,1, . . . ,N−1 [Equation 68]

In Equation 68, if S3 is 0, any scaling and rounding is not applied to yᵢ. That is, ŷᵢ=yᵢ.

It is assumed that the final output vector after y is multiplied by A_{N} or(D_{N}A_{N}) is X. Most of the multiplication may be substituted by a simple addition or subtraction except the first 1/\sqrt{2} multiplication. In this case, the 1/\sqrt{2} factor is a constant number, and may be approximated by hardwired multiplication based on a right shift as represented in Equation 69. As in Equation 67, other forms of scaling and rounding may also be applied to Equation 69.

X₀=(ŷ₀·F+(1<<(S₄−1)))>>S₄ [Equation 69]

In Equation 69, F and S4 need to satisfy a condition that F>>S4 is very close to 1/\sqrt{2}. One of methods of obtaining a (F, S4) pair is to use F=round{(1/\sqrt{2})<<S₄}.

The present disclosure may increase S4 for more accurate approximation of 1/2 [symbol] , but an increase of S4 requires intermediate variables having a longer length, which may increase execution complexity. Table 1 indicates possible pairs of (F, S4) approximated to 1/\sqrt{2}.

TABLE 26

| S₄ | F |
|---|---|
| 7 | 91 |
| 8 | 181 |
| 9 | 362 |
| 10 | 724 |
| 11 | 1448 |

In Equation 69, the present disclosure assumes that the same quantity as a left shift of F applies a right shift S4 in order to not change overall scaling, but is not essentially limited thereto. If a right shift as much as S5 (<S4) is applied instead of S4, the present disclosure needs to scale up all ŷ by 2^{S}^{₄}^{-S}^{₅}. When considering expected resultant scaling predicted after DCT-4 (or DST-4) calculation (ST, a positive value means a right shift) and all the shifts of the previous equations, the present disclosure may configure Equation 70 having all the scaling bit shift values.

S_{T}=(S₁−S₂)+S_{C}−S₃+(S₄−S₅)−S_{O} [Equation 70]

In Equation 70, SC may indicate a left shift amount attributable to a DCT-2 integer multiplication, which may be a non-integer value as in FIG. 31. SO indicates a right shift amount for calculating the final output (X) of DCT-4 (or DST-4). In Equation 70, some parts may be 0. For example, (S1-S2), S3, or (S5-S4) may be 0.

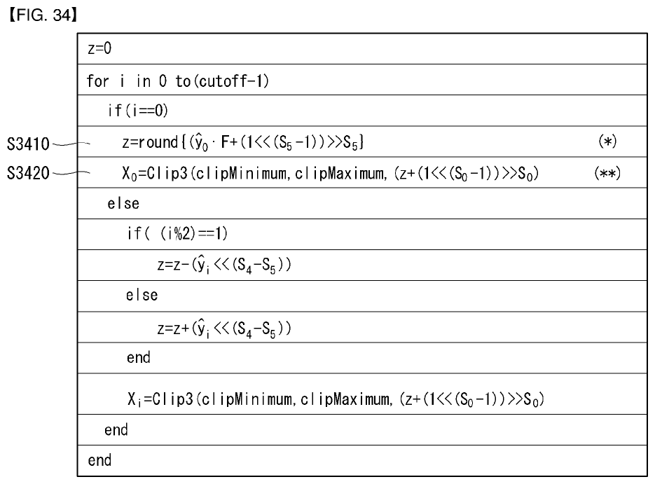

FIGS. 34 and 35 are embodiments to which the present disclosure is applied, wherein FIG. 34 illustrates the execution of a code at an output step for DST-4, and FIG. 35 illustrates the execution of a code at an output step for DCT-4.

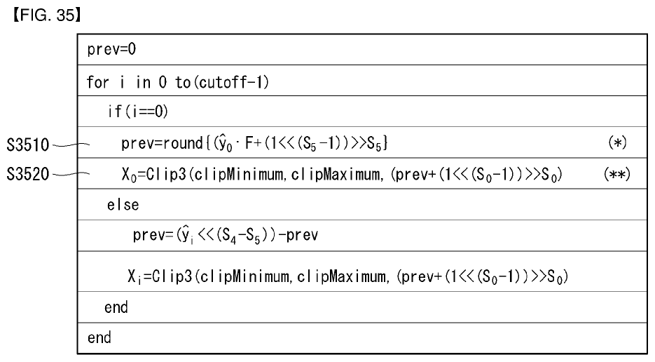

Assuming that an i-th element of the final output vector is Xi, an embodiment of the present disclosure may provide a code execution example of the final step for DST-4 corresponding to a multiplication of (D_{N}A_{N}) as in FIG. 36.

Furthermore, another embodiment of the present disclosure may provide a code execution example of the final step for DCT4 corresponding to a multiplication of A_{N} as in FIG. 35.

In FIG. 34, cutoff indicates the number of valid coefficients in a vector X. For example, cutoff may be N.

In FIG. 34, steps S1910 and S1920 may be integrated into one calculation process as in Equation 71.

X₀=Clip3(clipMinimum,clipMaximum,(ŷ₀·F+(1<<(S₅+S_{O}−1))>>(S₅+S_{O})) [Equation 71]

As in Equation 67, other forms of scaling and rounding may also be applied to FIG. 34 and Equation 71.

In FIG. 35, steps S3510 and S3520 may be integrated into one calculation process as in Equation 72.

X₀=Clip3(clipMinimum,clipMaximum,(ŷ₀·F+(1<<(S₅+S_{O}−1))>>(S₅+S_{O})) [Equation 72] (Equation 20)

As in Equation 67, other forms of scaling and rounding may also be applied to FIG. 35 and Equation 72.

In FIGS. 34 and 35, Clip3 indicates an operation of clipping an argument value to both ends clipMinimum and clipMaximum.

Each row of A_{N} (or (D_{N}A_{N})) has a common pattern with its previous row. The present disclosure may reuse a result of a previous row based on proper sign reversal. Such a pattern may be used through a variable z, prev in FIGS. 34 and 35. In this case, the variable z, prev reduces multiplication calculation of A_{N} (or (D_{N}A_{N})).

The present disclosure requires only one multiplication or only one addition/subtraction for each output due to the variable z, prev. For example, the multiplication may be necessary only in the first output element.

FIG. 36 is an embodiment to which the present disclosure is applied, and illustrates a configuration of a parameter set and multiplication coefficients for DST-4 and DCT-4 when DST-4 and DCT-4 are performed as forward DCT-2.

FIG. illustrates a configuration of a parameter set and multiplication coefficients for DST-4 and DCT-4 when DST-4 and DCT-4 are performed as forward DCT-2. Each transform of another size may be individually configured. That is, each transform of another size may have a parameter set and multiplication coefficients.

For example, when a configuration of a parameter set of DST-4 is (S1, S2, S3, S4, S5, S0), multiplication coefficient values may be (8, 8, 0, 8, 8, identical to HEVC) for all block sizes. Furthermore, when a configuration of a parameter set of DCT-4 is (S1, S2, S3, S4, S5, S0), multiplication coefficient values may be (8, 8, 0, 8, 8, identical to HEVC) for all block sizes.

Furthermore, when a configuration of a parameter set is M_{N}′, it may have each multiplication coefficient value described in FIG. 36 for each block size.

According to the present disclosure, the execution of inverse DST-4(DCT-4) is the same as forward DST-4(DCT-4) according to Equation 70.

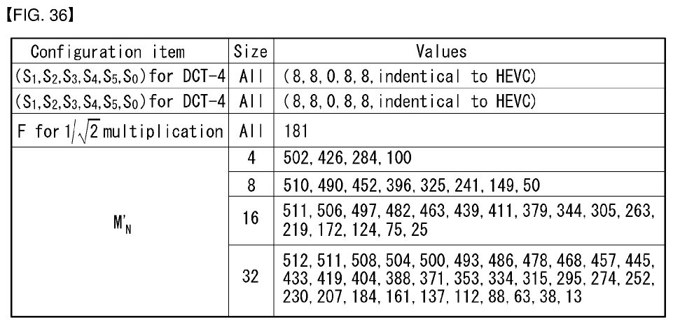

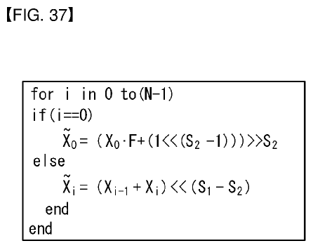

FIGS. 37 and 38 are embodiments to which the present disclosure is applied, wherein FIG. 37 illustrates the execution of a code at a pre-processing stage for DCT-4, and FIG. 38 illustrates the execution of a code at a pre-processing stage for DST-4.

### Embodiment 2-3: Alternative Implementation of DST-4 and DCT-4 Using Inverse DCT-2

The present embodiment provides a method of implementing DCT-4 and DST-4 through Equations 62 and 64.

A_{N}⁻¹, (A_{N}⁻¹J_{N}), M_{N}⁻¹, and (D_{N}M_{M}⁻¹) may be used instead of A_{N}, (D_{N}A_{N}), M_{N}, and (M_{N}J_{N}), which require a smaller computational load than DCT-2. Inverse DCT-2 is applied instead of forward DCT-2 in Equations 62 and 64.

Compared to Equations 60 and 63, A_{N}⁻¹ or (A_{N}⁻¹J_{N}) is applied in an input vector x, and M_{N}⁻¹ or (D_{N}M_{M}⁻¹) is applied in an output vector of DCT-2.

As in Equations 61 and 64, only one element is multiplied by \sqrt{2} in A_{N}⁻¹ and (A_{N}⁻¹J_{N}). In this case, A_{N}⁻¹ and (A_{N}⁻¹J_{N}) may be approximated as an integer multiplication by a right shift.

In Equation 62, the example of the code implementation at the pre-processing stage of DCT-4 is the same as FIG. 37, which corresponds to a multiplication of A_{N}⁻¹. Furthermore, in Equation 64, the example of the code execution at the pre-processing stage of DST-4 is the same as FIG. 38, which corresponds to a multiplication of (A_{N}⁻¹J_{N}).

As in Equation 67, other forms of scaling and rounding may also be applied to FIGS. 36 and 37.

In FIGS. 37 and 38, N indicates the length a transform basis vector in addition to the length of the input vector x. F and S1 indicate a multiplication factor and a right shift amount for approximating \sqrt{2} of a relation equation x·\sqrt{2}≈(x·F+(1<<(S₁−1)))>>S1.

In FIGS. 37 and 38, S2 is used for rounding instead of S1 because the input vector needs to be scaled up as much as 2S1-S2. If S1 is the same as S1, the input vector does not need to be scaled. Table 27 illustrates an example of a (F, S1) pair for approximating a \sqrt{2} multiplication.

TABLE 27

| S₁ | F |
|---|---|
| 7 | 181 |
| 8 | 362 |
| 9 | 724 |
| 10 | 1448 |
| 11 | 2896 |

As in Equation 68, in order to use a variable having a shorter bit length, the present disclosure may scale down inverse DCT-2 output. Assuming that an inverse DCT-2 output vector is y and an i-th element is yᵢ, an output vector ŷ scaled according to Equation 73 may be obtained. As in Equation 67, other forms of scaling and rounding may also be applied to Equation 73.

ŷᵢ=(yᵢ+(1<<(S₃−1)))>>S₃,i=0,1, . . . ,N−1 [Equation 73]

In Equation 62 and Equation 64, the post-processing stages correspond to M_{N}⁻¹ and (D_{N}M_{N}⁻¹), respectively. In this case, associated diagonal coefficients may be scaled up for a fixed point or an integer multiplication. Such scaling up may be performed as proper left shifts as in Equation 74.

$${[ {M}_{N}^{- {1}^{′}} ]}_{n , k} = \{ \begin{matrix}round \{ [ 1 / 2 cos \frac{π ( 2 n + 1 )}{4 N} ] ⪡ {S}_{4} \} , & if n = k \\ 0 , & otherwise\end{matrix} \\ n , k = 0 , 1 , … , N - {1 \\ [ {( {D}_{N} {M}_{N}^{- 1} )}^{′} ]}_{n , k} = \{ \begin{matrix}round \{ [ {( - 1 )}^{n} / 2 cos \frac{π ( 2 n + 1 )}{4 N} ] ⪡ {S}_{4} \} , & if n = k \\ 0 , & otherwise\end{matrix} \\ n , k = 0 , 1 , … , N - 1 \qquad [ Equation 74 ]$$

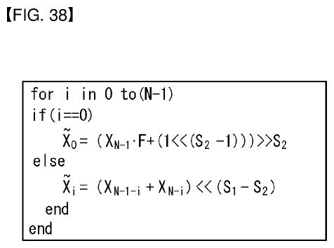

FIG. 39 is an embodiment to which the present disclosure is applied, and illustrates diagonal elements for a pair of a transform block size N and a right shift amount S₄ when DST-4 and DCT-4 are performed as inverse DCT-2.

Examples of diagonal elements of M_{N}^{-1′} may be seen as various combinations of N and S₄ of FIG. 39.

As in the embodiment 2-2, S₄ may be different set for each transform size. In FIG. 39, if (N, S₄) is (32, 9), large numbers, such 10431, may be decomposed like Equation 75, which is suitable for the multiplication of an operator unit having a shorter bit length. This will be applied when a large number of multiplication appears.

10431·x=(8096+2048+287)·x=(x<<13)+(x<<11)+(287·x) [Equation 75]

Corresponding examples of (D_{N}M_{N}⁻) may be derived from FIG. 39. For example, if (N, S₄) is (4, 9), a vector is [261, −308, 461, −1312].

Non-zero elements are available only on diagonal lines in M_{N}^{-1′} and (D_{N}M_{N}⁻¹)′, and an associated matrix multiplication may be performed by an element-wise multiplication as in Equation 76.

$$\hat{X} = \\ \{ \begin{matrix}{[ {\hat{y}}_{0} \cdot {[ {M}_{N}^{- {1}^{′}} ]}_{0 , 0} {\hat{y}}_{1} \cdot {[ {M}_{N}^{- {1}^{′}} ]}_{1 , 1} … {\hat{y}}_{N - 1} \cdot {[ {{M}_{N}^{- 1}}^{′} ]}_{N - 1 , N - 1} ]}^{T} & for DCT 4 \\ {[ {\hat{y}}_{0} \cdot {[ {( {D}_{N} {M}_{N}^{- 1} )}^{′} ]}_{0 , 0} {\hat{y}}_{1} \cdot {[ {( {D}_{N} {M}_{N}^{- 1} )}^{′} ]}_{1 , 1} … {\hat{y}}_{N - 1} \cdot {[ {( {D}_{N} {M}_{N}^{- 1} )}^{′} ]}_{N - 1 , N - 1} ]}^{T} = & \\ {[ {\hat{y}}_{0} \cdot {[ {M}_{N}^{- {1}^{′}} ]}_{0 , 0} - {\hat{y}}_{1} \cdot {[ {M}_{N}^{- {1}^{′}} ]}_{1 , 1} … {( - 1 )}^{N - 1} \cdot {\hat{y}}_{N - 1} \cdot {[ {M}_{N}^{- {1}^{′}} ]}_{N - 1 , N - 1} ]}^{T} & for DST 4\end{matrix} \qquad [ Equation 76 ]$$

If the final output vector is X, X calculated from Equation 76 needs to be properly scaled in order to satisfy previously given expected scaling. For example, if a left shift amount for obtaining the final output vector X is S_{O} and predicted scaling is S_{T}, an overall relation between shift lengths along with S_{O} and S_{T} may be configured like Equation 77.

Xᵢ=(\hat{X}ᵢ+(1<<(S_{O}−1)))>>S_{O},i=0,1, . . . ,N−1

S_{T}=(S₁−S₂)+S_{C}−S₃+S₄−S_{O} [Equation 77]

In this case, S_{T} may have a non-negative value in addition to a negative value. S_{C} may have a value, such as that in Equation 70. As in Equation 67, other forms of scaling and rounding may also be applied to Equation 77.

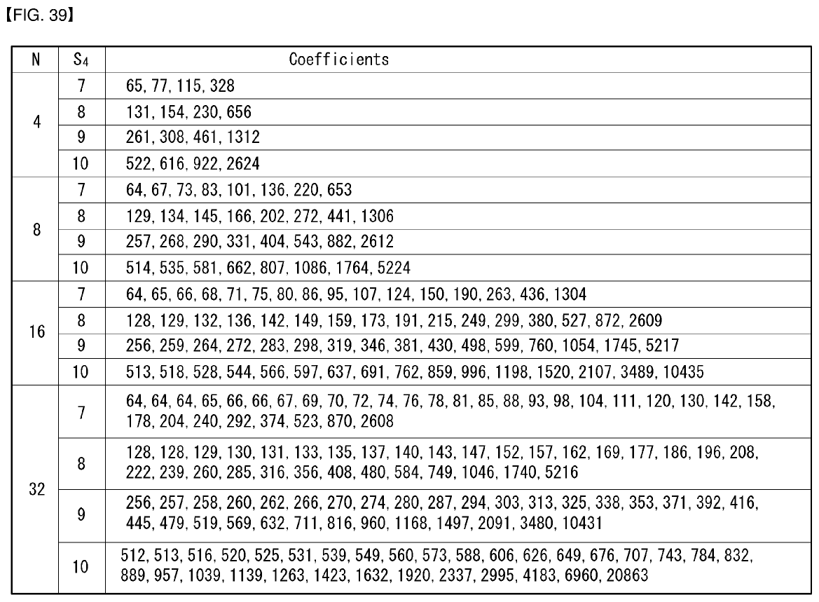

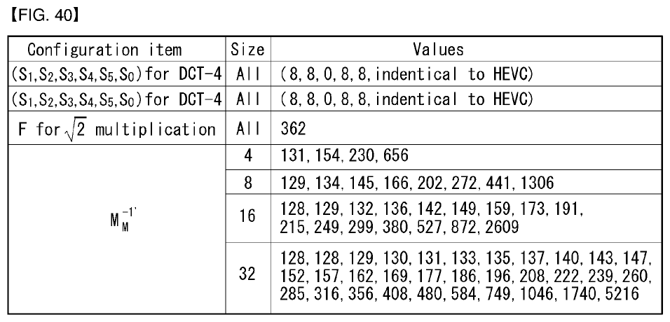

FIG. 40 is an embodiment to which the present disclosure is applied, and illustrates a configuration of a parameter set and multiplication coefficients for DST-4 and DCT-4 when DST-4 and DCT-4 are performed as inverse DCT-2.

FIG. 40 illustrates a configuration of a parameter set and multiplication coefficients in another implementation for DST-4 and DCT-4. Each transform of a different size may be individually configured. That is, each transform of a different size may have a parameter set and multiplication coefficients.

For example, when a configuration of a parameter set of DST-4 is (S₁, S₂, S₃, S₄, S5, S₀), a multiplication coefficient value for all block sizes may be (8, 8, 0, 8, 8, identical to HEVC). Furthermore, when a configuration of a parameter set of DCT-4 is (S₁, S₂, S₃, S₄, S₅, S₀), a multiplication coefficient value for all block sizes may be (8, 8, 0, 8, 8, identical to HEVC).

Furthermore, when a configuration of a parameter set is M_{N}⁻¹, each block size may have each multiplication coefficient value described in FIG. 40.

According to the present disclosure, the execution of inverse DST-4(DCT-4) is the same as forward DST-4(DCT-4) according to Equation 70.

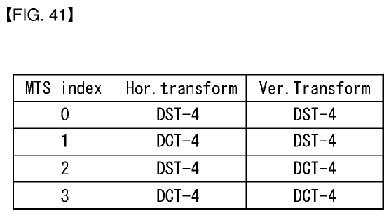

FIGS. 41 and 42 are embodiments to which the present disclosure is applied, wherein FIG. 41 illustrates MTS mapping for an intra-prediction residual, and FIG. 42 illustrates MTS mapping for an inter-prediction residual.

### Embodiment 2-4: MTS Mapping Using DST-4 and DCT-4

In an embodiment of the present disclosure, DCT-4 and DST-4 may be used to generate MTS mapping. For example, DST-7 and DCT-8 may be substituted with DCT-4 and DST-4.

In another embodiment, only DCT-4 and DST-4 may be used to generate MTS. For example, FIGS. 45a and 45b illustrates an example of MTS of a residual after an intra-prediction and a residual after an inter-prediction.

In another embodiment of the present disclosure, mapping is possible by other combinations of DST-4, DCT-4, DCT-2, etc.

In another embodiment, an MTS configuration for substituting DCT-4 with DCT-2 is possible.

In another embodiment, mapping for a residual after an inter-prediction composed of DCT-8/DST-7 is maintained without any change, and only a residual after an intra-prediction may be substituted.

In another embodiment, a combination of the embodiments is also possible.

### Embodiment 3: DST-4(DCT-4) or DST-7(DCT-8) Applied for Each

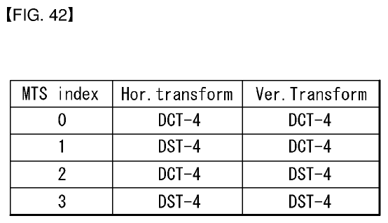

FIG. 43 illustrates an example of transform types according to lengths according to an embodiment of the present disclosure.

The methods of designing and implementing DST-7 and DCT-8 using DFT and the methods of designing and implementing DST-4 and DCT-4 using forward or inverse DCT-2 have been proposed.

In the case of DST-7 or DCT-8 of the length 8, although the proposed DFT-based design is applied, a computational load is not substantially reduced compared to DST-7 or DCT-8 of a matrix form from a viewpoint of a multiplication. Accordingly, with respect to the length 8, a computational load may be reduced by applying DST-4 instead of DST-7 and applying DCT-4 instead of DCT-8. In particular, a computational load can be reduced by applying a design method of DST-4 and DCT-4 using the proposed DCT-2. For example, a transform, such as FIG. 43, may be applied.

A transform applied in FIG. 43 may follow a design and implementation proposed in the embodiment of the present disclosure, and may apply another technology. For example, the transform does not follow the DFT-based DST-7 design proposed in the present patent document, but may follow a simple matrix multiplication or a DST-7 design based on a matrix multiplication. In a transform for a length 64, DCT-2 may be applied as in FIG. 43, but another transform (e.g., DST-4, DCT-4, DST-7, DCT-8) may be applied. If DST-4, DCT-4, DST-7, or DCT-8 is applied is the transform for the length 64, the transform may follow the design and implementation proposed in an embodiment of the present disclosure. In FIG. 43, transforms applied to one face are proposed. In the case of a two-dimensional block, different transforms may be applied in a transverse length and a longitudinal length. For example, in the case of an 8(transverse)×18(longitudinal) block, DST-4 or DCT-4 may be applied in a row direction and DST-7 or DCT-8 may be applied in a column direction according to Table 1.

Furthermore, in a transform application map for the configuration of FIG. 43, a row direction transform (Hor. Transform) and a column direction transform (Ver. Transform) may be determined based on an MTS index as in FIGS. 44a and 44b in the case of a length 4, 16, 32. As a transform map applying the configuration of FIG. 43, a row direction transform and a column direction transform may be determined based on an MTS index as in FIGS. 44a and 44b in the case of the length 8. In an embodiment, in the case of the length 8, an example in which DST-4 or DCT-4 is used is described, but DST-4 or DCT-4 may be applied to another length in addition to the length 8.

FIGS. 44a and 44b illustrate examples of tables for determining transform types for the horizontal direction and the vertical direction in the case of lengths 4, 16, and 32. FIG. 44a illustrates transform pairs applied to a residual generated through an intra-prediction. FIG. 44b illustrates transform pairs applied to a residual generated through an inter-prediction.

Referring to FIG. 44a, if a transform for a residual signal generated through an intra-prediction or an inverse transform for an inverse quantized or inverse secondary-transformed signal is applied, a transform type corresponding to an index indicative of the transform type may be determined for both the horizontal direction and the vertical direction. For example, when an MTS index is 0, DST-7 is determined as a transform type with respect to the horizontal direction and the vertical direction. When the MTS index is 1, DCT-8 is determined as a transform type for the horizontal direction and DST-7 is determined as a transform type for the vertical direction. When the MTS index is 2, DST-7 is determined as a transform type for the horizontal direction and DCT-8 is determined as a transform type for the vertical direction. When the MTS index is 3, DCT-8 is determined as a transform type for both the horizontal direction and the vertical direction.

Referring to FIG. 44b, if a transform for a residual signal generated through an inter-prediction or an inverse transform for an inverse quantized or inverse secondary-transformed signal is applied, a transform type corresponding to an index indicative of the transform type may be determined with respect to a horizontal direction and a vertical direction. For example, when an MTS index is 0, DCT-8 is determined as a transform type for both the horizontal direction and the vertical direction. When the MTS index is 1, DST-7 is determined as a transform type for the horizontal direction, and DCT-8 is determined as a transform type for the vertical direction. When the MTS index is 2, DCT-8 is determined as a transform type for the horizontal direction, and DST-7 is determined as a transform type for the vertical direction. When the MTS index is 3, DST-7 is determined as a transform type for both the horizontal direction and the vertical direction.

FIGS. 45a and 45b illustrate examples of tables for determining transform types for the horizontal direction and the vertical direction in the case of a length 8. FIG. 45a illustrates transform pairs applied to a residual generated through an intra-prediction, and FIG. 45b illustrates transform pairs applied to a residual generated through an inter-prediction.

Referring to FIG. 45a, if a transform for a residual signal generated through an intra-prediction or an inverse transform for an inverse quantized or inverse secondary-transformed signal is applied, a transform type corresponding to an index indicative of the transform type may be determined with respect to a horizontal direction and a vertical direction. For example, when an MTS index is 0, DST-4 is determined as a transform type for both the horizontal direction and the vertical direction. When the MTS index is 1, DCT-4 is determined as a transform type for the horizontal direction, and DST-4 is determined as a transform type for the vertical direction. When the MTS index is 2, DST-4 is determined as a transform type for the horizontal direction, and DCT-4 is determined as a transform type for the vertical direction. When the MTS index is 3, DCT-4 is determined as a transform type for both the horizontal direction and the vertical direction.

Referring to FIG. 44b, if a transform for a residual signal generated through an inter-prediction or an inverse transform for an inverse quantized or inverse secondary-transformed signal is applied, a transform type corresponding to an index indicative of the transform type may be determined for a horizontal direction and a vertical direction. For example, when an MTS index is 0, DCT-4 is determined as a transform type for both the horizontal direction and the vertical direction. When the MTS index is 1, DST-4 is determined as a transform type for the horizontal direction, and DCT-4 is determined as a transform type for the vertical direction. When the MTS index is 2, DCT-4 is determined as a transform type for the horizontal direction, and DST-4 is determined as a transform type for the vertical direction. When the MTS index is 3, DST-4 is determined as a transform type for both the horizontal direction and the vertical direction.

FIGS. 44a, 44b, 45a, and 45b illustrate examples in which DST-7 or DCT-8 is used when the length of a transformed or inverse transformed signal is 4, 16, or 32 and DST-4 or DCT-4 is used when the length of a transformed or inverse transformed signal is 8, but they are illustrative. The present disclosure may also be applied to an embodiment for adaptively selecting a transform type based on the length of a signal.

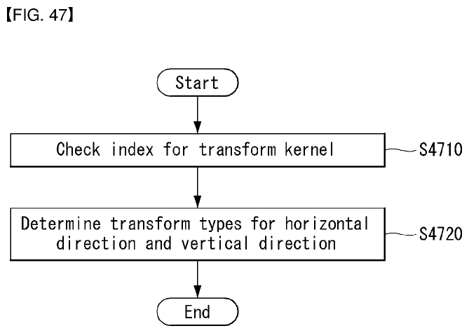

FIG. 46 illustrates an example of a flowchart for processing a video signal using a transform based on DST-4, DCT-4, DST-7, and DCT-8 according to an embodiment of the present disclosure. FIG. 46 illustrates an example of an operation flowchart of the encoder 100 or the decoder 200 according to the embodiment 3. Hereinafter, for convenience of description, an operation of the decoder 200 is basically described, but an embodiment of the present disclosure is not limited to the decoder 200 and substantially the same or corresponding operation may be performed even in the decoder 200. Terms “transform” and “inverse transform” used hereinafter may be interchangeably used.

First, the decoder 200 may check the length of a signal to be transformed (S4610). For example, the decoder 200 may separate a matrix to which an inverse secondary transform (e.g., NSST) is applied into a row direction and a column direction, and may perform an inverse primary transform. In this case, the length of the signal may mean the number of elements in the row direction or column direction. For example, the length of the signal may be 4, 8, 16, or 32.

Thereafter, the decoder 200 may determine a transform type for an inverse transform (S4620). In this case, the transform type is a function for generating a transform matrix or an inverse transform matrix for a transform or an inverse transform between a space domain and a frequency domain, and may include DST-4, DCT-4, DST-7, DCT-8, or transforms based on sine/cosine.

According to an embodiment of the present disclosure, the decoder 200 may determine DST-4 or DCT-4 as a transform type if the length of the signal corresponds to a first length, and may determine DST-7 or DCT-8 as a transform type if the length of the signal corresponds to a second length. In this case, the first length may correspond to 8, and the second length may correspond to 4, 16, or 32.

Furthermore, according to an embodiment of the present disclosure, DST-4 and DCT-4 may be implemented by a low complexity design based on DST-2 and DCT-2 as described the embodiment 2.

Furthermore, according to an embodiment of the present disclosure, DST-7 may be implemented by a low complexity design based on a DFT as described through the embodiment 1.

Thereafter, the decoder 200 may apply the transform matrix to the signal (S4630). More specifically, the decoder 20 may generate a signal of a frequency domain by applying the transform matrix to a residual signal after a prediction is applied.

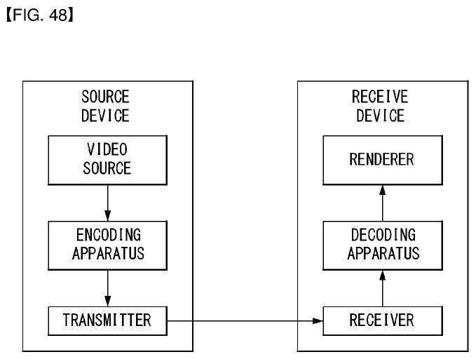

FIG. 47 illustrates an example of a flowchart for determining a transform type in a process of processing a video signal using transforms based on DST-4, DCT-4, DST-7, and DCT-8 according to an embodiment of the present disclosure. FIG. 47 illustrates an example of step S4620 of FIG. 46.

In FIG. 47, the decoder 200 may check an index for a transform type (S4710). For example, the decoder 200 may check an index (e.g., MTS index) for a transform type transmitted by the encoder 100.

Thereafter, the decoder 200 may determine a transform type for a vertical direction and a horizontal direction (S4720). More specifically, the decoder 200 may determine a first transform type for horizontal elements of the signal and a second transform type for vertical elements of the signal so that the transform type corresponds to an index for a transform type received from the encoder 100.

In this case, if the length of the signal corresponds to a first length (e.g., 8), the first transform type for the horizontal elements and the second transform type for the vertical elements may be determined based on a combination of DST-4 or DCT-corresponding to the index. For example, as in the table of FIG. 45a or 45b, a transform type may be determined. Furthermore, if the length of the signal corresponds to a second length (e.g., 4, 16, 32), the first transform type for the horizontal elements and the second transform type for the vertical elements may be determined based on a combination of DST-7 or DCT-8 corresponding to the index. For example, as in the table of FIG. 44a or 44b, a transform type may be determined.

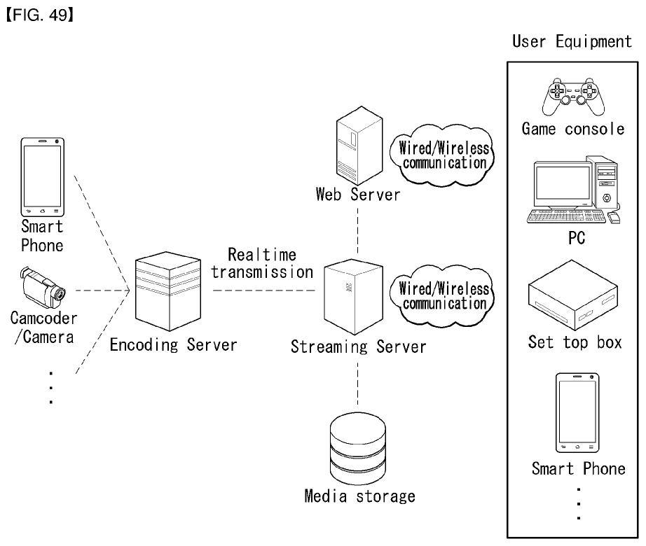

FIG. 48 illustrates an example of a video coding system as an embodiment to which the present disclosure is applied.

A video coding system may include a source device and a receiving device. The source device may transmit encoded video/image information or data to the receiving device via a digital storage medium or a network in a file or streaming form.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be implemented as a separate device or an external component.

The video source may acquire a video/image through a capturing, synthesizing, or generating process of the video/image. The video source may include a video/image capture device and/or a video/image generation device. The video/image capture device may include, for example, one or more cameras, video/image archives including previously captured video/images, and the like. The video/image generation device may include, for example, a computer, a tablet, and a smart phone and may (electronically) generate the video/image. For example, a virtual video/image may be generated by the computer, etc., and in this case, the video/image capturing process may be replaced by a process of generating related data.

The encoding apparatus may encode an input video/image. The encoding apparatus may perform a series of procedures including prediction, transform, quantization, and the like for compression and coding efficiency. The encoded data (encoded video/image information) may be output in the bitstream form.

The transmitter may transfer the encoded video/image information or data output in the bitstream to the receiver of the receiving device through the digital storage medium or network in the file or streaming form. The digital storage medium may include various storage media such as USB, SD, CD, DVD, Blu-ray, HDD, SSD, and the like. The transmitter may include an element for generating a media file through a predetermined file format and may include an element for transmission through a broadcast/communication network. The receiver may extract the bitstream and transfer the extracted bitstream to the decoding apparatus.

The decoding apparatus may perform a series of procedures including dequantization, inverse transform, prediction, etc., corresponding to an operation of the encoding apparatus to decode the video/image.

The renderer may render the decoded video/image. The rendered video/image may be displayed by the display.

FIG. 49 illustrates an example of a video streaming system as an embodiment to which the present disclosure is applied.

Referring to FIG. 49, the content streaming system to which the disclosure is applied may basically include an encoding server, a streaming server, a web server, a media storage, a user equipment and a multimedia input device.

The encoding server basically functions to generate a bitstream by compressing content input from multimedia input devices, such as a smartphone, a camera or a camcorder, into digital data, and to transmit the bitstream to the streaming server. For another example, if multimedia input devices, such as a smartphone, a camera or a camcorder, directly generate a bitstream, the encoding server may be omitted.

The bitstream may be generated by an encoding method or bitstream generation method to which the disclosure is applied. The streaming server may temporally store a bitstream in a process of transmitting or receiving the bitstream.

The streaming server transmits multimedia data to the user equipment based on a user request through the web server. The web server plays a role as a medium to notify a user that which service is provided. When a user requests a desired service from the web server, the web server transmits the request to the streaming server. The streaming server transmits multimedia data to the user. In this case, the content streaming system may include a separate control server. In this case, the control server functions to control an instruction/response between the apparatuses within the content streaming system.

The streaming server may receive content from the media storage and/or the encoding server. For example, if content is received from the encoding server, the streaming server may receive the content in real time. In this case, in order to provide smooth streaming service, the streaming server may store a bitstream for a given time.

Examples of the user equipment may include a mobile phone, a smart phone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD)), digital TV, a desktop computer, and a digital signage.

The servers within the content streaming system may operate as distributed servers. In this case, data received from the servers may be distributed and processed.

The embodiments described in the present disclosure may be implemented and performed on a processor, a microprocessor, a controller, or a chip. For example, functional units illustrated in each drawing may be implemented and performed on a computer, the processor, the microprocessor, the controller, or the chip.

In addition, the decoder and the encoder to which the present disclosure may be included in a multimedia broadcasting transmitting and receiving device, a mobile communication terminal, a home cinema video device, a digital cinema video device, a surveillance camera, a video chat device, a real time communication device such as video communication, a mobile streaming device, storage media, a camcorder, a video on demand (VoD) service providing device, an OTT (Over the top) video device, an Internet streaming service providing devices, a three-dimensional (3D) video device, a video telephone video device, a transportation means terminal (e.g., a vehicle terminal, an airplane terminal, a ship terminal, etc.), and a medical video device, etc., and may be used to process a video signal or a data signal. For example, the OTT video device may include a game console, a Blu-ray player, an Internet access TV, a home theater system, a smartphone, a tablet PC, a digital video recorder (DVR), and the like.

In addition, a processing method to which the present disclosure is applied may be produced in the form of a program executed by the computer, and may be stored in a computer-readable recording medium. Multimedia data having a data structure according to the present disclosure may also be stored in the computer-readable recording medium. The computer-readable recording medium includes all types of storage devices and distribution storage devices storing computer-readable data. The computer-readable recording medium may include, for example, a Blu-ray disc (BD), a universal serial bus (USB), a ROM, a PROM, an EPROM, an EEPROM, a RAM, a CD-ROM, a magnetic tape, a floppy disk, and an optical data storage device. Further, the computer-readable recording medium includes media implemented in the form of a carrier wave (e.g., transmission over the Internet). Further, the bitstream generated by the encoding method may be stored in the computer-readable recording medium or transmitted through a wired/wireless communication network.

In addition, the embodiment of the present disclosure may be implemented as a computer program product by a program code, which may be performed on the computer by the embodiment of the present disclosure. The program code may be stored on a computer-readable carrier.

As described above, the embodiments described in the disclosure may be implemented and performed on a processor, a microprocessor, a controller or a chip. For example, the function units illustrated in the drawings may be implemented and performed on a computer, a processor, a microprocessor, a controller or a chip.

Furthermore, the decoder and the encoder to which the disclosure is applied may be included in a multimedia broadcasting transmission and reception device, a mobile communication terminal, a home cinema video device, a digital cinema video device, a camera for monitoring, a video dialogue device, a real-time communication device such as video communication, a mobile streaming device, a storage medium, a camcorder, a video on-demand (VoD) service provision device, an over the top (OTT) video device, an Internet streaming service provision device, a three-dimensional (3D) video device, a video telephony device, and a medical video device, and may be used to process a video signal or a data signal. For example, the OTT video device may include a game console, a Blu-ray player, Internet access TV, a home theater system, a smartphone, a tablet PC, and a digital video recorder (DVR).

Furthermore, the processing method to which the disclosure is applied may be produced in the form of a program executed by a computer, and may be stored in a computer-readable recording medium. Multimedia data having a data structure according to the disclosure may also be stored in a computer-readable recording medium. The computer-readable recording medium includes all types of storage devices in which computer-readable data is stored. The computer-readable recording medium may include a Blu-ray disk (BD), a universal serial bus (USB), a ROM, a PROM, an EPROM, an EEPROM, a RAM, a CD-ROM, a magnetic tape, a floppy disk, and an optical data storage device, for example. Furthermore, the computer-readable recording medium includes media implemented in the form of carriers (e.g., transmission through the Internet). Furthermore, a bit stream generated using an encoding method may be stored in a computer-readable recording medium or may be transmitted over wired and wireless communication networks.

Furthermore, an embodiment of the disclosure may be implemented as a computer program product using program code. The program code may be performed by a computer according to an embodiment of the disclosure. The program code may be stored on a carrier readable by a computer.

The embodiments described above are implemented by combinations of components and features of the present disclosure in predetermined forms. Each component or feature should be considered selectively unless specified separately. Each component or feature may be carried out without being combined with another component or feature. Moreover, some components and/or features are combined with each other and can implement embodiments of the present disclosure. The order of operations described in embodiments of the present disclosure may be changed. Some components or features of one embodiment may be included in another embodiment, or may be replaced by corresponding components or features of another embodiment. It is apparent that some claims referring to specific claims may be combined with another claims referring to the claims other than the specific claims to constitute an embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be embodied in other specific forms without departing from essential features of the present disclosure. Accordingly, the aforementioned detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

### INDUSTRIAL APPLICABILITY

The aforementioned preferred embodiments of the disclosure have been disclosed for illustrative purposes, and those skilled in the art may improve, change, substitute, or add various other embodiments without departing from the technical spirit and scope of the disclosure disclosed in the attached claims.

1. A method of processing a video signal, comprising:
checking a length of a signal to which a transform is to be applied in the video signal, wherein the length of the signal corresponds to a width or height of a current block to which the transform is applied;
determining a transform type based on the length of the signal; and
applying, to the signal, the transform matrix determined based on the transform type,
wherein DST-4 or DCT-4 is determined as the transform type if the length of the signal corresponds to a first length, and
wherein DST-7 or DCT-8 is determined as the transform type if the length of the signal corresponds to a second length different from the first length.

2. The method of claim 1,
wherein the first length corresponds to 8, and
wherein the second length corresponds to 4, 16, or 32.

3. The method of claim 1,
wherein applying, to the signal, the transform matrix determined based on the transform type includes:
checking an index indicative of the transform type, and
determining a first transform type for horizontal components of the signal and a second transform type for vertical components of the signal to correspond to the index.

4. The method of claim 3,
wherein if the length of the signal corresponds to the first length, the first transform type for the horizontal components of the signal and the second transform type for the vertical components of the signal are determined based on a combination of the DST-4 or the DCT-4 corresponding to the index, and
wherein if the length of the signal corresponds to the second length, the first transform type for the horizontal components of the signal and the second transform type for the vertical components of the signal are determined based on a combination of the DST-7 or the DCT-8 corresponding to the index.

5. The method of claim 1,
wherein the DST-4 and the DCT-4 are determined based on DST-2 and DCT-2.

6. The method of claim 1,
wherein the DST-7 is determined based on a discrete Fourier transform (DFT).

7. The method of claim 6,
wherein the first length corresponds to a length having a small complexity reduction when the DST-7 determined based on the DFT is applied.

8. An apparatus for processing a video signal, comprising:
a memory configured to store the video signal, and
a decoder functionally coupled to the memory and configured to process the video signal,
wherein the decoder is configured to:
check a length of a signal to which a transform is to be applied in the video signal, wherein the length of the signal corresponds to a width or height of a current block to which the transform is applied;
determine a transform type based on the length of the signal; and
apply, to the signal, the transform matrix determined based on the transform type,
wherein DST-4 or DCT-4 is determined as the transform type if the length of the signal corresponds to a first length, and
wherein DST-7 or DCT-8 is determined as the transform type if the length of the signal corresponds to a second length different from the first length.

9. The apparatus of claim 8,
wherein the first length corresponds to 8, and
wherein the second length corresponds to 4, 16, or 32.

10. The apparatus of claim 8,
wherein the decoder is configured to:
check an index indicative of the transform type, and
determine a first transform type for horizontal components of the signal and a second transform type for vertical components of the signal to correspond to the index.

11. The apparatus of claim 10,
wherein if the length of the signal corresponds to the first length, the first transform type for the horizontal components of the signal and the second transform type for the vertical components of the signal are determined based on a combination of the DST-4 or the DCT-4 corresponding to the index, and
wherein if the length of the signal corresponds to the second length, the first transform type for the horizontal components of the signal and the second transform type for the vertical components of the signal are determined based on a combination of the DST-7 or the DCT-8 corresponding to the index.

12. The apparatus of claim 8,
wherein the DST-4 and the DCT-4 are determined based on DST-2 and DCT-2.

13. The apparatus of claim 8,
wherein the DST-7 is determined based on a discrete Fourier transform (DFT).

14. The apparatus of claim 13,
wherein the first length corresponds to a length having a small complexity reduction when the DST-7 determined based on the DFT is applied.
